(19) United States
(12) Patent Application Publication
(10) Pub. No.: US 2016/0011349 A1
(43) Pub. Date: Jan. 14, 2016

(54) INFRARED REFLECTING FILM AND LAMINATED FILM

(71) Applicants: JNC CORPORATION, Tokyo (JP); JNC PETROCHEMICAL CORPORATION, Tokyo (JP)

(72) Inventor: Yoshiharu Hirai, Ichihara-shi (JP)

(73) Assignees: JNC PETROCHEMICAL CORPORATION, Tokyo (JP); JNC CORPORATION, Tokyo (JP)

(21) Appl. No.: 14/577,540

(22) Filed: Dec. 19, 2014

(30) Foreign Application Priority Data
Dec. 20, 2013 (JP) 2013-263872

(51) Int. Cl. G02B 5/26; G02B 5/20; G02F 1/13; C09K 19/38

(52) U.S. Cl. CPC G02B 5/26; C09K 19/3809; G02B 5/208; G02F 1/1313

(57) ABSTRACT

To provide an infrared reflecting film that is prepared by using a specific polymerizable liquid crystal compound and a specific optically active compound and is hard to cause an alignment defect, and also to provide a laminated film having the infrared reflecting film. A solution is the infrared reflecting film formed of a polymerizable liquid crystal composition containing a specific amount of optically active compound (2) having a binaphthol moiety and a specific amount of achiral polymerizable liquid crystal compound (1).

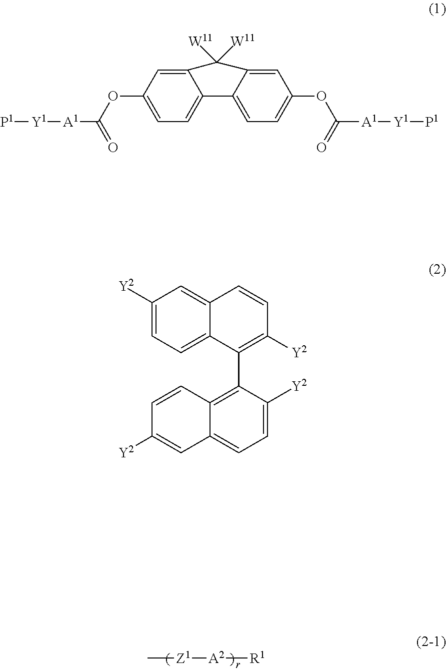

### TECHNICAL FIELD

The present invention relates to an infrared reflecting film obtained by polymerizing a polymerizable liquid crystal composition containing an optically active compound having a binaphthol moiety and an achiral polymerizable liquid crystal compound having a fluorene moiety, and a laminated film using the infrared reflecting film.

### BACKGROUND ART

From a viewpoint of prevention of global warming, and energy saving, cutting of heat rays (infrared light) from sunlight from a window or a showwindow of a building, a window surface of a car or the like to reduce temperature is widely performed. As a material for cutting the heat rays, proposal has been made for a material using antimony-doped tin oxide (ATO), a material using tin doped indium oxide (ITO) or the like (see Patent literature No. 1, for example), and a material using a laminated film of a metallic thin film (see Patent literature No. 2, for example). Moreover, proposal has been made for an infrared reflecting film using a cholesteric liquid crystal (see Patent literatures Nos. 3 to 5) or the like. Moreover, the present inventors have developed a polymerizable liquid crystal composition utilizing an optically active compound having a binaphthol moiety and a polymerizable liquid crystal compound having a fluorene skeleton. (Patent literature Nos. 6 to 9).

A member for cutting the heat rays in which ATO or ITO is used as proposed in Patent literature No. 1 has an absorption band in a visible light region. However, a method for cutting the heat rays is of a heat ray absorption type, and therefore when the member is laminated with glass or the like and used, heat cracking may be occasionally caused. Moreover, a member for cutting the heat rays in which the laminated film of the metallic thin film is used as proposed in Patent literature No. 2 has a system of cutting the heat rays of a reflecting type, and therefore the heat cracking as described above is not caused. However, the member is used for the window or the showwindow of the building, the member cuts an electromagnetic wave, and therefore the member has a problem of incapability of communication using a cell phone or the like.

Thermal insulation coating in which the cholesteric liquid crystal is used as proposed in Patent literature Nos. 3 and 4 has comparatively longer reflection wavelength, and in order to obtain desired reflectance, an increase in film thickness (increasing the number of helical pitches in a thickness direction) is required. Therefore, alignment properties of the cholesteric liquid crystal are easily disordered, and thus the coating has a concern on a decrease of light reflectance at a wavelength at which reflection is desired, and a decrease of transmittance in the visible light region as caused by a rise in haze.

The heat ray reflecting film in which the cholesteric liquid crystal is used as proposed in Patent literature No. 5 utilizes a polyfunctional compound and a polyfunctional thiol compound in order to secure adhesion properties with a transparent support substrate. However, the thiol compound has a peculiar odor, and has a problem on a manufacturing process.

The polymerizable liquid crystal compositions described in Patent literature Nos. 6 to 8 suggest an application possibility in various uses by controlling a kind or an amount of addition of the optically active compound to change a helical pitch of an optically anisotropic substance having twist alignment. A description is found on a length of the helical pitch of the optically anisotropic a visible light reflection use in the range of 380 nanometers to 780 nanometers in a length of the helical pitch of the optical anisotropic substance having twist alignment, and a negative C plate for an optical compensation use of a liquid crystal display in the range less than 380 nanometers in the length of the helical pitch, but no specific description is found in presuming an infrared reflecting film.

Patent literature No. 9 proposes a polymerizable liquid crystal composition consisting of a cationically polymerizable compound in which a polymerizable functional group includes an oxiranyl group or an oxetanyl group. An optical device having reflection characteristics in a near-infrared region is also described. In the above case, adhesion with a support substrate is easily secured by utilizing cationic polymerization, but yellowing, after film formation, peculiar to the cationic polymerization may be occasionally significant, and reduction of yellowing has been desired.

### CITATION LIST

### Patent Literature

Patent literature No. 1: JP H09-156025 A.

Patent literature No. 2: JP H10-309767 A.

Patent literature No. 3: JP 2001-519317 A.

Patent literature No. 4: JP 2011-138147 A.

Patent literature No. 5: JP 2013-173238 A.

Patent literature No. 6: JP 2005-113131 A.

Patent literature No. 7: JP 2008-174716 A.

Patent literature No. 8: JP 2009-286885 A.

Patent literature No. 9: JP 2010-132876 A.

### SUMMARY OF INVENTION

### Technical Problem

A first object of the invention is to provide an infrared reflecting film in which a specific polymerizable liquid crystal compound and a specific optically active compound are used, and an alignment defect is hard to occur. A second object is to provide a laminated film having the infrared reflecting film.

### Solution to Problem

The present inventors have found that the problems are solved by aligning a polymerizable liquid crystal composition having a specific amount of a polymerizable optically active compound having a binaphthol moiety and a polymerizable liquid crystal compound having a fluorene skeleton and curing the composition, and thus the have completed the invention. The invention is as described below.

Item 1. An infrared reflecting film, obtained by curing a polymerizable liquid crystal composition containing an achiral polymerizable liquid crystal compound and an optically active compound in a state of a liquid crystal phase, wherein

the achiral polymerizable liquid crystal compound contains component (A) being at least one compound selected from the group of achiral polymerizable liquid crystal compounds represented by formula (1),

the optically active compound contains component (B) being at least one compound selected from the group of optically active compounds having a binaphthol moiety represented by formula (2), and

a content of component (B) in the total weight of the achiral polymerizable liquid crystal compound and the optically active compound is in the range of 0.1% by weight or more and 5% by weight or less:

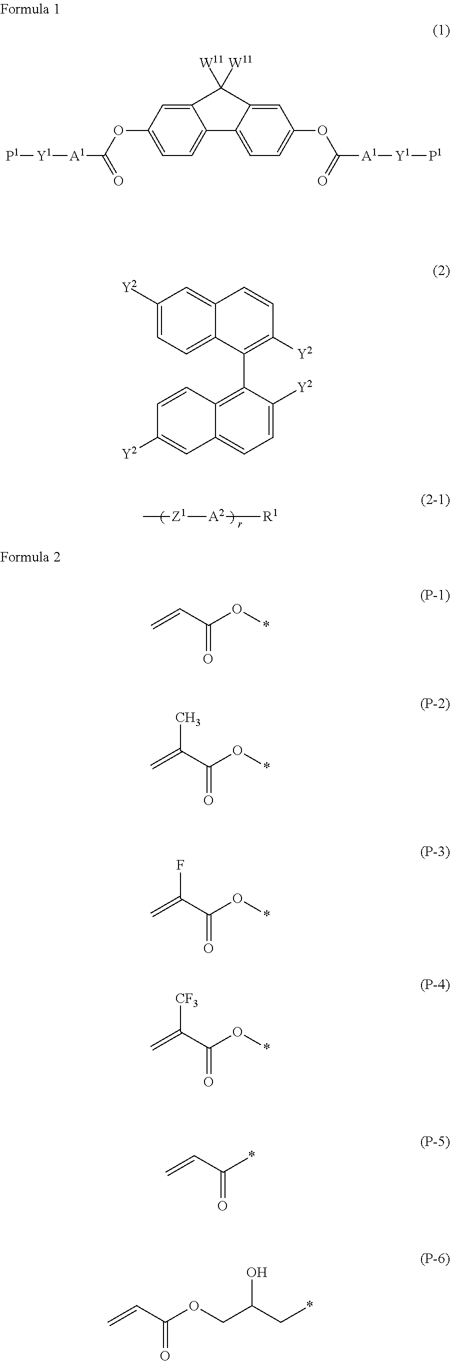

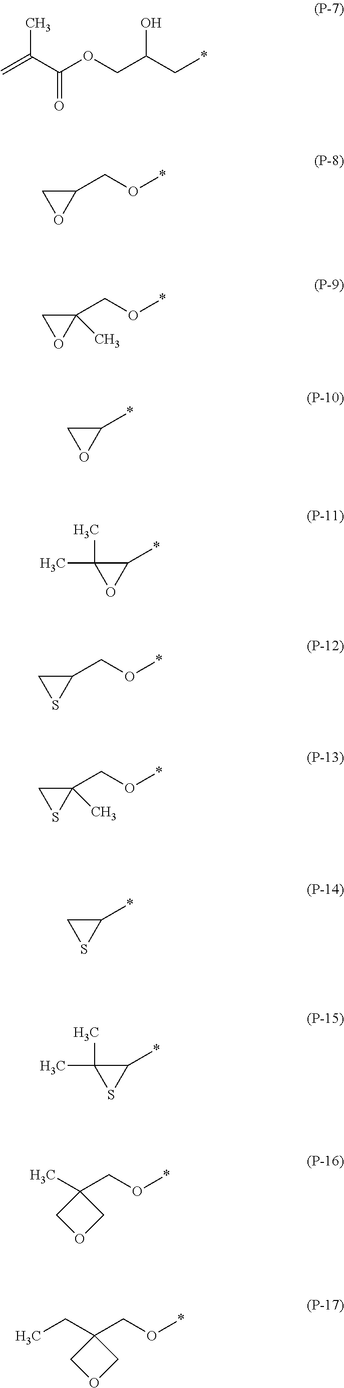

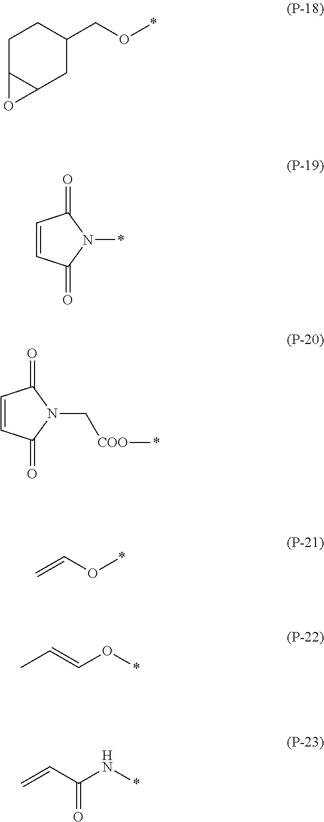

wherein, in (P-1) to (P-23), * represents a bonding site:

wherein, in formula (1),

P¹ is independently represented by any one of formulas (P-1) to (P-23);

W¹¹ is independently hydrogen, fluorine, chlorine, methyl or ethyl, and at least one of hydrogen in the methyl and the ethyl may be replaced by halogen;

A¹ is independently 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;

Y¹ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine,

in formula (2),

Y² is independently hydrogen, halogen or a group represented by formula (2-1), however, in Y², at least two are a group represented by formula (2-1);

in formula (2-1),

R¹ is independently halogen, cyano, alkenyl having 2 to 20 carbons or alkyl having 1 to 20 carbons, at least one of —CH₂— in the group may be replaced by —O—, excluding a case where —O— is adjacent, at least one of hydrogen in the group may be replaced by halogen, and in one or two of Y², one of hydrogen in R¹ may be replaced by any one of formulas (P-1) to (P-23);

A² is independently 1,4-cyclohexylene, 1,4-phenylene, 4,4′-biphenylene, naphthalene-2,6-diyl, decahydronaphthalene-2,6-diyl, 1,2,3,4-tetrahydronaphthalene-2,6-diyl, or 1,4-phenylene in which at least one of hydrogen is replaced by halogen;

Z¹ is independently a single bond, —O—, —COO—, —OCO—, —CH═CH—COO—, —OCO—CH═CH—, —CH₂CH₂—COO—, —OCO—CH₂CH₂—, —OCF₂— or —(CH₂)ₚ—, and one of —CH₂— in —(CH₂)ₚ— may be replaced by —O—;

p is independently an integer from 1 to 20; and

r is independently an integer from 1 to 3.

Item 2. The infrared reflecting film according to item 1, wherein component (A) is at least one compound selected from the group of compounds represented by formula (1-1), and component (B) is at least one compound selected from the group of compounds having optical activity represented by formula (2-2):

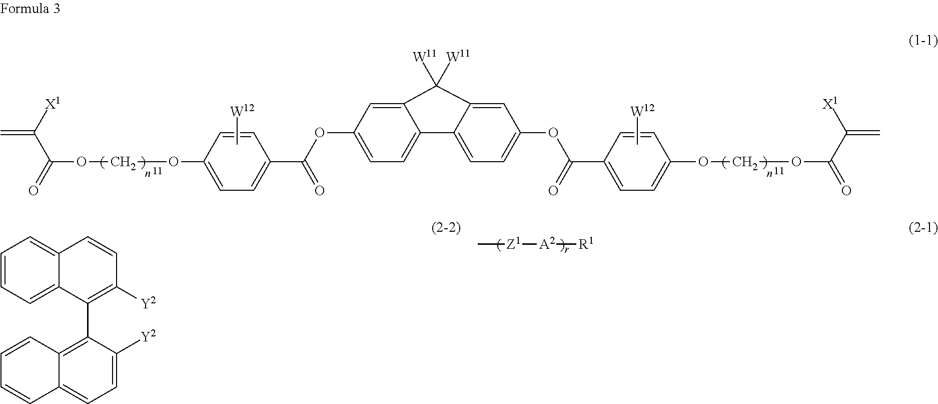

wherein, in formula (1-1),

X¹ is independently hydrogen, methyl, fluorine or trifluoromethyl;

W¹¹ is independently hydrogen or methyl;

W¹² is independently hydrogen, halogen, nitro, cyano, alkyl having 1 to 7 carbons or alkoxy having 1 to 7 carbons;

n¹¹ is independently an integer from 2 to 20;

in formula (2-2),

Y² is independently a group represented by formula (2-1);

in formula (2-1),

R¹ is independently halogen, cyano, alkenyl having 2 to 20 carbons or alkyl having 1 to 20 carbons, at least one of —CH₂— in the group may be replaced by —O—, excluding a case where —O— is adjacent, at least one of hydrogen in the group may be replaced by halogen, and in one or two of Y², one of hydrogen in R¹ may be replaced by acryloyloxy, methacryloyloxy, formula (P-16) or formula (P-17);

A² is independently 1,4-cyclohexylene, 1,4-phenylene, 4,4′-biphenylene, naphthalene-2,6-diyl, decahydronaphthalene-2,6-diyl, 1,2,3,4-tetrahydronaphthalene-2,6-diyl, or 1,4-phenylene in which at least one of hydrogen is replaced by halogen;

Z¹ is independently a single bond, —O—, —COO—, —OCO—, —CH═CH—COO—, —OCO—CH═CH—, —CH₂CH₂—COO—, —OCO—CH₂CH₂—, —OCF₂— or —(CH₂)ₚ—, and one of —CH₂— in —(CH₂)ₚ— may be replaced by —O—;

p is independently an integer from 1 to 20; and

r is independently an integer from 1 to 3.

Item 3. The infrared reflecting film according to item 1 or 2, wherein at least one kind of polymerization initiator is added as component (C) to the polymerizable liquid crystal composition.

Item 4. The infrared reflecting film according to item 3, wherein the polymerization initiator is a photopolymerization initiator having oxime ester.

Item 5. The infrared reflecting film according to any one of items 2 to 4, wherein,

in formula (1-1),

X¹ is independently hydrogen or methyl;

W¹² is independently hydrogen, halogen, alkyl having 1 to 7 carbons or alkoxy having 1 to 7 carbons;

n¹¹ is independently an integer from 2 to 20;

in formula (2-2),

Y² is independently a group represented by formula (2-1);

in formula (2-1),

R¹ is independently alkenyl having 2 to 20 carbons or alkyl having 1 to 20 carbons, at least one of —CH₂— in the group may be replaced by —O—, excluding a case where —O— is adjacent, at least one of hydrogen in the group may be replaced by halogen, and one of hydrogen in the group may be replaced by acryloyloxy, methacryloyloxy, formula (P-16) or formula (P-17);

Z¹ is independently a single bond, —O—, —COO—, —OCO—, —CH═CH—COO—, —OCO—CH═CH—, —CH₂CH₂—COO—, —OCO—CH₂CH₂— or —(CH₂)ₚ—, and one of —CH₂— in —(CH₂)ₚ— may be replaced by —O—; and

p is independently an integer from 1 to 10.

Item 6. The infrared reflecting film according to item 5, wherein, in formula (1-1), W¹² is independently hydrogen, fluorine, alkyl having 1 to 7 carbons or alkoxy having 1 to 7 carbons;

n¹¹ is independently an integer from 2 to 10;
in formula (2-2),

Y² is independently a group represented by formula (2-1); and

in formula (2-1),

p is independently an integer from 1 to 3.

Item 7. The infrared reflecting film according to any one of items 1 to 6, wherein the polymerizable liquid crystal composition further contains at least one compound selected from the group of achiral polymerizable liquid crystal compounds represented by formula (3-1), formula (3-2) and formula (3-3) as component (D):

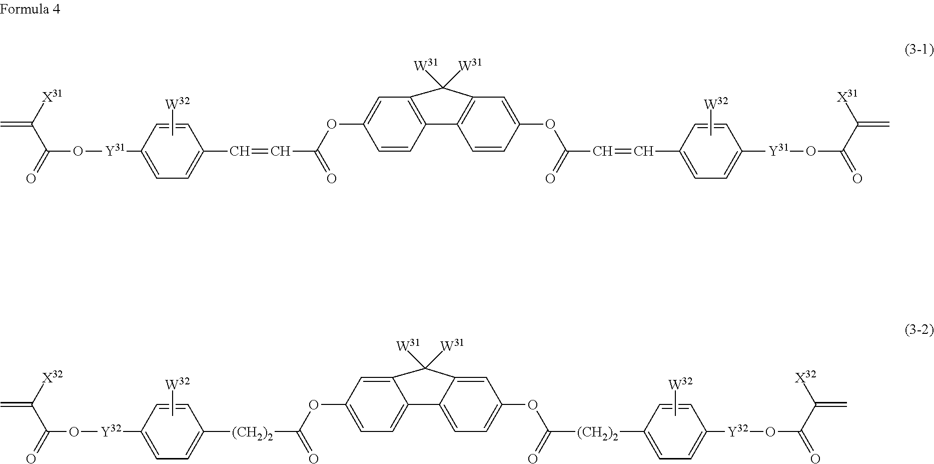

wherein, in formula (3-1),

X³¹ is independently hydrogen, methyl or trifluoromethyl;

Y³¹ is independently alkylene having 1 to 20 carbons, and at least one of —CH₂— may be replaced by —O—, —S—, —COO—, —OCO— or —OCOO—, at least one of —CH₂CH₂— may be replaced by —CH═CH— or —C≡C—, and in the groups, at least one of hydrogen may be replaced by fluorine or chlorine;

W³¹ is independently hydrogen, fluorine, chlorine, methyl or ethyl, and at least one of hydrogen in the methyl and the ethyl may be replaced by halogen;

W³² is independently hydrogen, halogen, nitro, cyano, alkyl having 1 to 7 carbons or alkoxy having 1 to 7 carbons;

in formula (3-2),

W³¹ and W³² are defined in a manner identical with the definitions described above;

Y³² is defined in a manner identical with the definitions of Y³¹, and

X³² is defined in a manner identical with the definitions of X³¹.

Item 8. The infrared reflecting film according to any one of items 1 to 7, wherein the polymerizable liquid crystal composition further contains at least one compound selected from the group of achiral polymerizable liquid crystal compounds represented by formula (4) as component (E):

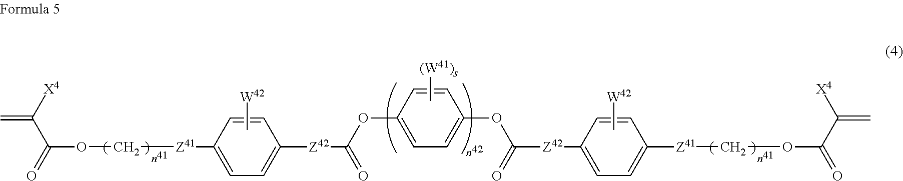

wherein, in formula (4),

X⁴ is independently hydrogen, methyl, fluorine or trifluoromethyl;

W⁴² is independently hydrogen, halogen, nitro, cyano, alkyl having 1 to 7 carbons or alkoxy having 1 to 7 carbons, and in the alkyl and the alkoxy, at least one of hydrogen may be replaced by fluorine;

W⁴¹ is independently hydrogen, halogen, nitro, cyano, phenyl, benzyl, alkyl having 1 to 7 carbons, alkoxy having 1 to 7 carbons, alkoxycarbonyl (—COOR^{a}; R^{a} is straight-chain alkyl having 1 to 7 carbons) or alkylcarbonyl (—COR^{b}; R^{b} is straight-chain alkyl having 1 to 16 carbons), and in the alkyl and the alkoxy, at least one of hydrogen may be replaced by fluorine;

s is an integer from 0 to 4;

n⁴¹ is independently an integer from 2 to 12;

n⁴² is an integer from 1 to 3;

Z⁴¹ is independently a single bond, —O—, —CO—, —CH═CH—, —COO—, —OCO—, —OCO—CH═CH—COO— or —OCOO—; and

Z⁴² is independently a single bond, —CH₂CH₂— or —CH═CH—.

Item 9. The infrared reflecting film according to any one of items 1 to 8, wherein the polymerizable liquid crystal composition further contains at least one compound selected from the group of achiral polymerizable liquid crystal compounds represented by formula (5-1) and formula (5-2) as component (F):

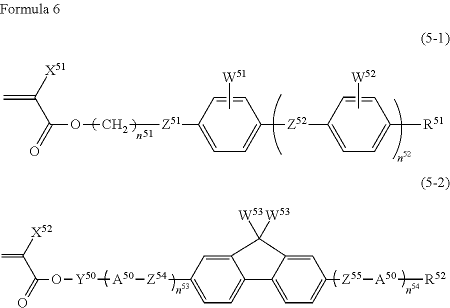

wherein, in formula (5-1),

X⁵¹ is hydrogen, methyl, fluorine or trifluoromethyl; R⁵¹ is cyano, trifluoromethoxy, alkyl having 1 to 20 carbons, alkyl ester having 1 to 20 carbons (—COOR^{c}, —OCOR^{c} or —CH═CH—COOR^{c}; R^{c} is straight-chain alkyl having 1 to 20 carbons) or alkoxy having 1 to 20 carbons, and in the alkyl and the alkoxy, at least one of hydrogen may be replaced by fluorine;

W⁵¹ and W⁵² are independently hydrogen, halogen, nitro, cyano, alkyl having 1 to 7 carbons or alkoxy having 1 to 7 carbons, and in the alkyl and the alkoxy, at least one of hydrogen may be replaced by fluorine;

Z⁵¹ is a single bond, —O—, —COO—, —OCO— or —OCOO—;

Z⁵² is independently a single bond, —COO—, —OCO—, —CH═CH—COO—, —OCO—CH═CH—, —CH₂CH₂—COO—, —OCO—CH₂CH₂— or —C≡C—;

n⁵¹ is an integer from 2 to 12;

n⁵² is an integer from 1 to 2;

in formula (5-2),

X⁵² is independently hydrogen, methyl, fluorine or trifluoromethyl;

R⁵² is cyano, trifluoromethoxy, alkyl having 1 to 20 carbons, alkyl ester having 1 to 20 carbons (—COOR^{c}, —OCOR^{c} or —CH═CH—COOR^{c}; R^{c} is straight-chain alkyl having 1 to 20 carbons) or alkoxy having 1 to 20 carbons, and in the alkyl and the alkoxy, at least one of hydrogen may be replaced by fluorine;

W⁵³ is independently hydrogen, fluorine, chlorine, methyl or ethyl, and at least one of hydrogen in the methyl and the ethyl may be replaced by halogen;

Y⁵⁰ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine;

A⁵⁰ is independently a single bond, 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;

Z⁵⁴ and Z⁵⁵ are each independently a single bond, —COO—, —OCO—, —OCOO—, —CH═CH—COO—, —OCO—CH═CH—, —CH₂CH₂—OCO—, —OCO—CH₂CH₂— or —C≡C—; and,

n⁵³ and n⁵⁴ are independently 0 or 1.

Item 10. The infrared reflecting film according to any one of items 1 to 9, wherein the polymerizable liquid crystal composition further contains at least one compound selected from the group of achiral polymerizable liquid crystal compounds represented by formulas (6-1) and (6-2) as component (G):

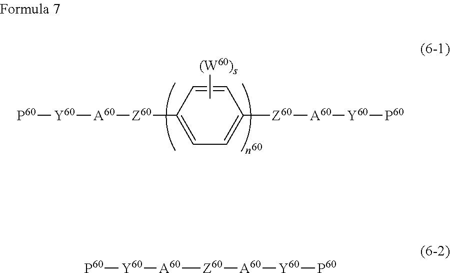

wherein, in formula (6-1) and formula (6-2),

P⁶⁰ is independently represented by any one of formula (P-8) to formula (P-18);

Y⁶⁰ is independently a single bond or alkylene having 1 to 20 carbons, and at least one of —CH₂— may be replaced by —O—, —S—, —COO—, —OCO—, —OCOO—, excluding a case where —O— is adjacent, at least one of —CH₂CH₂— may be replaced by —CH═CH— or —C≡C—, and in the groups, at least one of hydrogen may be replaced by fluorine or chlorine;

A⁶⁰ is independently 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;

Z⁶⁰ is independently a single bond, —COO—, —OCO—, —CH═CH—COO—, —OCO—CH═CH—, —CH₂CH₂—COO—, —OCO—CH₂CH₂— or —C≡C—;

W⁶⁰ is independently hydrogen, halogen, nitro, cyano, phenyl, benzyl, alkyl having 1 to 7 carbons, alkoxy having 1 to 7 carbons, alkoxycarbonyl (—COOR^{a}; R^{a} is straight-chain alkyl having 1 to 7 carbons) or alkylcarbonyl (—COR^{b}; R^{b} is straight-chain alkyl having 1 to 16 carbons), and in the alkyl and the alkoxy, at least one of hydrogen may be replaced by fluorine;

s is an integer from 0 to 4; and

n⁶⁰ is an integer from 1 to 3.

Item 11. The infrared reflecting film according to any one of items 1 to 10, wherein the polymerizable liquid crystal composition further contains at least one compound selected from the group of achiral polymerizable liquid crystal compounds represented by formula (7-1) and formula (7-2) as component (H):

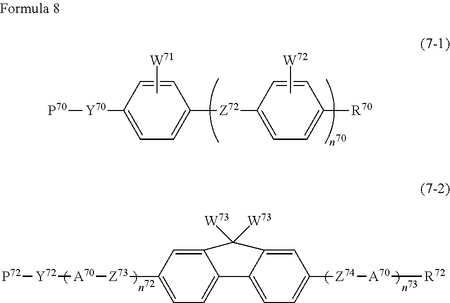

wherein, in formula (7-1),

P⁷⁰ is independently represented by any one of formula (P-8) to formula (P-18);

Y⁷⁰ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine;

W⁷¹ and W⁷² are independently hydrogen, halogen, nitro, cyano, alkyl having 1 to 7 carbons or alkoxy having 1 to 7 carbons;

Z⁷² is independently a single bond, —COO—, —OCO—, —CH═CH—COO—, —OCO—CH═CH—, —CH₂CH₂—COO—, —OCO—CH₂CH₂— or —C≡C—;

R⁷⁰ is cyano, trifluoromethoxy, alkyl having 1 to 20 carbons, alkyl ester having 1 to 20 carbons (—COOR^{c}, —OCOR^{c} or —CH═CH—COOR^{c}; R^{c} is straight-chain alkyl having 1 to 20 carbons) or alkoxy having 1 to 20 carbons, and in the alkyl and the alkoxy, at least one of hydrogen may be replaced by fluorine;

n⁷⁰ is an integer from 1 to 2;

in formula (7-2),

P⁷² is independently represented by any one of formula (P-8) to formula (P-18);

Y⁷² is independently a single bond or alkylene having 1 to 20 carbons, and at least one of —CH₂— may be replaced by —O—, —S—, —COO—, —OCO—, or —OCOO—, excluding a case where —O— is adjacent, at least one of —CH₂CH₂— may be replaced by —CH═CH— or —C≡C—, and in the groups, at least one of hydrogen may be replaced by fluorine or chlorine;

W⁷³ is independently hydrogen, fluorine, chlorine, methyl or ethyl, and at least one of hydrogen in the methyl and the ethyl may be replaced by halogen;

Z⁷³ and Z⁷⁴ are each independently a single bond, —COO—, —OCO—, —CH═CH—COO—, —OCO—CH═CH—, —CH₂CH₂—COO—, —OCO—CH₂CH₂— or —C≡C—;

A⁷⁰ is independently a single bond, 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;

R⁷² is cyano, trifluoromethoxy, alkyl having 1 to 20 carbons, alkyl ester having 1 to 20 carbons (—COOR^{c}, —OCOR^{c} or —CH═CH—COOR^{c}; R^{c} is straight-chain alkyl having 1 to 20 carbons) or alkoxy having 1 to 20 carbons, and in the alkyl and the alkoxy, at least one of hydrogen may be replaced by fluorine; and n⁷² and n⁷³ are independently 0 or 1.

Item 12. The infrared reflecting film according to any one of items 1 to 11, wherein a surfactant is added to the polymerizable liquid crystal composition.

Item 13. The infrared reflecting film according to any one of items 1 to 12, wherein a weathering agent is added to the polymerizable liquid crystal composition.

Item 14. A laminated film, including two or more layers of the infrared reflecting film according to any one of items 1 to 13.

Item 15. The laminated film according to item 14, including a ½λ layer.

Item 16. The laminated film according to item 15, wherein the ½λ layer includes a stretched film.

### Advantageous Effects of Invention

An infrared reflecting film obtained by aligning a polymerizable liquid crystal composition containing a polymerizable optically active compound having a binaphthol structure and a polymerizable liquid crystal compound having a fluorene skeleton and curing the resultant aligned material has stable alignment uniformity. Moreover, the infrared reflecting film has excellent adhesion properties with a support substrate, and is expected to be useful for improving reliability.

### DESCRIPTION OF EMBODIMENTS

Usage of terms herein is as described below. “Liquid crystal compound” is a generic term for a compound having a liquid crystal phase, and a compound having no liquid crystal phase but being useful as a component of a liquid crystal composition. The liquid crystal phase includes a nematic phase, a smectic phase and a cholesteric phase, and in many cases, means the nematic phase. Polymerizability means capability of a monomer polymerizing by means of light, heat, a catalyst or the like to give a polymer. A compound represented by formula (1) may be occasionally represented as compound (1) or formula (1). A compound represented by any other formula may be referred to according to a similar simplification method. A meaning of a term “liquid crystallinity” is not limited only to having the liquid crystal phase. The crystallinity semantically includes characteristics in which a compound can be used as a component when the compound is mixed with other liquid crystal compounds, even if the compound itself has no liquid crystal phase. A term “arbitrary” used upon describing compound structure means being arbitrary not only for a position but also for the number. Further, for example, an expression “arbitrary A may be replaced by B, C or D” means inclusion of a case where arbitrary A is replaced by B, a case where arbitrary A is replaced by C and a case where arbitrary A is replaced by D, and also a case where a plurality of A are replaced by at least two of B to D. However, a definition by which arbitrary —CH₂— may be replaced by —O— excludes replacement resulting in producing a bonding group —O—O—. When arbitrary —CH₂— is replaced by —CH═CH— or a case where the number of carbons exceeds the range described is excluded. For example, when Y¹ in formula (1) is alkylene having 1 to 20 carbons, and in the alkylene, arbitrary —CH₂— may be replaced by —CH═CH— or the number of carbons of alkylene including —CH₂— replaced by —CH═CH— or —C≡C— does not exceed 20 in the above case. The rule is also applied to any other definition in a similar manner.

In a substituent in which a position of connection with ring-constituting carbon is unclear, the connecting position semantically is free within the range in which the position chemically has no problems. An optically active compound having a binaphthol moiety according to the invention may be occasionally referred to as an optically active compound or only a compound. A composition containing a polymerizable liquid crystal compound and an optically active compound having the binaphthol moiety is referred to as the polymerizable liquid crystal composition, and a case where any other component such as a polymerization initiator, a surfactant and a weathering agent is added to the polymerizable liquid crystal composition, the resultant added material may be occasionally referred to as a composition. Moreover, the polymerizable liquid crystal composition may be occasionally referred to only as a liquid crystal composition. A case where a compound has one polymerizable group may be occasionally referred to as monofunctionality. A case where a compound has a plurality of polymerizable groups may be occasionally referred to as polyfunctionality or may be occasionally referred to by the number corresponding to the number of polymerizable groups.

As a chemical formula, when a content described below is described, a straight line from A to B means a bond in which hydrogen in group B is replaced by group A, and a position thereof is arbitrary. X represents the number of groups A to be replaced. A case where X is 0 represents absence of A or no replacement.

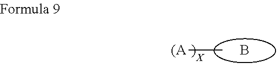

The polymerizable liquid crystal composition according to the invention contains at least one compound selected from the group of achiral polymerizable liquid crystal compounds represented by formula (1) as component (A). The compound represented by formula (1) is preferably represented by formula (1-1).

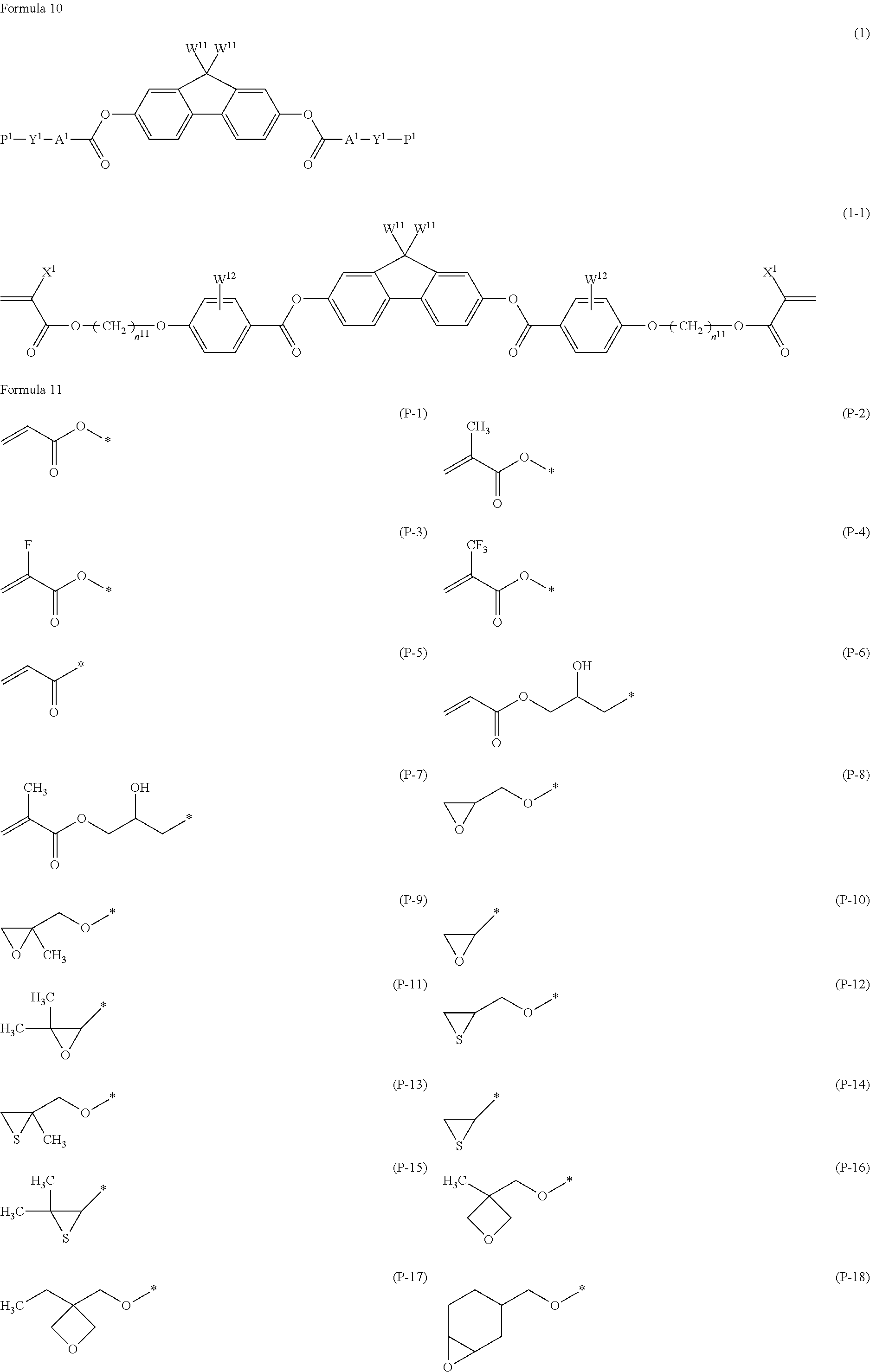

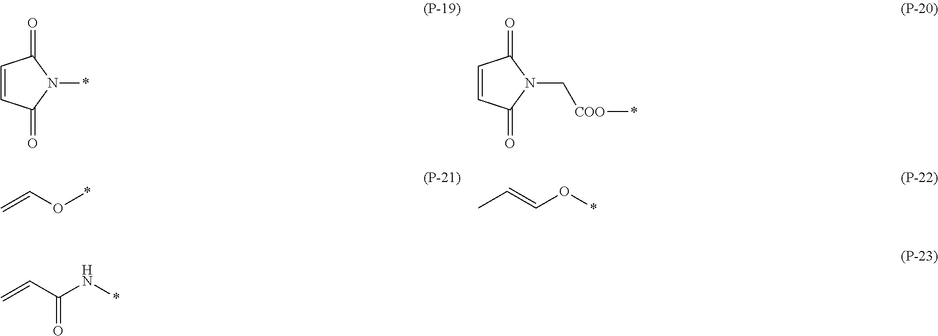

wherein, in (P-1) to (P-23), * represents a bonding site.

In formula (1),

P¹ is independently represented by any one of formulas (P-1) to (P-23), and preferably, any one of formulas (P-1) to (P-11) or formulas (P-16) to (P-18).

W¹¹ is independently hydrogen, fluorine, chlorine, methyl or ethyl, and at least one of hydrogen in the methyl and the ethyl may be replaced by halogen, and preferably, hydrogen or methyl. In the invention, “halogen” means a group 17 element, and specifically, fluorine, chlorine, bromine or iodine, and preferably, fluorine, chlorine or bromine.

A¹ is independently 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons,

Y¹ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine.

Formula (1) preferably includes formula (1-1), and W¹¹ is defined in a manner identical with the definitions described above.

In formula (1-1),

X¹ is independently hydrogen, methyl, fluorine or trifluoromethyl, and preferably, hydrogen or methyl,

W¹¹ is preferably independently hydrogen or methyl,

W¹² is independently hydrogen, halogen, nitro, cyano, alkyl having 1 to 7 carbons or alkoxy having 1 to 7 carbons, preferably, hydrogen, halogen, alkyl having 1 to 7 carbons or alkoxy having 1 to 7 carbons, and further preferably, hydrogen, alkyl having 1 to 7 carbons or alkoxy having 1 to 7 carbons, and

n¹¹ is independently an integer from 2 to 20, preferably, 2 to 12, further preferably, 2 to 10, and still further preferably, an integer from 3 to 6.

The polymerizable liquid crystal composition according to the invention contains at least one compound selected from the group of optically active compounds having binaphthol moieties represented by formula (2) (preferably formula (2-2)) as component (B).

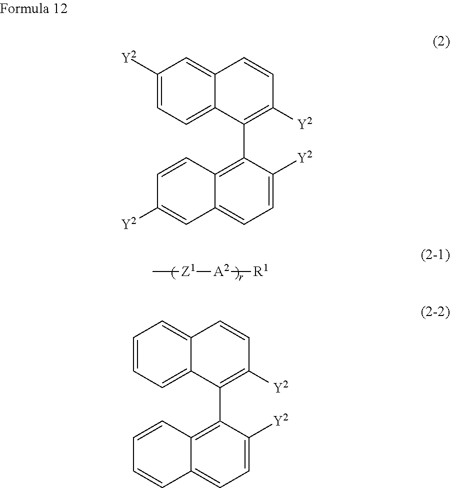

In formula (2),

Y² is independently hydrogen, halogen or a group represented by formula (2-1), however, in Y², at least two are a group represented by formula (2-1), preferably, a bonding pattern in formula (2-2).

In formula (2-1),

R¹ is independently halogen, cyano, alkenyl having 2 to 20 carbons, or alkyl having 1 to 20 carbons, at least one of —CH₂— in the group may be replaced by —O—, excluding a case where —O— is adjacent, and at least one of hydrogen in the group may be replaced by halogen. In one or two of Y², one of hydrogen in R¹ may be replaced by any one of formulas (P-1) to (P-23), preferably, any one of formula (P-1) to formula (P-11) or formula (P-16) to formula (P-18).

R¹ is preferably alkyl having 1 to 20 carbons, at least one of —CH₂— in the group may be replaced by —O—, excluding a case where —O— is adjacent, and in one or two of Y², one of hydrogen in R¹ is replaced by a group represented by any one of formula (P-1) to formula (P-11) or formula (P-16) to formula (P-18).

A² is independently 1,4-cyclohexylene, 1,4-phenylene, 4,4′-biphenylene, naphthalene-2,6-diyl, decahydronaphthalene-2,6-diyl, 1,2,3,4-tetrahydronaphthalene-2,6-diyl, or 1,4-phenylene in which at least one of hydrogen is replaced by halogen.

Z¹ is independently a single bond, —O—, —COO—, —OCO—, —CH═CH—COO—, —OCO—CH═CH—, —CH₂CH₂—COO—, —OCO—CH₂CH₂—, —OCF₂— or —(CH₂)ₚ—, and one of —CH₂— in —(CH₂)ₚ— may be replaced by —O—.

Then, p is independently an integer from 1 to 20, preferably, an integer from 1 to 10, and further preferably, an integer from 1 to 6.

Then, r is independently an integer from 1 to 3.

A compound represented by formula (2) preferably includes a compound represented by formula (2-2).

In formula (2-2),

Y² is independently a group represented by formula (2-1);

in formula (2-1),

R¹ is independently halogen, cyano, alkenyl having 2 to 20 carbons, or alkyl having 1 to 20 carbons, at least one of —CH₂— in the group may be replaced by —O—, excluding a case where —O— is adjacent, at least one of hydrogen in the group may be replaced by halogen, and in one or two of Y², one of hydrogen in R¹ may be replaced by acryloyloxy, methacryloyloxy, formula (P-16) or formula (P-17);

A² is independently 1,4-cyclohexylene, 1,4-phenylene, 4,4′-biphenylene, naphthalene-2,6-diyl, decahydronaphthalene-2,6-diyl, 1,2,3,4-tetrahydronaphthalene-2,6-diyl, or 1,4-phenylene in which at least one of hydrogen is replaced by halogen;

Z¹ is independently a single bond, —COO—, —OCO—, —CH═CH—COO—, —OCO—CH═CH—, —CH₂CH₂—COO—, —OCO—CH₂CH₂—, —OCF₂— or —(CH₂)ₚ—, and one of —CH₂— in —(CH₂)ₚ— may be replaced by —O—;

p is independently an integer from 1 to 20, preferably, an integer from 1 to 10, and further preferably, an integer from 1 to 3; and

r is independently an integer from 1 to 3.

The polymerizable liquid crystal composition according to the invention may contain at least one compound selected from the group of polymerizable achiral liquid crystal compounds represented by formula (3-1) and formula (3-2) as component (D).

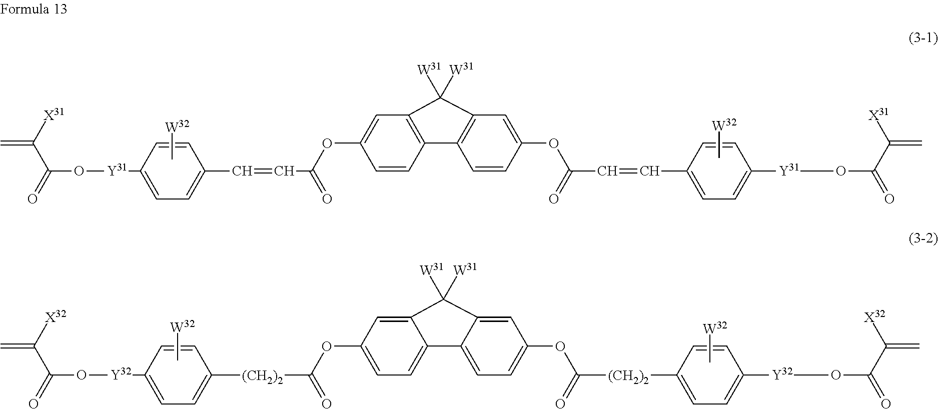

In formula (3-1),

X³¹ is independently hydrogen, methyl or trifluoromethyl.

Y³¹ is independently alkylene having 1 to 20 carbons, and at least one of —CH₂— may be replaced by —O—, —S—, —COO—, —OCO—, —OCOO—, —CH═CH— or —C≡C—, at least one of —CH₂CH₂— may be replaced by —CH═CH— or —C≡C—, and in the groups, at least one of hydrogen may be replaced by fluorine or chlorine.

W³¹ is independently hydrogen, fluorine, chlorine, methyl or ethyl, and at least one of hydrogen in the methyl and the ethyl may be replaced by halogen.

W³² is independently hydrogen, halogen, nitro, cyano, alkyl having 1 to 7 carbons or alkoxy having 1 to 7 carbons.

In formula (3-2),

W³¹ and W³² are defined in a manner identical with definitions described above.

Y³² is defined in a manner identical with the definitions of Y³¹. Moreover, X³² is defined in a manner identical with the definitions of X³¹.

The polymerizable liquid crystal composition according to the invention may contain at least one compound selected from the group of achiral polymerizable liquid crystal compounds represented by formula (4) as component (E).

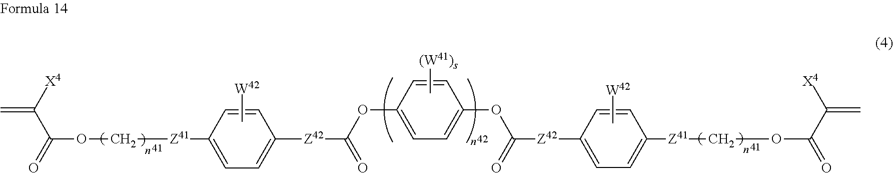

In formula (4),

X⁴ is independently hydrogen, methyl, fluorine or trifluoromethyl.

W⁴² is independently hydrogen, halogen, nitro, cyano, alkyl having 1 to 7 carbons or alkoxy having 1 to 7 carbons, and in the alkyl and the alkoxy, at least one of hydrogen may be replaced by fluorine.

W⁴¹ is independently halogen, nitro, cyano, phenyl, benzyl, alkyl having 1 to 7 carbons, alkoxy having 1 to 7 carbons, alkoxycarbonyl (—COOR^{a}; R^{a} is straight-chain alkyl having 1 to 7 carbons) or alkylcarbonyl (—COR^{b}; R^{b} is straight-chain alkyl having 1 to 16 carbons), and in the alkyl and the alkoxy, at least one of hydrogen may be replaced by fluorine.

Then, s is an integer from 0 to 4.

Then, n⁴¹ is independently an integer from 2 to 10, and preferably, an integer from 3 to 6.

Then, n⁴² is an integer from 1 to 3.

Z⁴¹ is independently a single bond, —O—, —CO—, —CH═CH—, —COO—, —OCO—, —OCO—CH═CH—COO— or —OCOO—.

Z⁴² is independently a single bond, —CH₂CH₂— or —CH═CH—.

The polymerizable liquid crystal composition according to the invention may contain at least one compound selected from the group of achiral polymerizable liquid crystal compounds represented by formula (5-1) and formula (5-2) as component (F).

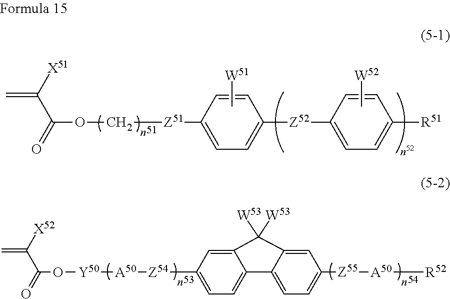

In formula (5),

X⁵¹ is hydrogen, methyl, fluorine or trifluoromethyl.

R⁵¹ is cyano, trifluoromethoxy, alkyl having 1 to 20 carbons (preferably, straight-chain alkyl having 1 to 10 carbons), alkyl ester having 1 to 20 carbons (—COOR^{c}, —OCOR^{c} or —CH═CH—COOR^{c}; R^{c} is straight-chain alkyl having 1 to 20 carbons (preferably, 1 to 10 carbons)) or alkoxy having 1 to 20 carbons (preferably, straight-chain alkoxy having 1 to 10 carbons), and in the alkyl and the alkoxy, at least one of hydrogen may be replaced by fluorine.

W⁵¹ and W⁵² are independently hydrogen, halogen, nitro, cyano, alkyl having 1 to 7 carbons or alkoxy having 1 to 7 carbons, and in the alkyl and the alkoxy, at least one of hydrogen may be replaced by fluorine.

Z⁵¹ is a single bond, —O—, —COO—, —OCO— or —OCOO—.

Z⁵² is independently a single bond, —COO—, —OCO—, —CH═CH—COO—, —OCO—CH═CH—, —CH₂CH₂—COO—, —OCO—CH₂CH₂— or —C≡C—.

Then, n⁵¹ is an integer from 2 to 12, and preferably, an integer from 3 to 6.

Then, n⁵² is an integer from 1 to 2.

In formula (5-2),

X⁵² is hydrogen, methyl, fluorine or trifluoromethyl.

R⁵² is cyano, trifluoromethoxy, alkyl having 1 to 20 carbons (preferably, straight-chain alkyl having 1 to 10 carbons), alkyl ester having 1 to 20 carbons (—COOR^{c}, —OCOR^{c} or —CH═CH—COOR^{c}; R^{c} is straight-chain alkyl having 1 to 10 carbons) or alkoxy having 1 to 20 carbons (preferably, straight-chain alkoxy of 1 to 10 carbons), and in the alkyl and the alkoxy, at least one of hydrogen may be replaced by fluorine.

W⁵³ is independently hydrogen, fluorine, chlorine, methyl or ethyl, and at least one of hydrogen in the methyl and the ethyl may be replaced by halogen.

Y⁵⁰ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine.

A⁵⁰ is independently a single bond, 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons.

Z⁵⁴ and e are each independently a single bond, —COO—, —OCO—, —OCOO—, —CH═CH—COO—, —OCO—CH═CH—, —CH₂CH₂—COO—, —OCO—CH₂CH₂— or —C≡C—.

Then, n⁵³ and n⁵⁴ are independently 0 or 1.

The polymerizable liquid crystal composition according to the invention may contain at least one compound selected from the group of achiral polymerizable liquid crystal compounds represented by formula (6-1) and formula (6-2) as component (G).

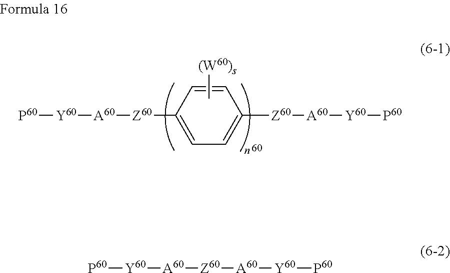

In formula (6-1) and formula (6-2),

P⁶⁰ is independently represented by any one of formulas (P-8) to (P-18),

Y⁶⁰ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C— and in the groups, at least one of hydrogen may be replaced by fluorine or chlorine,

A⁶⁰ is independently 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons,

Z⁶⁰ is independently a single bond, —COO—, —OCO—, —CH═CH—COO—, —OCO—CH═CH—, —CH₂CH₂—COO—, —OCO—CH₂CH₂— or —C≡C—,

W⁶⁰ is independently halogen, nitro, cyano, phenyl, benzyl, alkyl having 1 to 7 carbons, alkoxy having 1 to 7 carbons, alkoxycarbonyl (—COOR^{a}; R^{a} is straight-chain alkyl having 1 to 7 carbons) or alkylcarbonyl (—COR^{b}; R^{b} is straight-chain alkyl having 1 to 16 carbons), and in the alkyl and the alkoxy, at least one of hydrogen may be replaced by fluorine,

s is an integer from 0 to 4, and

n⁶⁰ is an integer from 1 to 3.

The polymerizable liquid crystal composition according to the invention may contain at least one compound selected from the group of achiral polymerizable liquid crystal compounds represented by formula (7-1) and formula (7-2) as component (H).

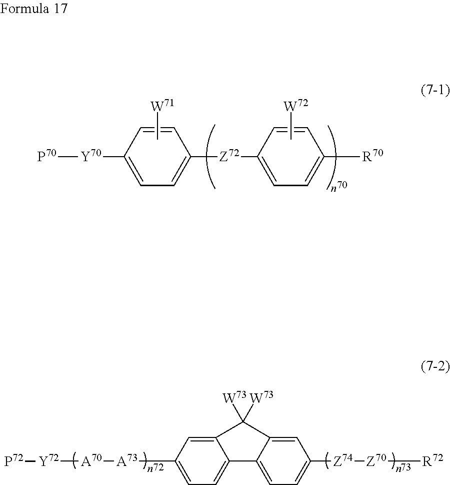

In formula (7-1),

P⁷⁰ are independently represented by any one of formulas (P-8) to (P-18),

Y⁷⁰ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine,

W⁷¹ and W⁷² are independently hydrogen, halogen, nitro, cyano, alkyl having 1 to 7 carbons or alkoxy having 1 to 7 carbons,

Z⁷² is independently a single bond, —COO—, —OCO—, —CH═CH—COO—, —OCO—CH═CH—, —CH₂CH₂—OCO—, —OCO—CH₂CH₂— or —C≡C—,

R⁷⁰ is cyano, trifluoromethoxy, alkyl having 1 to 20 carbons (preferably, straight-chain alkyl having 1 to 10 carbons), alkyl ester having 1 to 20 carbons (—COOR^{c}, —OCOR^{c} or —CH═CH—COOR^{c}; R^{c} is straight-chain alkyl having 1 to 20 carbons (preferably, 1 to 10 carbons)) or alkoxy having 1 to 20 carbons (preferably, straight-chain alkoxy having 1 to 10 carbons), and in the alkyl and the alkoxy, at least one of hydrogen may be replaced by fluorine, and

n⁷⁰ is an integer from 1 to 2.

In formula (7-2),

P⁷² are independently represented by any one of formulas (P-8) to (P-18);

Y⁷² is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine;

W⁷³ is independently hydrogen, fluorine, chlorine, methyl or ethyl, and at least one of hydrogen in the methyl and the ethyl may be replaced by halogen;

Z⁷³ and Z⁷⁴ are each independently a single bond, —COO—, —OCO—, —CH═CH—COO—, —OCO—CH═CH—, —CH₂CH₂—COO—, —OCO—CH₂CH₂— or —C≡C—;

A⁷⁰ is independently a single bond, 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;

R⁷² is cyano, trifluoromethoxy, alkyl having 1 to 20 carbons (preferably, straight-chain alkyl having 1 to 10 carbons), alkyl ester having 1 to 20 carbons (—COOR^{c}, —OCOR^{c} or —CH═CH—COOR^{c}; R^{c} is straight-chain alkyl having 1 to 20 carbons (preferably, straight-chain alkyl having 1 to 10 carbons)) or alkoxy having 1 to 20 carbons (preferably, straight-chain alkoxy having 1 to 10 carbons), and in the alkyl and the alkoxy, at least one of hydrogen may be replaced by fluorine; and

n⁷² and n⁷³ are independently 0 or 2.

In addition to component (A) and component (B), the polymerizable liquid crystal composition according to the invention may contain component (D), component (E), component (F), component (G) and component (H) alone, respectively, or may contain the components together.

Moreover, the polymerizable liquid crystal composition according to the invention may further contain component (C) in addition to component (A) and component (B).

The polymerizable liquid crystal composition according to the invention may further contain the surfactant. Specific examples of the surfactant include a cationic surfactant, an anionic surfactant and a nonionic surfactant, and specific examples of the nonionic surfactant include a vinyl-based surfactant, a fluorine-based surfactant, a silicone-based surfactant or a hydrocarbon-based surfactant. The nonionic surfactant is effective in improving smoothness of an applied film.

The polymerizable liquid crystal composition according to the invention has the nematic phase at room temperature, and is subjected to twist alignment on a plastic substrate subjected to rubbing treatment or photo-alignment treatment or on an alignment film such as a polyimide film subjected to the photo-alignment treatment or rubbing alignment treatment. The twist alignment herein is also referred to as planar molecular arrangement, and liquid crystal molecules are aligned such that a helical axis of the liquid crystal may become perpendicular to a substrate plane. The alignment is also referred to as Grandjean arrangement. In such alignment, a tilt angle of the liquid crystal molecules on a side of an air interface is preferably horizontal to the substrate plane, and addition of the nonionic surfactant to the polymerizable liquid crystal composition according to the invention facilitates the planar arrangement.

The compounds used for polymerizable liquid crystal composition according to the invention will be described.

The compound represented by formula (1) has a skeleton having specific structure centering on a fluorene ring, and two polymerizable groups. The compound has fluorene structure, and therefore birefringence (Δn) of a cured film tends to be large. When the birefringence is increased, a reflection band tends to be extended as describe below. The compound exhibits liquid crystallinity, and maintenance of the liquid crystal phase at room temperature become easy, and therefore reduction of a fault, during the film formation, caused by crystallization is expected. The polymer of the polymerizable liquid crystal compound forms three-dimensional structure, and therefore serves as a harder polymer in comparison with a compound having one polymerizable group.

The compound represented by formula (2) includes the optically active compound having the binaphthol moiety as axial asymmetry. The compound has comparatively large helical twisting power, and even a small amount of addition of the compound allows formation of helical structure to reflect infrared light. An effect is developed by addition of the small amount, and therefore characteristics of the achiral liquid crystal serving as a host are not adversely affected. Moreover, when the compound has the polymerizable group, the compound may be cross-linked with any other achiral polymerizable liquid crystal compound to form dense three-dimensional structure, and therefore the resulting optically anisotropic substance becomes strong.

The compounds represented by formulas (3-1) to (3-2) include a compound having two polymerizable groups centering on a fluorene ring, and has a bonding moiety different from the bonding moiety in formula (1). The polymer of the polymerizable liquid crystal compound forms three-dimensional structure, and therefore serves as a harder polymer in comparison with the compound having one polymerizable group. The compound may or may not exhibit the liquid crystallinity. The compound has a central skeleton common with the skeleton in formula (1), and therefore is easily compatibilized to easily adjust a melting point of the polymerizable liquid crystal composition. Moreover, the compound represented by formula (3-1) has a cinnamate moiety, and therefore can further increase Δn, and the compound represented by formula (3-2) has an ethyl ester moiety, and therefore can decrease the melting point of the composition. The compounds represented by formulas (3-1) to (3-2) and a compound derived therefrom may be occasionally referred to as formula (3) hereinafter as a generic term.

The compound represented by formula (4) has a phenylene skeleton and two polymerizable groups. The compound is easily homogeneously aligned, when coating is made on a rubbing treatment substrate with an alignment film polymer having no side chain or when the nonionic surfactant is added to the polymerizable liquid crystal composition, although a degree depends on conditions of a support substrate, an additive or the like. Moreover, the compound tends to exhibit the liquid crystal phase in a wide temperature range. A compound derived from formula (4) may be occasionally referred to as formula (4) hereinafter as a generic term in a manner similar to formula (3) as described above.

The compounds represented by formula (5-1) and formula (5-2) have a phenylene skeleton or fluorene skeleton, and one polymerizable group. The compounds have monofunctionality, and thus a cured film to be formed can be provided with flexibility, and therefore the helical pitches are easily nonuniformalized by conditions in a curing process (temperature, exposure conditions or the like) as described later. The compound has properties of increasing a tilt angle of other liquid crystal molecules or decreasing a melting point thereof. Compounds derived from formula (5-1) and formula (5-2) may be occasionally referred to as formula (5) hereinafter as a generic term in a manner similar to formula (3) as described above.

The compounds represented by formula (6-1) and formula (6-2) have two cationically polymerizable functional groups. The polymer of the polymerizable liquid crystal compound forms three-dimensional structure, and therefore serves as a harder polymer in comparison with the compound having one polymerizable group. The compound may or may not exhibit the liquid crystallinity. The compound represented by formula (6-1) has phenylene structure in a center of the mesogen skeleton. The compounds represented by formula (6-2) has two ring structure. Cationic polymerization has a rate of polymerization different from a rate of polymerization in radical polymerization, and therefore a rate of immobilizing the helical structure of the cured film can be nonuniformalized. Moreover, cure shrinkage is low in the film of the polymer obtained by the cationic polymerization, and therefore the adhesion properties with the support substrate can be improved. Compounds derived from formula (6-1) and formula (6-2) may be occasionally referred to as formula (6) hereinafter as a generic term in a manner similar to formula (3) as described above.

The compounds represented by formula (7-1) and formula (7-2) have one cationically polymerizable functional group. The compound has properties of increasing a tilt angle of other liquid crystal molecules or decreasing a melting point thereof. The compound may or may not exhibit the liquid crystallinity. The compound represented by formula (7) has phenylene structure. In a manner similar to formula (6), the cationic polymerization has a rate of polymerization different from a rate of polymerization in the radical polymerization, and therefore the a rate of immobilizing the helical structure of the cured film can be nonuniformalized. Moreover, cure shrinkage is low in the film of the polymer obtained by the cationic polymerization, and therefore the adhesion properties with the support substrate can be improved. Compounds derived from formula (7-1) and formula (7-2) may be occasionally referred to as formula (7) hereinafter as a generic term in a manner similar to formula (3) as described above.

To the polymerizable liquid crystal composition according to the invention, any other polymerizable compound (hereinafter, also referred to as “any other polymerizable compound”) that is different from formula (1), formula (2), formula (3), formula (4), formula (5), formula (6) or formula (7), the surfactant or the weathering agent (an ultraviolet light absorber, an antioxidant, a radical scavenger, a light stabilizer or the like) may be added. To the polymerizable liquid crystal composition, a silane coupling agent may be added in order to improve the adhesion properties between a coating film and the support substrate. To the polymerizable liquid crystal composition, the polymerization initiator suitable for a polymerization reaction may be added, and also an additive such as a photosensitizer may be further added. To the polymerizable liquid crystal composition, an additive such as a chain transfer agent may be added in order to improve the characteristics of the polymer. To the polymerizable liquid crystal composition, an organic solvent may be added. The organic solvent is useful for forming the coating film having uniform thickness.

A content of each component in the polymerizable liquid crystal composition according to the invention will be described.

In the invention, the content of component (B) in the total weight of the achiral polymerizable liquid crystal compound and the optically active compound is approximately 0.1% by weight or more and approximately 5% by weight or less. When the content is in the range described above, the reflecting film that can reflect the infrared light in a preferred region can be obtained.

A preferred content of component (B)being the optically active compound having the binaphthol moiety is approximately 0.1% by weight or more and approximately 4.9% by weight or less based on the total weight of the achiral polymerizable liquid crystal compound and the optically active compound (for example, the total weight of component (A), component (B), component (D), component (E), component (F) component, component (G) and component (H)). A further preferred content is approximately 0.5% by weight or more and approximately 4.8% by weight or less based thereon. A still further preferred content is approximately 1.0% by weight or more and approximately 4.8% by weight or less based thereon.

A preferred content of the total weight of component (A), component (D), component (E), component (F), component (G) and component (H), each being the achiral polymerizable liquid crystal compound, is approximately 95% by weight to approximately 99.9% by weight based on the total weight of the achiral polymerizable liquid crystal compound and the optically active compound (for example, the total weight of component (A), component (B), component (D), component (E), component (F), component (G) and component (H)). A further preferred content is approximately 95% by weight to approximately 99.5% by weight based thereon. A still further preferred content is approximately 95% by weight to approximately 99% by weight based thereon.

A preferred content of component (A) is approximately 1% to approximately 99.9% by weight based on the total weight of the achiral polymerizable liquid crystal compound and the optically active compound. A further preferred content is approximately 3% by weight to approximately 99.5% by weight based thereon. A still further preferred content is approximately 5% by weight to approximately 99% by weight based thereon.

A preferred content of component (D) is approximately 0% by weight to approximately 75% by weight based on the total weight of the achiral polymerizable liquid crystal compound and the optically active compound. A further preferred content is approximately 0% by weight to approximately 70% by weight based thereon. A still further preferred content is approximately 0% by weight to approximately 50% by weight based thereon.

A preferred content of component (E) is approximately 0% by weight to approximately 75% by weight based on the total weight of the achiral polymerizable liquid crystal compound and the optically active compound. A further preferred content is approximately 0% by weight to approximately 70% by weight based thereon. A still further preferred content is approximately 0% by weight to approximately 60% by weight based thereon.

A preferred content of component (F) is approximately 0% by weight to approximately 75% by weight based on the total weight of the achiral polymerizable liquid crystal compound and the optically active compound. A further preferred content is approximately 0% by weight to approximately 70% by weight based thereon. A still further preferred content is approximately 0% by weight to approximately 50% by weight based thereon.

A preferred content of component (G) is approximately 0% by weight to approximately 75% by weight based on the total weight of the achiral polymerizable liquid crystal compound and the optically active compound. A further preferred content is approximately 0% by weight to approximately 70% by weight based thereon. A still further preferred content is approximately 0% by weight to approximately 60% by weight based thereon.

A preferred content of component (H) is approximately 0% by weight to approximately 75% by weight based on the total weight of the achiral polymerizable liquid crystal compound and the optically active compound. A further preferred content is approximately 0% by weight to approximately 70% by weight based thereon. A still further preferred content is approximately 0% by weight to approximately 50% by weight based thereon.

To the polymerizable liquid crystal composition according to the invention, the polymerization initiator may be added as component (C). Specific examples of the polymerization initiator include a photopolymerization initiator and a thermal polymerization initiator, and the photopolymerization initiator is preferred. The polymerization initiator in the invention preferably has no optically active moiety. A preferred ratio of adding the polymerization initiator being component (C) is approximately 0.01 to approximately 0.15 in terms of a weight ratio based on the total weight of the achiral polymerizable liquid crystal compound and the optically active compound. A further preferred ratio is approximately 0.02 to approximately 0.13 based thereon. A still further preferred ratio is approximately 0.03 to approximately 0.10 based thereon.

A preferred ratio of adding the surfactant is, although the ratio is different depending on a type of the surfactant, a composition ratio of the polymerizable liquid crystal compositions or the like, approximately 0.0001 to approximately 0.05 in terms of a weight ratio based on the total weight of the achiral polymerizable liquid crystal compound and the optically active compound. A further preferred ratio is approximately 0.0003 to approximately 0.03 based thereon. A still further preferred ratio is approximately 0.0005 to approximately 0.02 based thereon.

To the polymerizable liquid crystal composition according to the invention, the weathering agent (the ultraviolet light absorber, the antioxidant, the radical scavenger, the light stabilizer or the like) may be added. A preferred ratio of adding the weathering agent is approximately 0.001 to approximately 0.20 in terms of a weight ratio based on the total weight of the achiral polymerizable liquid crystal compound and the optically active compound.

A preferred ratio when the silane coupling agent is added to the polymerizable liquid crystal composition according to the invention is approximately 0.01 to approximately 0.15 in terms of a weight ratio based on the total weight of the achiral polymerizable liquid crystal compound and the optically active compound. A further preferred weight ratio is in the range of approximately 0.03 to approximately 0.10 based thereon.

A preferred ratio when any other polymerizable compound is added to the polymerizable liquid crystal composition according to the invention is approximately 0.01 to approximately 0.50 in terms of a weight ratio based on the total weight of the achiral polymerizable liquid crystal compound and the optically active compound, and a further preferred ratio is approximately 0.03 to approximately 0.30 based thereon.

Upon further simultaneously using the additive such as the sensitizer and the chain transfer agent to the polymerizable liquid crystal composition according to the invention, as usage, the additive only needs a minimum amount for attaining a purpose.

A preferred combination of the polymerizable liquid crystal compounds in the polymerizable liquid crystal composition according to the invention will be described.

The combination includes:

a combination of component (A) and component (B);
a combination of component (A), component (B) and component (D);
a combination of component (A), component (B) and component (E);
a combination of component (A), component (B) and component (F);
a combination of component (A), component (B) and component (G);
a combination of component (A), component (B) and component (H);
a combination of component (A), component (B), component (D) and component (E);
a combination of component (A), component (B), component (D) and component (F);
a combination of component (A), component (B), component (E) and component (F);
a combination of component (A), component (B), component (G) and component (H);
a combination of component (A), component (B), component (D), component (E) and component (F);
a combination of component (A), component (B), component (D) and component (G);
a combination of component (A), component (B), component (D) and component (H);
a combination of component (A), component (B), component (E) and component (G);
a combination of component (A), component (B), component (E) and component (H);
a combination of component (A), component (B), component (F) and component (G);
a combination of component (A), component (B), component (F) and component (H);
a combination of component (A), component (B), component (D), component (E) and component (G);
a combination of component (A), component (B), component (D), component (E) and component (H);
a combination of component (A), component (B), component (D), component (E), component (G) and component (H);
a combination of component (A), component (B), component (D), component (F) and component (G);
a combination of component (A), component (B), component (D), component (F) and component (H);
a combination of component (A), component (B), component (D), component (F), component (G) and component (H);
a combination of component (A), component (B), component (E), component (F) and component (G);
a combination of component (A), component (B), component (E), component (F) and component (H);
a combination of component (A), component (B), component (E), component (F), component (G) and component (H);
a combination of component (A), component (B), component (D), component (E), component (F) and component (G);
a combination of component (A), component (B), component (D), component (E), component (F) and component (H); and
a combination of component (A), component (B), component (D), component (E), component (F), component (G) and component (H).

In order to incorporate a large amount of three-dimensional structure into the infrared reflecting film to increase mechanical strength, a combination containing neither component (F) nor component (H) (namely, a combination by the polyfunctional polymerizable liquid crystal compound) is preferred. When flowability is secured by heating or the like in the curing process in order to extend the reflection band, a combination containing component (F) and component (H) is preferred. In order to reduce the cure shrinkage (improvement of adhesion performance), the content of the monofunctional component or the cationic polymerization component is to be increased, and therefore a combination containing component (F), component (G) and component (H) is preferred. In order to nonuniformarize the rate of polymerization to extend the reflection zone, a combination containing component (G) and component (H) is preferred.

When alignment uniformity or application uniformity is adjusted, the surfactant may be combined with the composition. When the adhesion properties with the support substrate are improved, the silane coupling agent or the chain transfer agent may be further combined therewith. In order to control polymerization efficiency, the sensitizer may be further combined therewith. Moreover, any other polymerizable compound may be further combined in each combination.

Next, methods for synthesizing the compounds will be described. The compounds used in the invention can be synthesized by combining synthesis methods in organic chemistry described in Houben Weyl, Methoden der Organischen Chemie (Georg Thieme Verlag, Stuttgart), Organic Reactions (John Wily & Sons Inc.), Organic Syntheses (John Wily & Sons, Inc.), Comprehensive Organic Synthesis (Pergamon Press), New Experimental Chemistry Course (Shin Jikken Kagaku Koza in Japanese) (Maruzen Co., Ltd.) or the like.

A method for synthesizing the compound represented by formula (1-1) is described in JP 2003-238491 A or JP 2006-307150 A. A method for synthesizing the compound represented by formula (1) in which the polymerizable group is cationically polymerizable is described in JP 2005-60373 A.

A method for synthesizing the compound having the polymerizable group as represented by formula (2-2) is described in U.S. Pat. No. 5,886,242 B, GB 2298202 A and JP 2005-263778 A.

As for a method for synthesizing the compound represented by formula (3-1), a method described in U.S. Pat. No. 5,770,107 B can be used as a reference.

As for a method for synthesizing the compound represented by formula (3-2), a method described in JP 2006-307150 A can be used as a reference.

A method for synthesizing the compound represented by formula (4) is described in Makromol. Chem., 190, 3201-3215 (1989), Makromol. Chem., 190, 2255-2268 (1989), WO 97/00600 A, U.S. Pat. No. 5,770,107 B and JP 2004-231638 A or the like.

As a method for synthesizing the compound represented by formula (5), the compound can be synthesized by a method described in Macromolecules, 26, 6132-6134 (1993), Makromol. Chem., 183, 2311-2321 (1982), DE 19504224 A, WO 1997/00600 A, U.S. Pat. No. 4,952,334 B, U.S. Pat. No. 4,842,754 B, JP 2003-238491 A or the like.

As a method for synthesizing the compound represented by formula (6), the compound can be synthesized by a method described in Macromolecules, 26, 1244-1247 (1993), Liquid Crystals, 31, 12, 1627-1634 (2004), Makromol. Chem., 202, 180-187 (2001), JP 2006-241116 A, JP 2006-225607 A, JP 2011-144159 A, JP 2011-246365 A, JP 2012-1526 A or the like.

As a method for synthesizing the compound represented by formula (7), the compound can be synthesized by a method described in Makromol. Chem., 196, 2941-2945 (1995), Polymer Bulletin 29, 49-56 (1992), JP 2006-117564 A, JP 2006-45195 A, JP 2006-241116 A, JP 2011-144159 A, JP 2011-246365 A, JP 2012-1526 A or the like.

Next, examples of component compounds are shown. Preferred examples of the compounds represented by formula (1-1) are shown below.

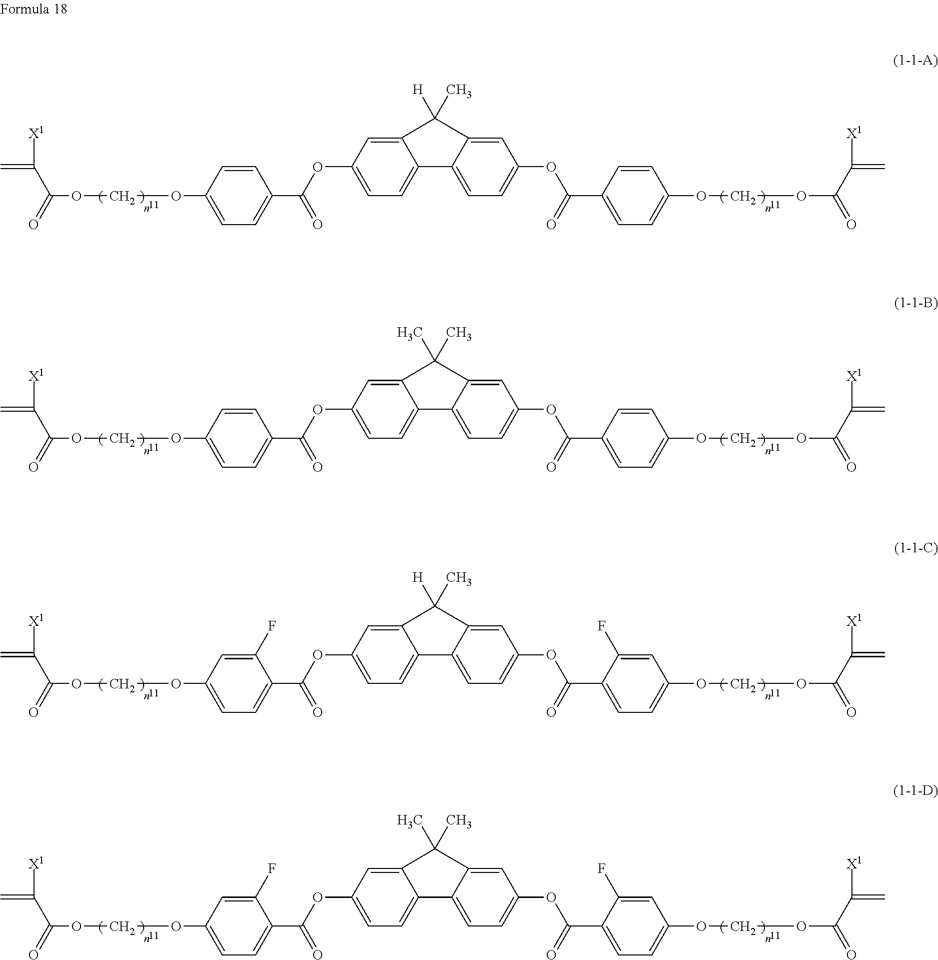

wherein, in formulas (1-1-A) to (1-1-D), X¹ and n¹¹ are defined in a manner similar with the definitions described above.

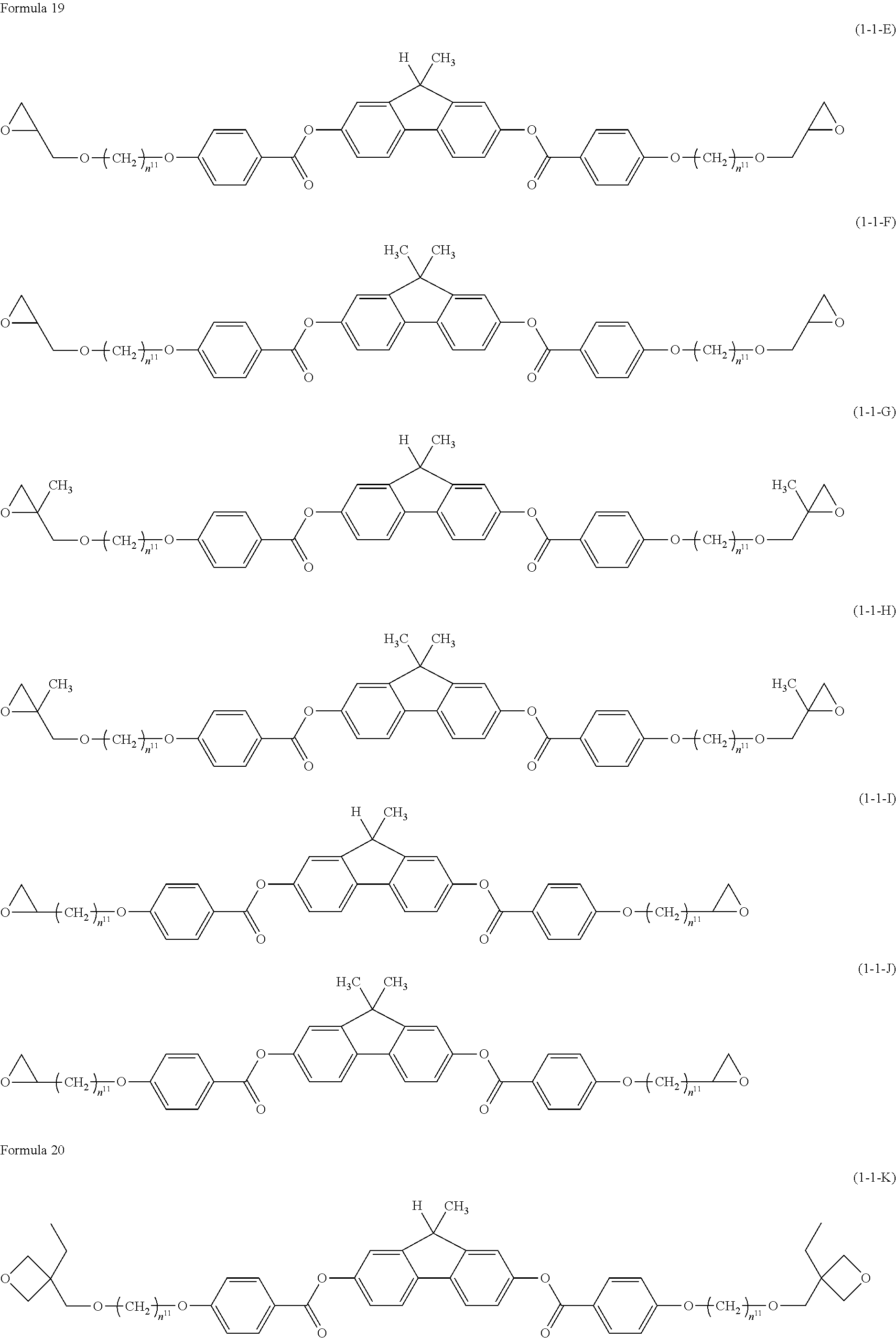

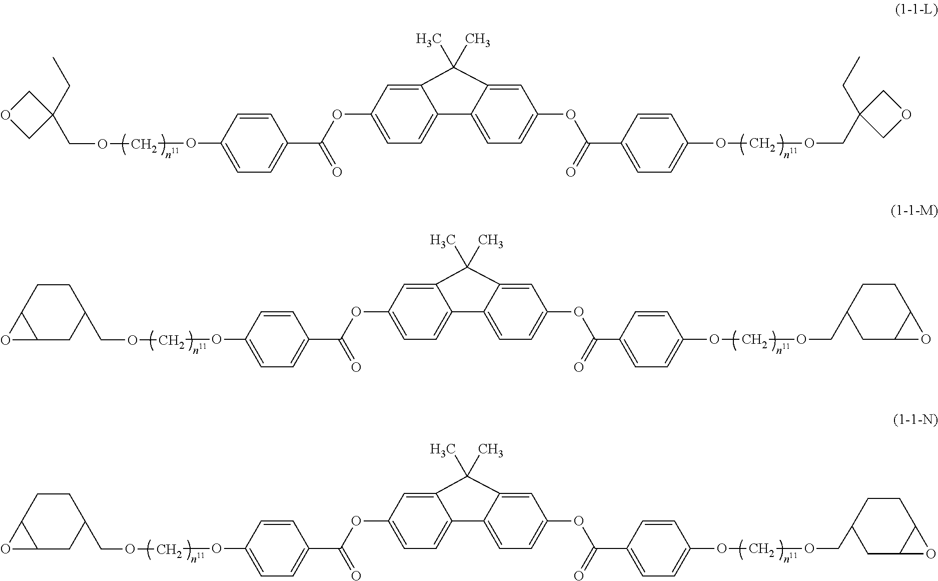

wherein, in formulas (1-1-E) to (1-1-N), n¹¹ is defined in a manner similar with the definitions described above.

Preferred examples of the compounds represented by formula (2-2) are shown below.

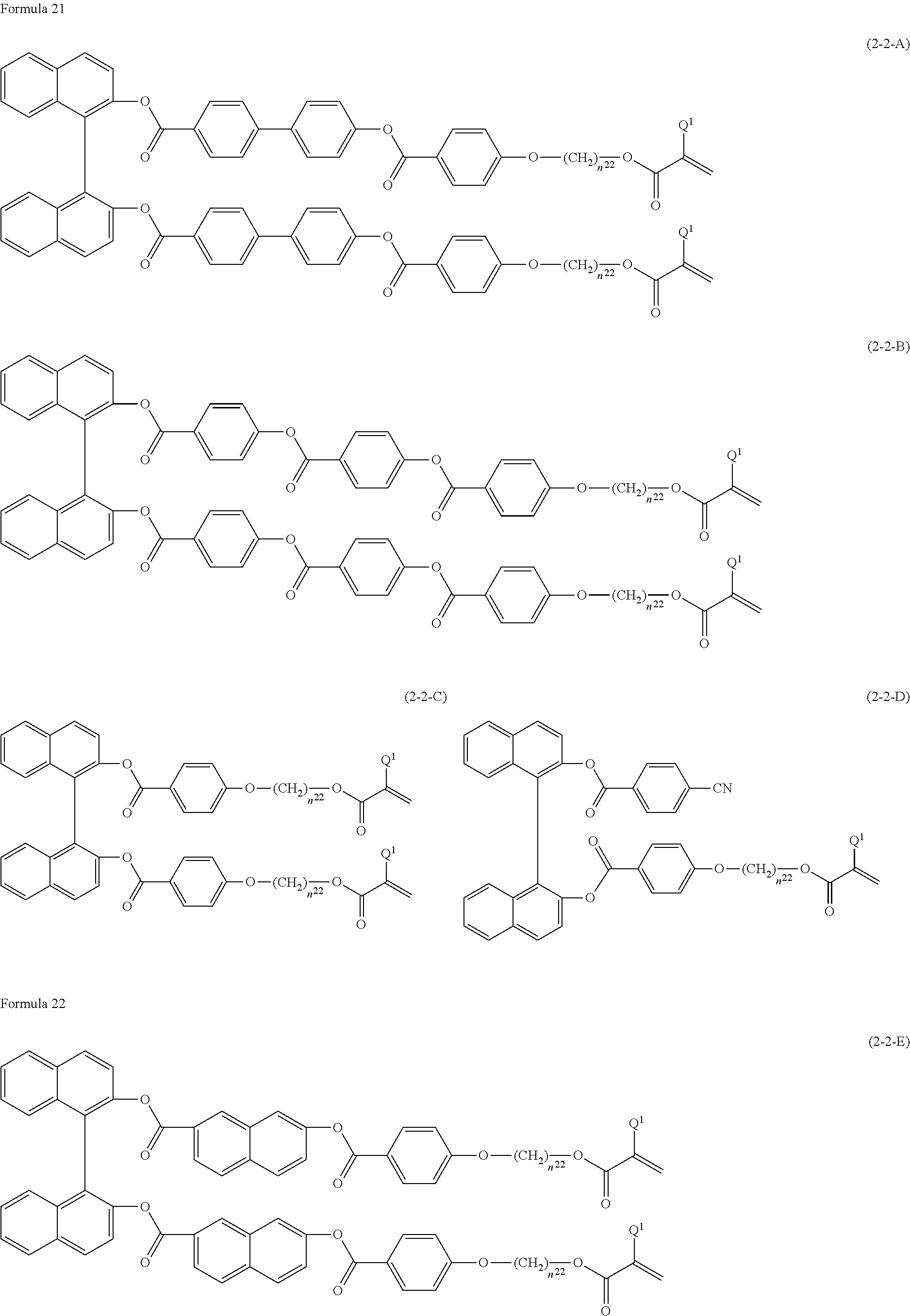

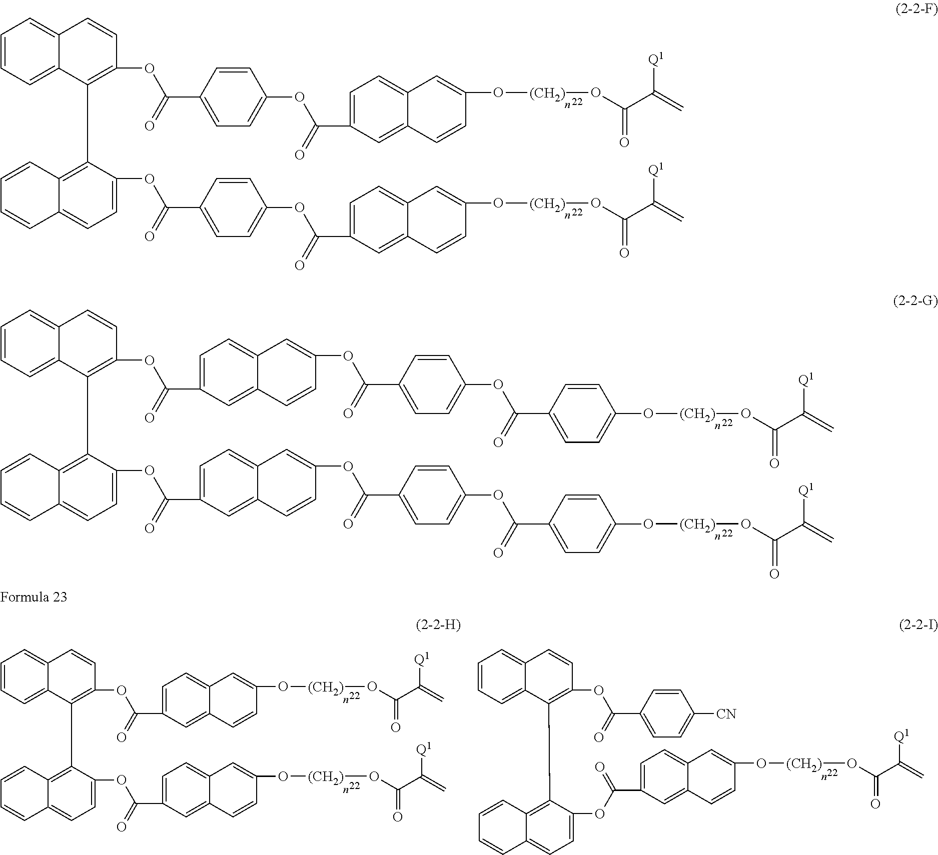

wherein, Q¹ is independently hydrogen, methyl or trifluoromethyl, and n²² is independently an integer from 2 to 12.

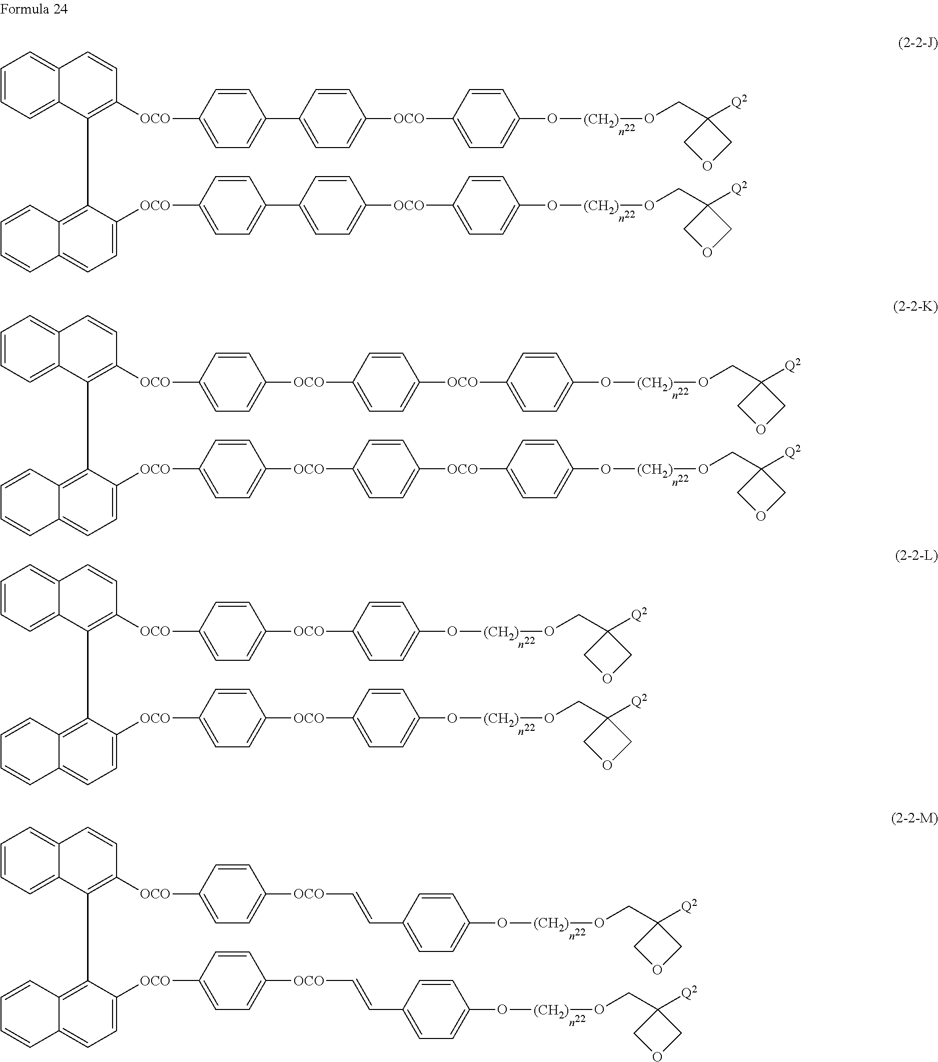

wherein, Q² is independently methyl or ethyl, and n²² is independently an integer from 2 to 12. In formula (2-2-M), —CH═CH— preferably takes a trans form.

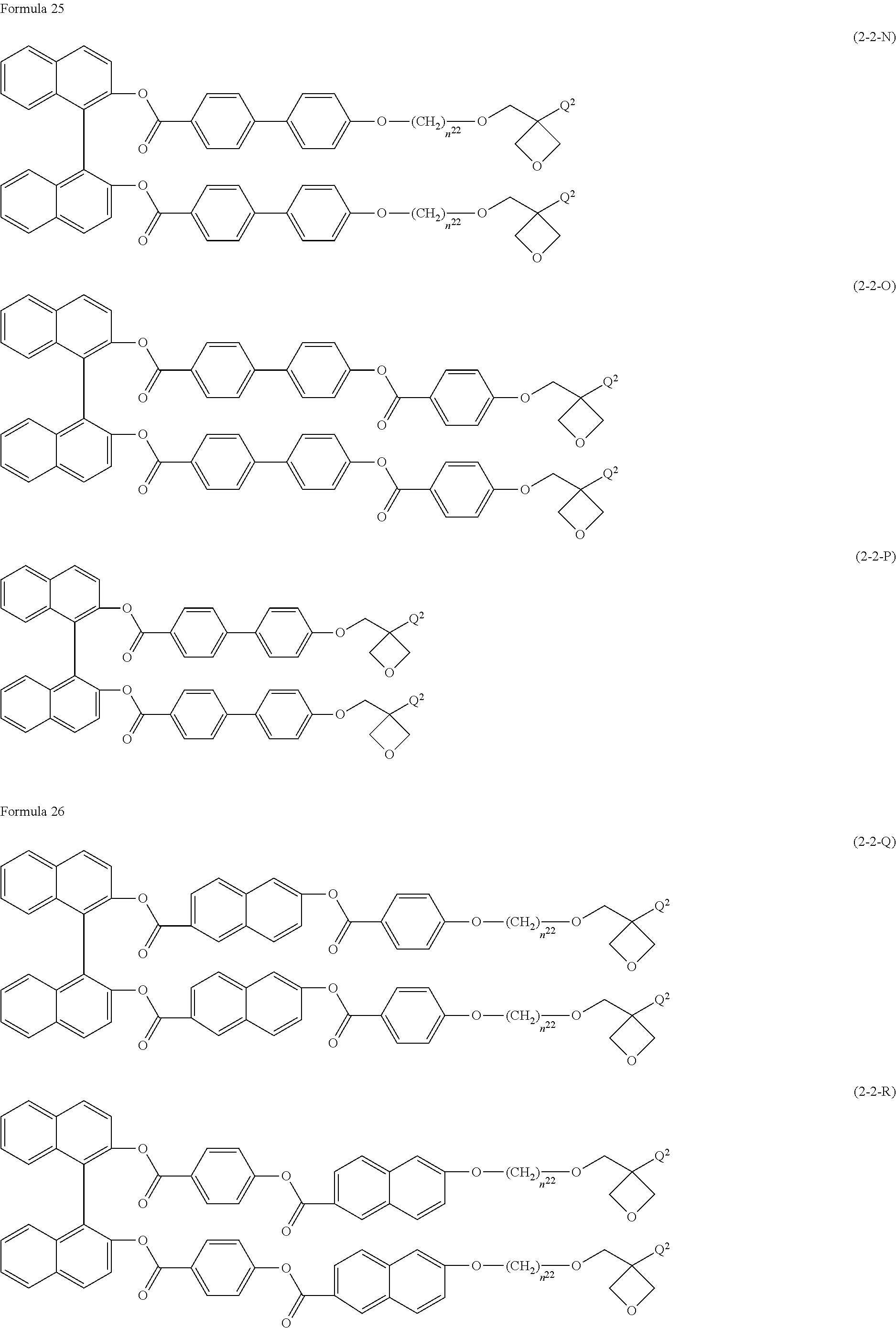

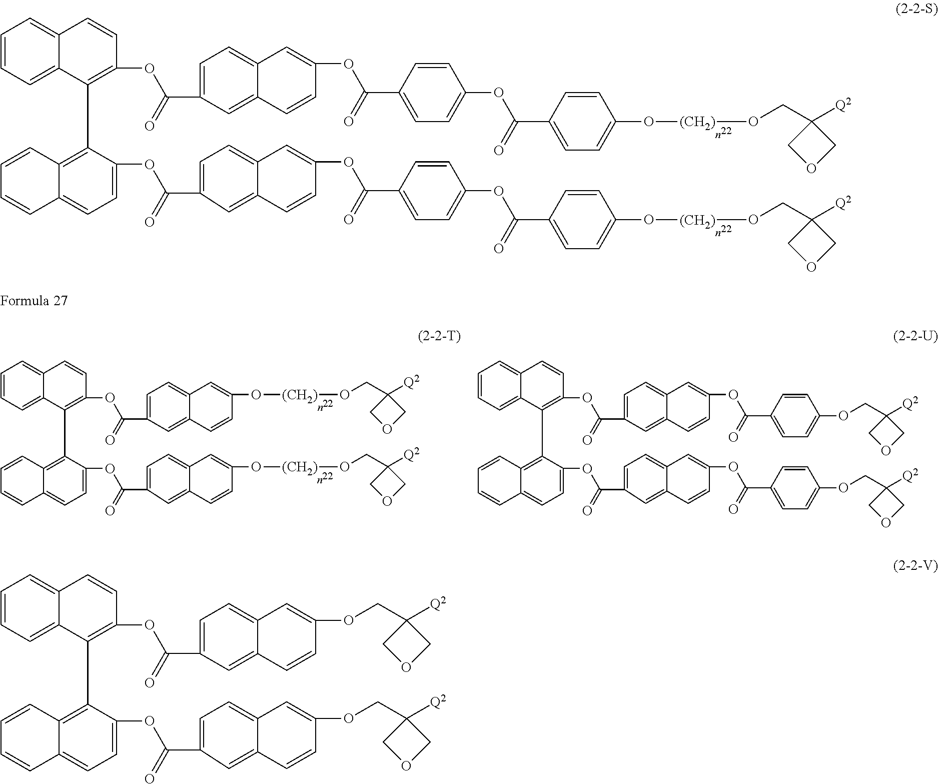

wherein, Q² is independently methyl or ethyl, and n²² is independently an integer from 2 to 12.

Preferred examples of the compounds represented by formulas (3-1) to (3-2) are shown below.

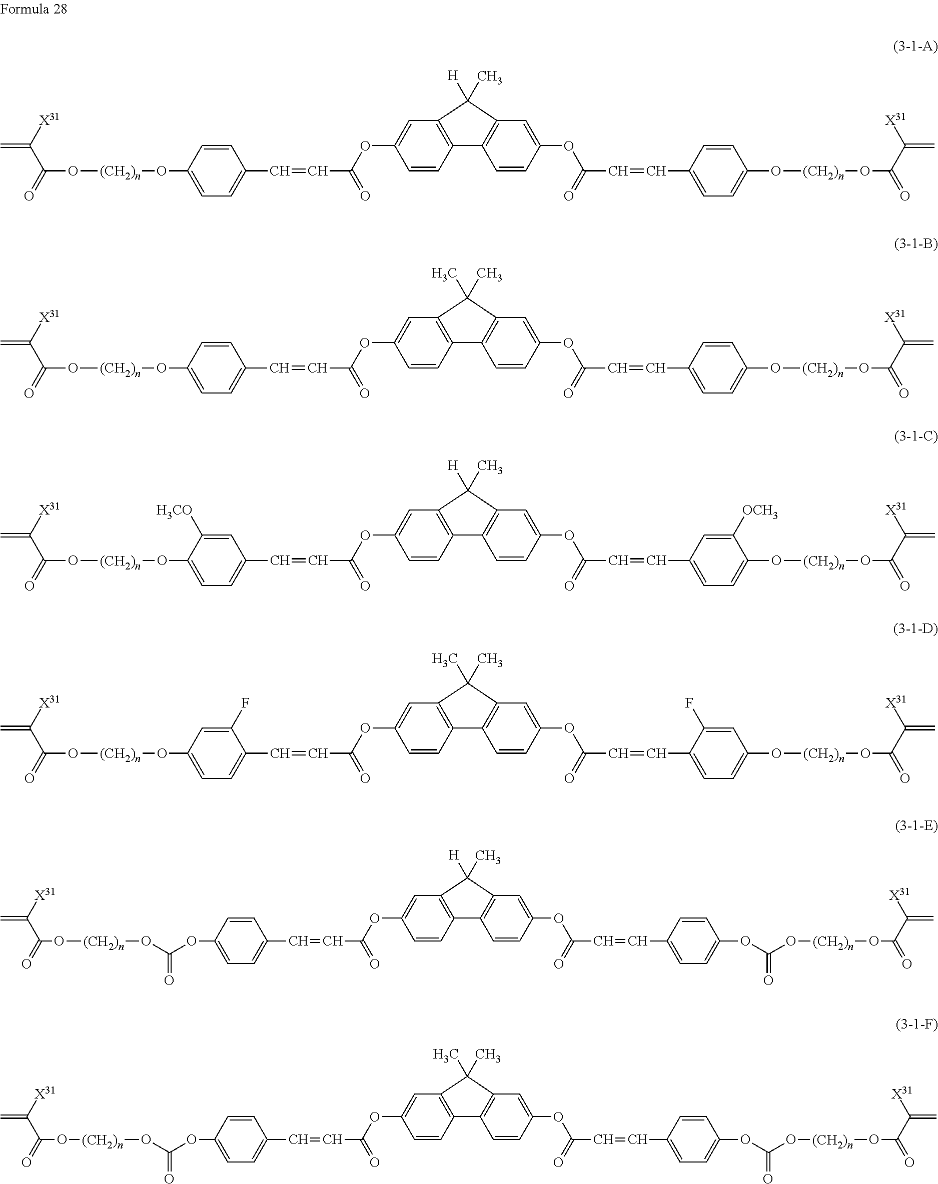

wherein, in formulas (3-1-A) to (3-1-F), X³¹ is independently hydrogen, methyl or trifluoromethyl, and n is independently an integer from 2 to 20. In formulas (3-1-A) to (3-1-F), a trans isomer is preferred, and both of —CH═CH— further preferably take a trans form.

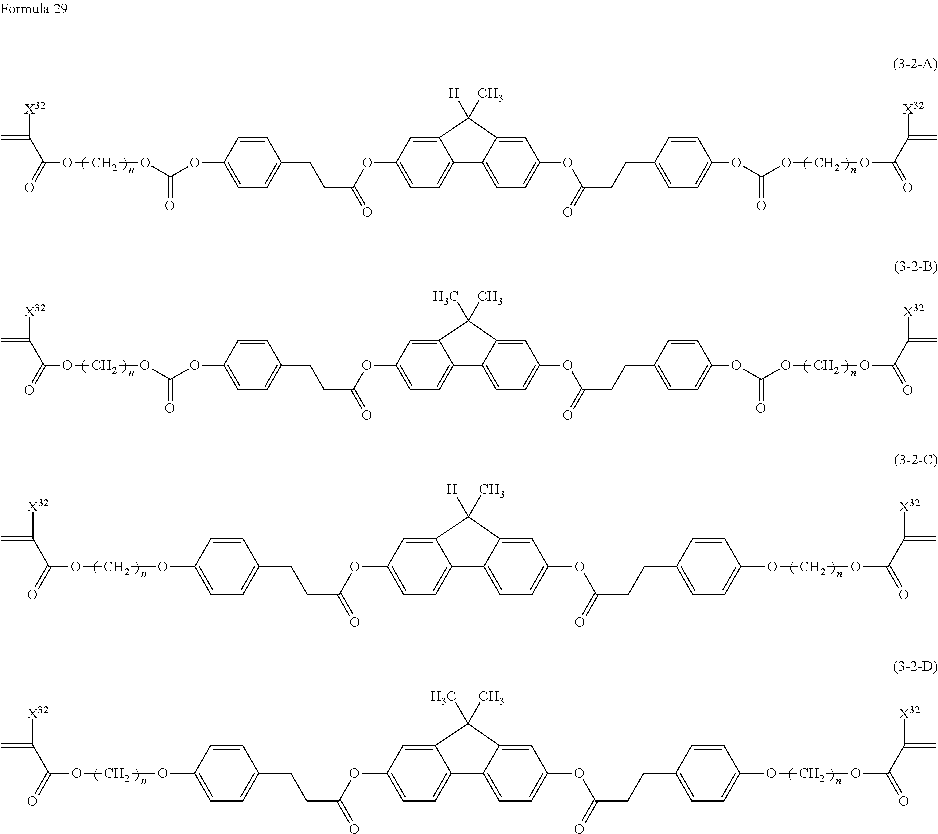

wherein, in formulas (3-2-A) to (3-2-D), X³² is independently hydrogen, methyl or trifluoromethyl, and n is independently an integer from 2 to 20.

Preferred examples of the compounds represented by formula (4) are shown below.

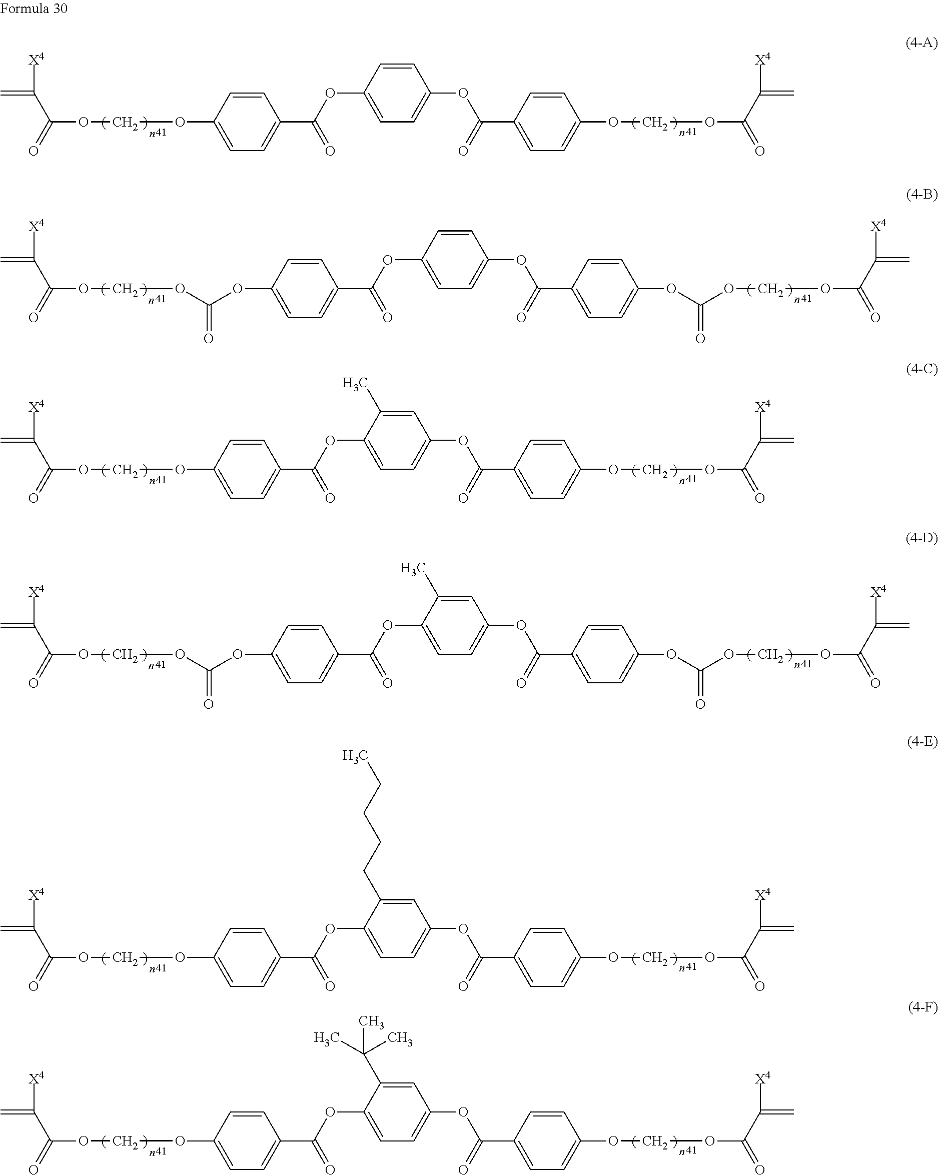

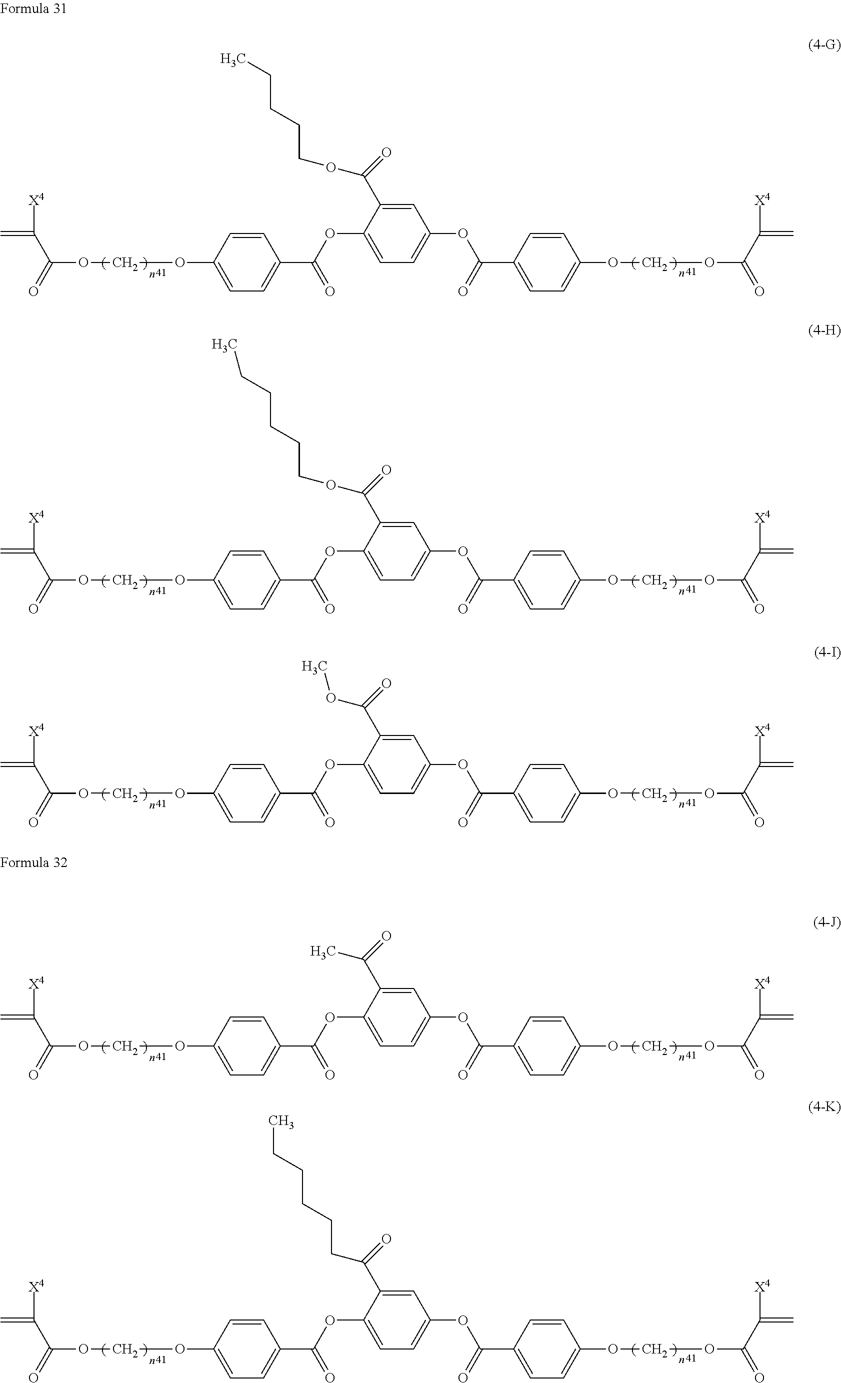

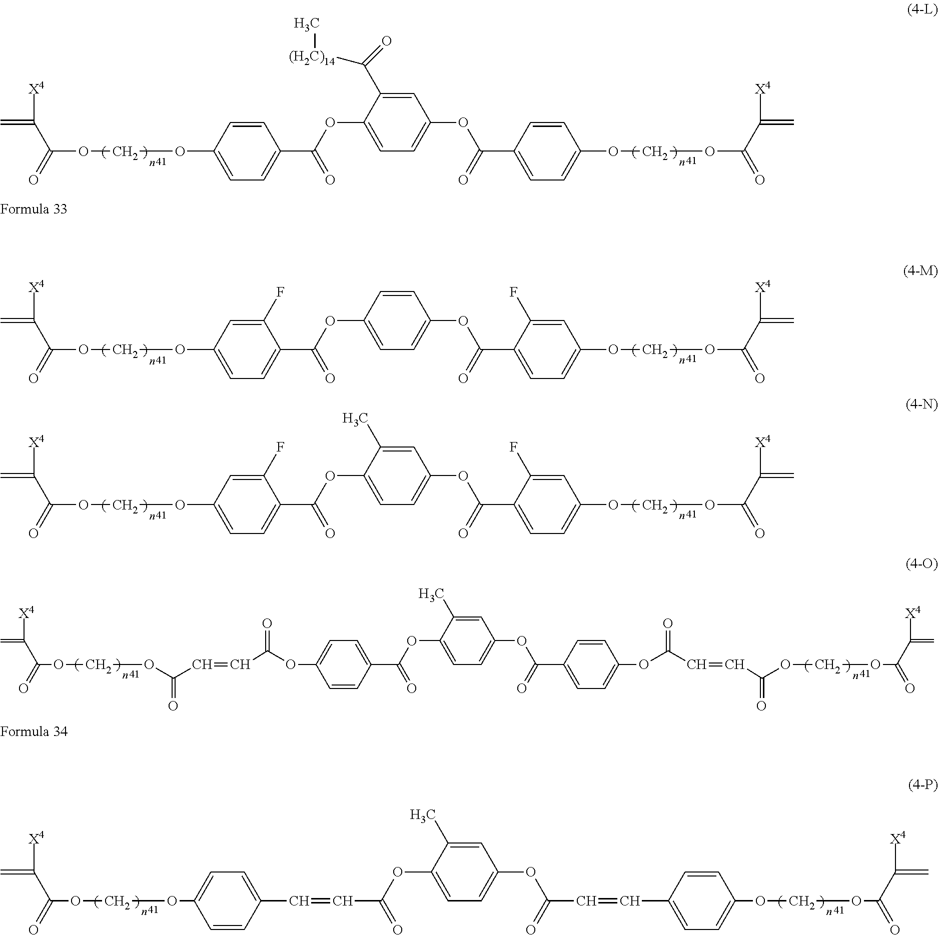

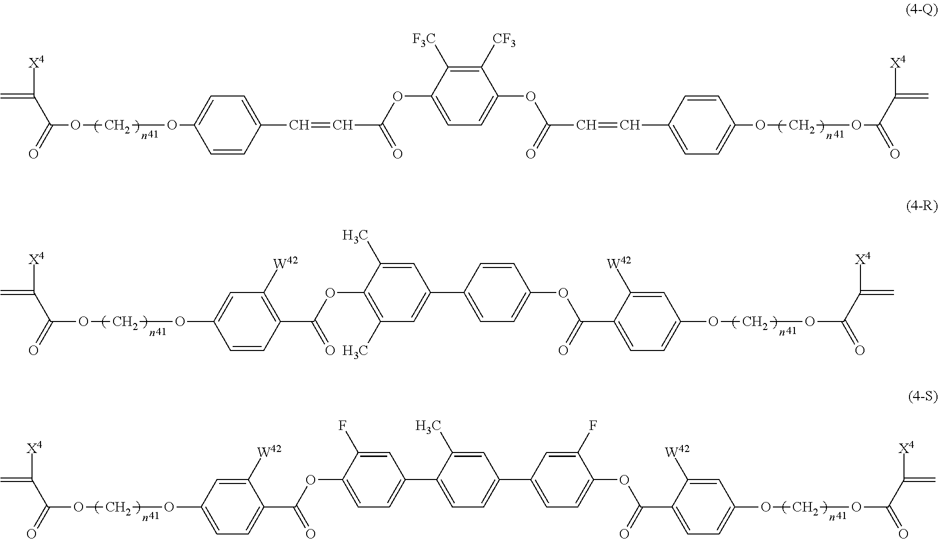

wherein, in formulas (4-A) to (4-S), X⁴ is independently hydrogen, methyl, fluorine or trifluoromethyl, W⁴² is hydrogen or fluorine, and n⁴¹ is independently an integer from 2 to 10. In formulas (4-P) to (4-Q), a trans isomer is preferred, and both of —CH═CH— further preferably take a trans form.

Preferred examples of the compounds represented by formula (5-1) are shown below.

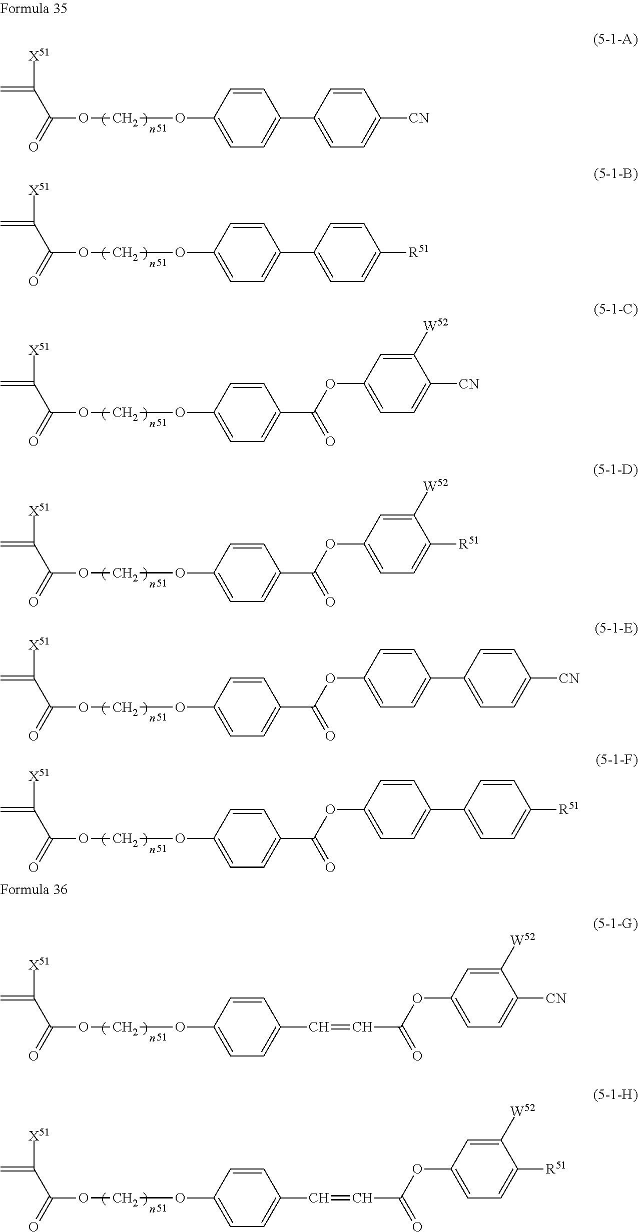

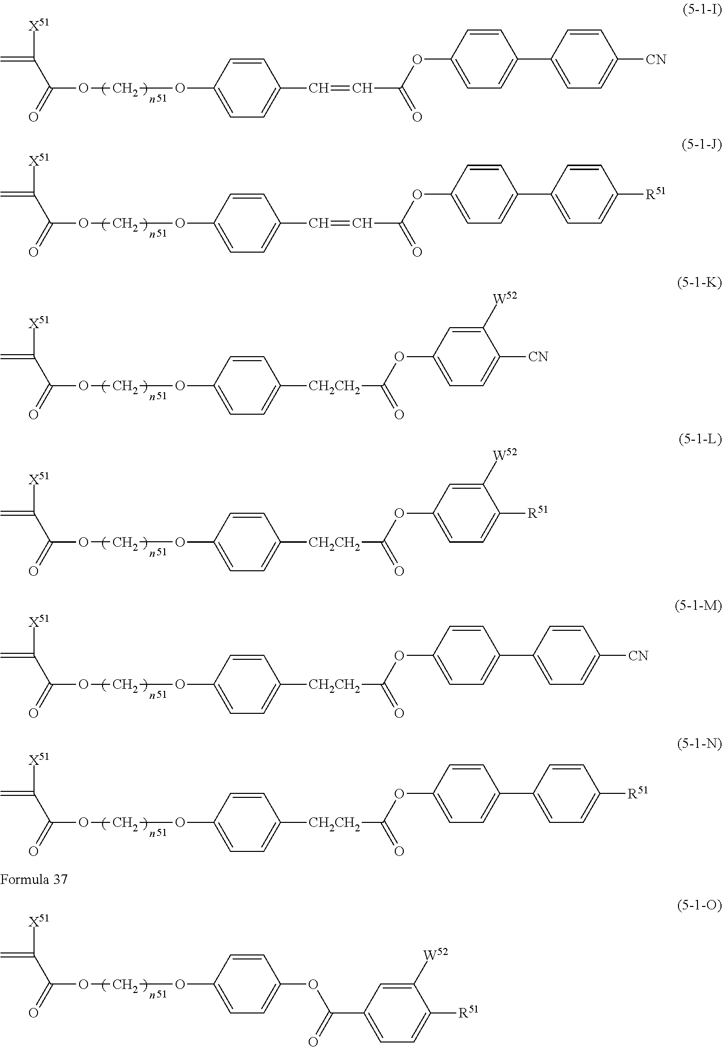

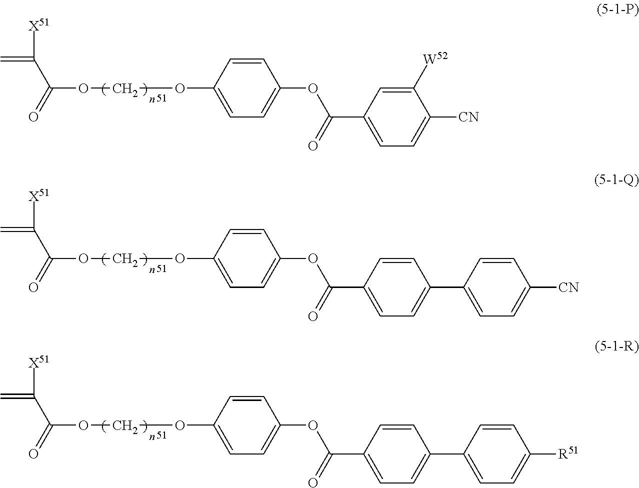

In formulas (5-1-A) to (5-1-R), X⁵¹, W⁵² and R⁵² are defined in a manner identical with the definitions described above.

X⁵¹ is, preferably, hydrogen or methyl,

W⁵² is hydrogen or fluorine,

R⁵¹ is alkyl having 1 to 20 carbons, alkoxy having 1 to 20 carbons, trifluoromethoxy, or alkyl ester having 1 to 10 carbons (—COOR^{c}, —OCOR^{c} or —CH═CH—COOR^{c}; R^{c} is straight-chain alkyl having 1 to 20 carbons), and n⁵¹ is an integer from 2 to 12.

In formulas (5-1-G) to (5-1-J), a trans isomer is preferred.

Preferred examples of the compounds represented by formula (5-2) are shown below.

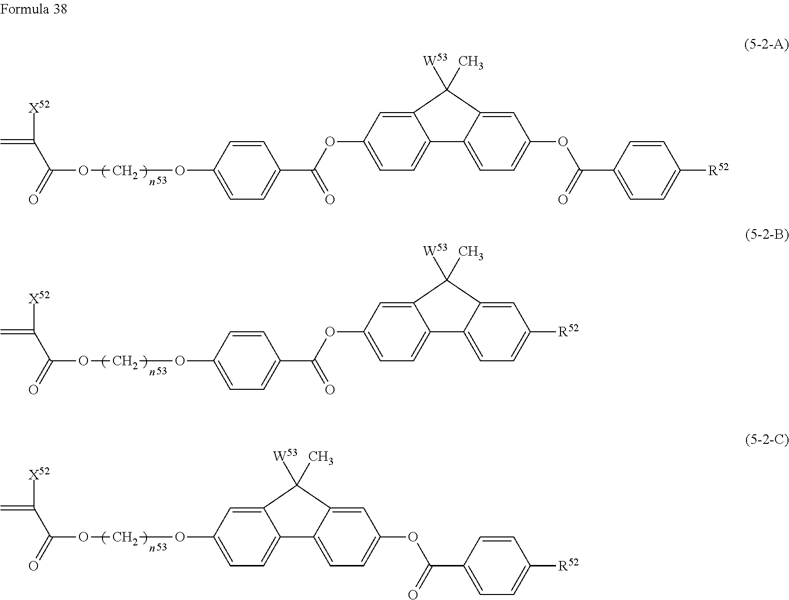

In formulas (5-2-A) to (5-2-C), X⁵², W⁵³ and R⁵² are defined in a manner identical with the definitions described above.

X⁵² is, preferably, hydrogen or methyl,

W⁵³ is hydrogen or fluorine,

R⁵² is alkyl having 1 to 20 carbons, alkoxy having 1 to 20 carbons, trifluoromethoxy, or alkyl ester having 1 to 10 carbons (—COOR^{c}, —OCOR^{c} or —CH═CH—COOR^{c}; R^{c} is straight-chain alkyl having 1 to 20 carbons), and n⁵³ is an integer from 2 to 12.

Preferred examples of the compounds represented by formula (6-1) are shown below.

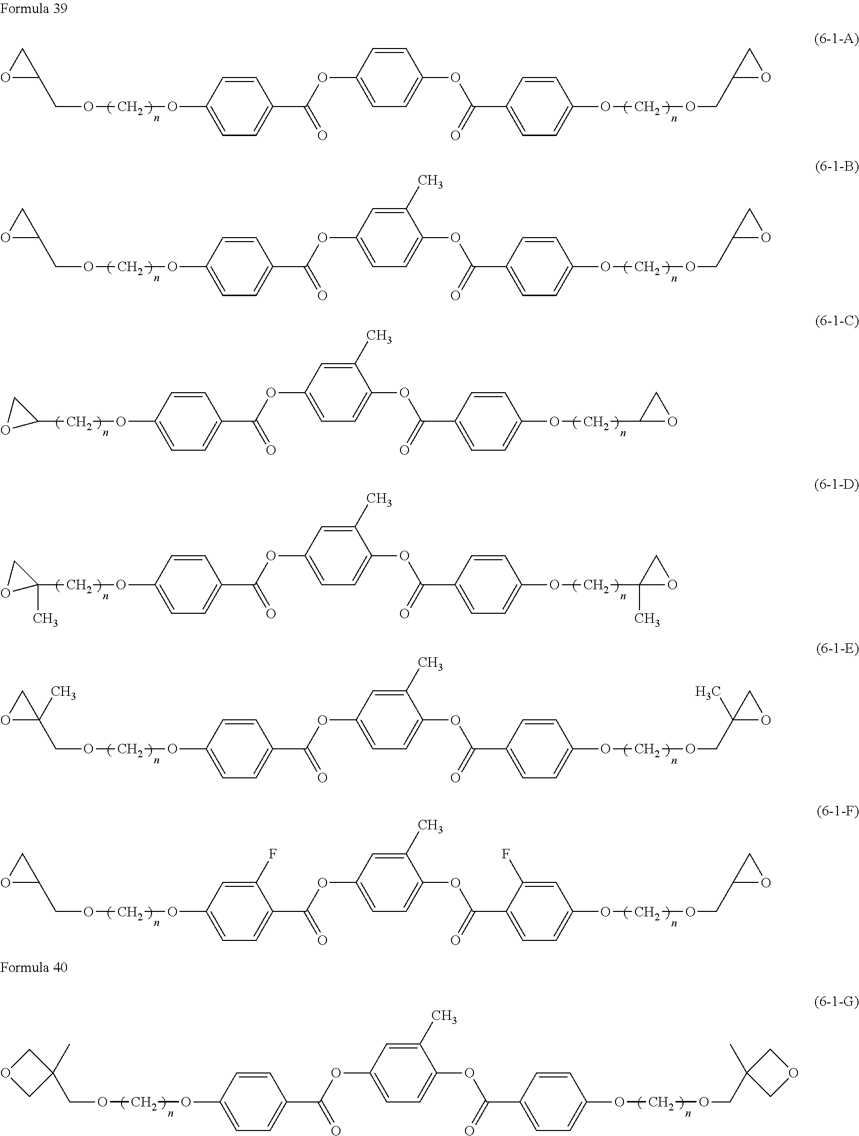

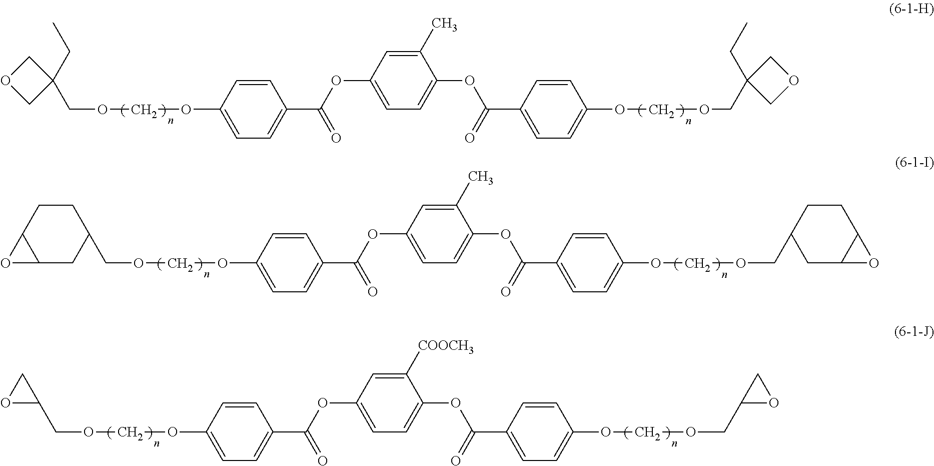

wherein, in formulas (6-1-A) to (6-1-J), n is an integer from 2 to 12.

Preferred examples of the compounds represented by formula (6-2) are shown below.

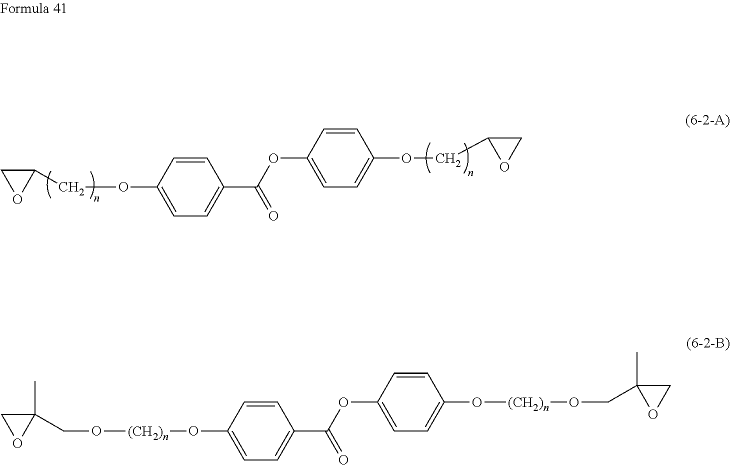

wherein, in formula (6-2-A), n is an integer from 1 to 12, and in formula (6-2-B), n is an integer from 2 to 12.

Preferred examples of the compounds represented by formula (7-1) are shown below.

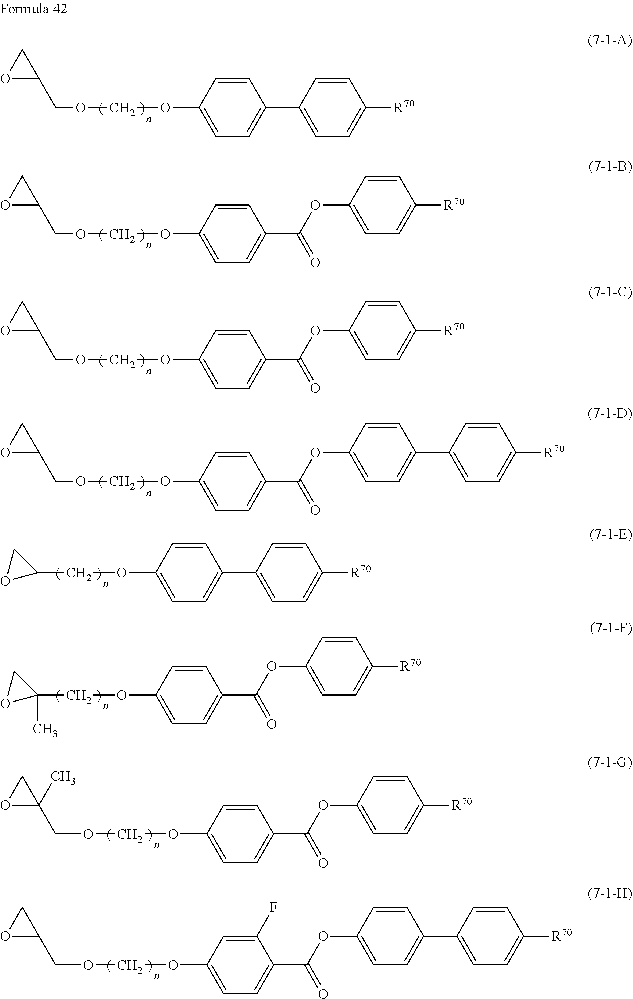

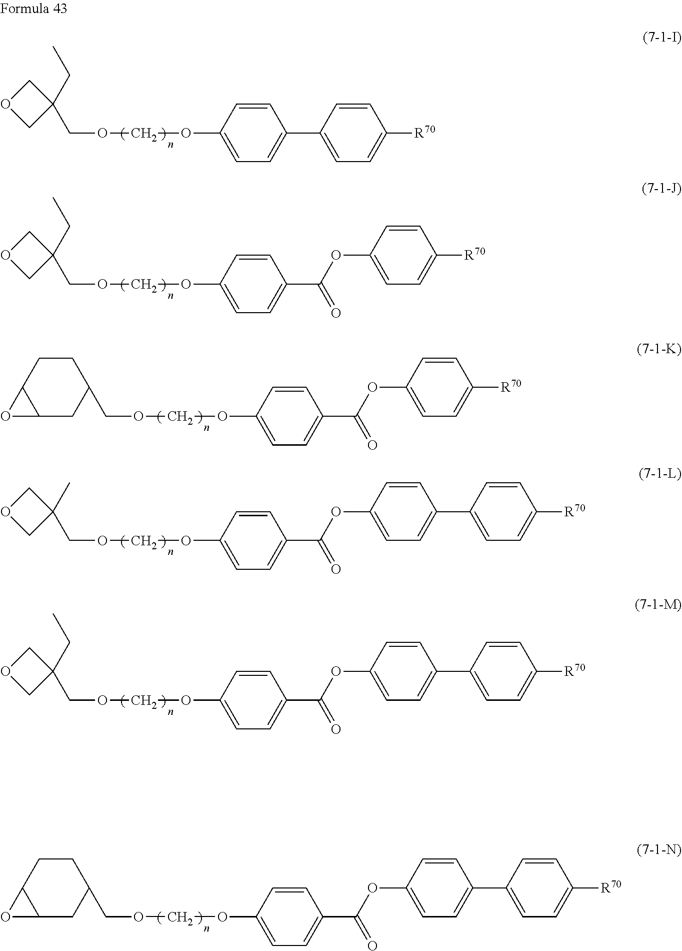

wherein, in formulas (7-1-A) to (7-1-N),

R⁷⁰ is cyano, trifluoromethoxy, alkyl having 1 to 10 carbons, alkyl ester of 1 to 10 carbons or alkoxy having 1 to 10 carbons, and in the alkyl and the alkoxy, at least one of hydrogen may be replaced by fluorine.

Then, n is an integer from 2 to 12.

Preferred examples of the compounds represented by formula (7-2) are shown below.

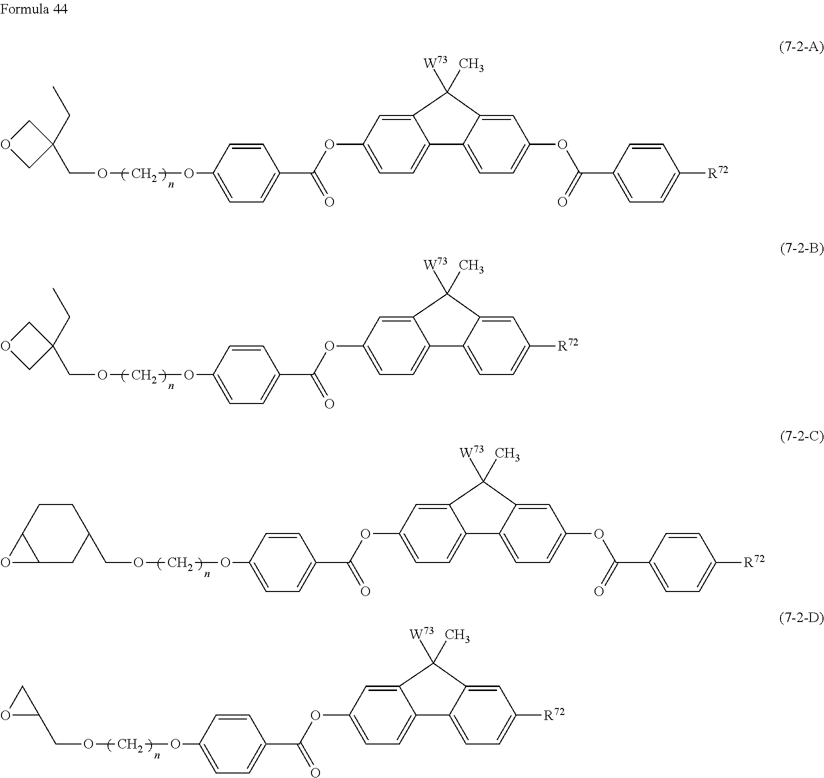

In formulas (7-2-A) to (7-2-D), W⁷³ is independently hydrogen or methyl,

R⁷² is alkyl having 1 to 20 carbons, alkoxy having 1 to 20 carbons, trifluoromethoxy, or alkyl ester having 1 to 20 carbons (—COOR^{c}, —OCOR^{c} or —CH═CH—COOR^{c}; R^{c} is straight-chain alkyl having 1 to 20 carbons).

Then, n is an integer from 2 to 12.

Specific examples of compounds represented by formulas (1) to (7) are shown below.

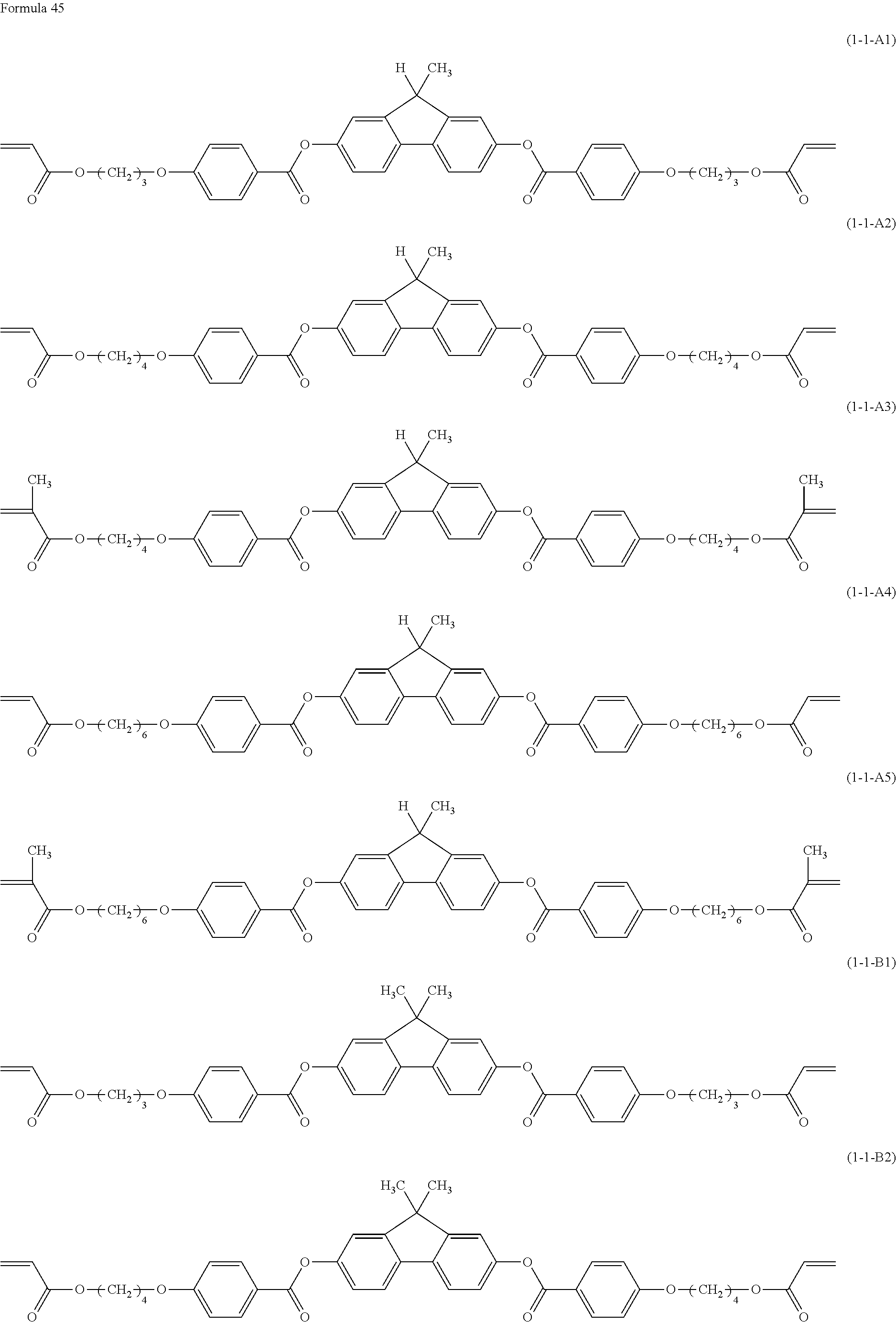

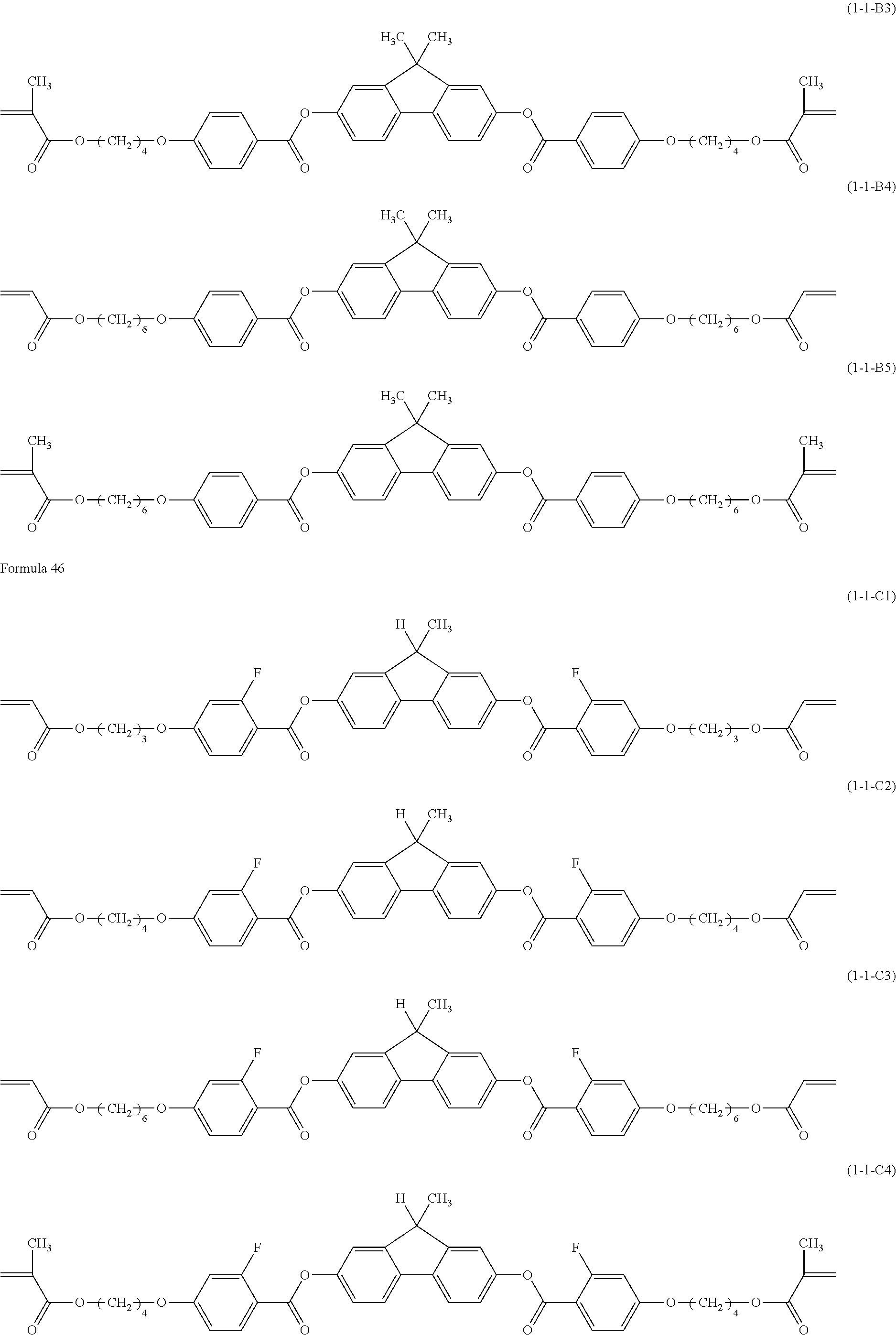

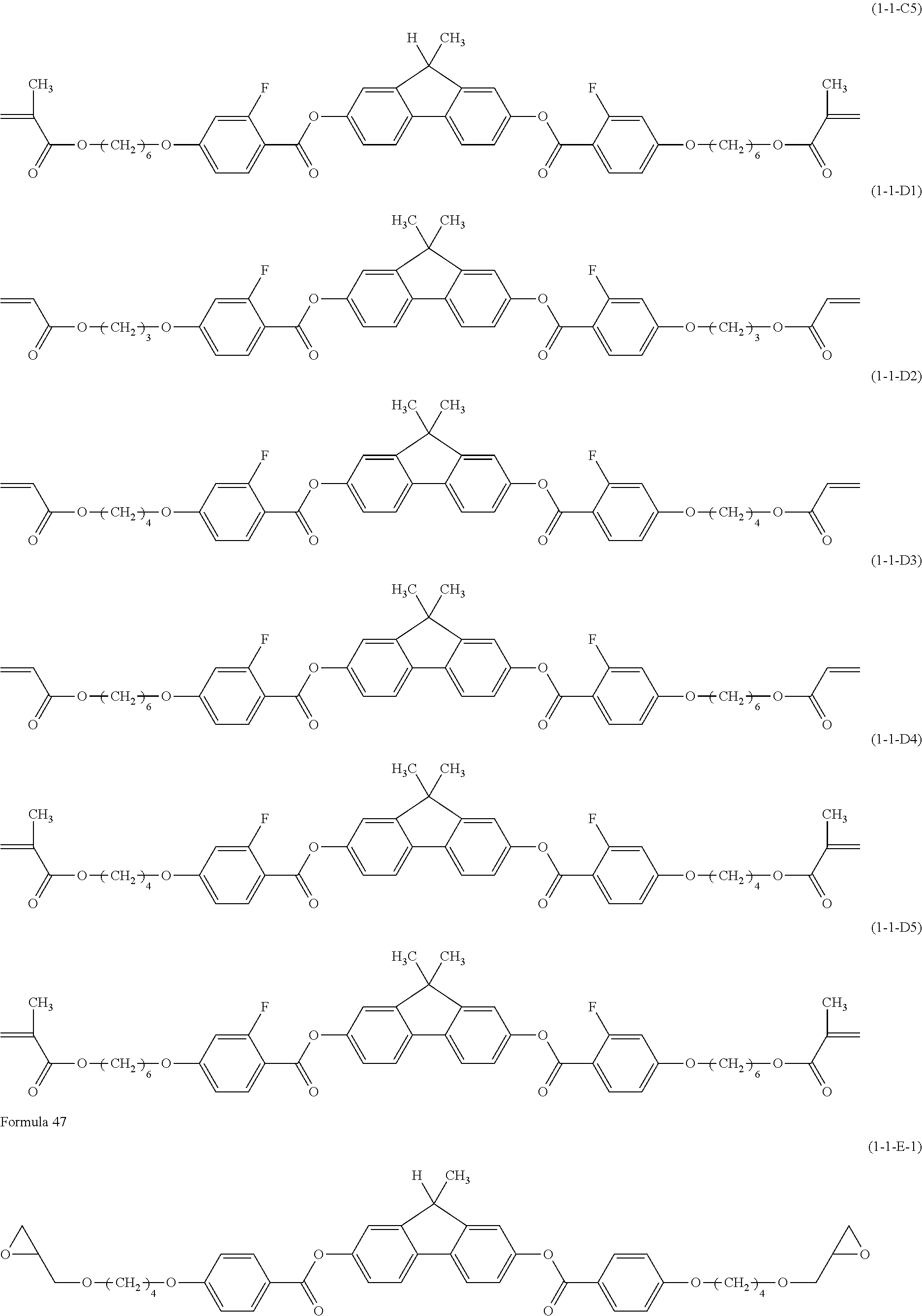

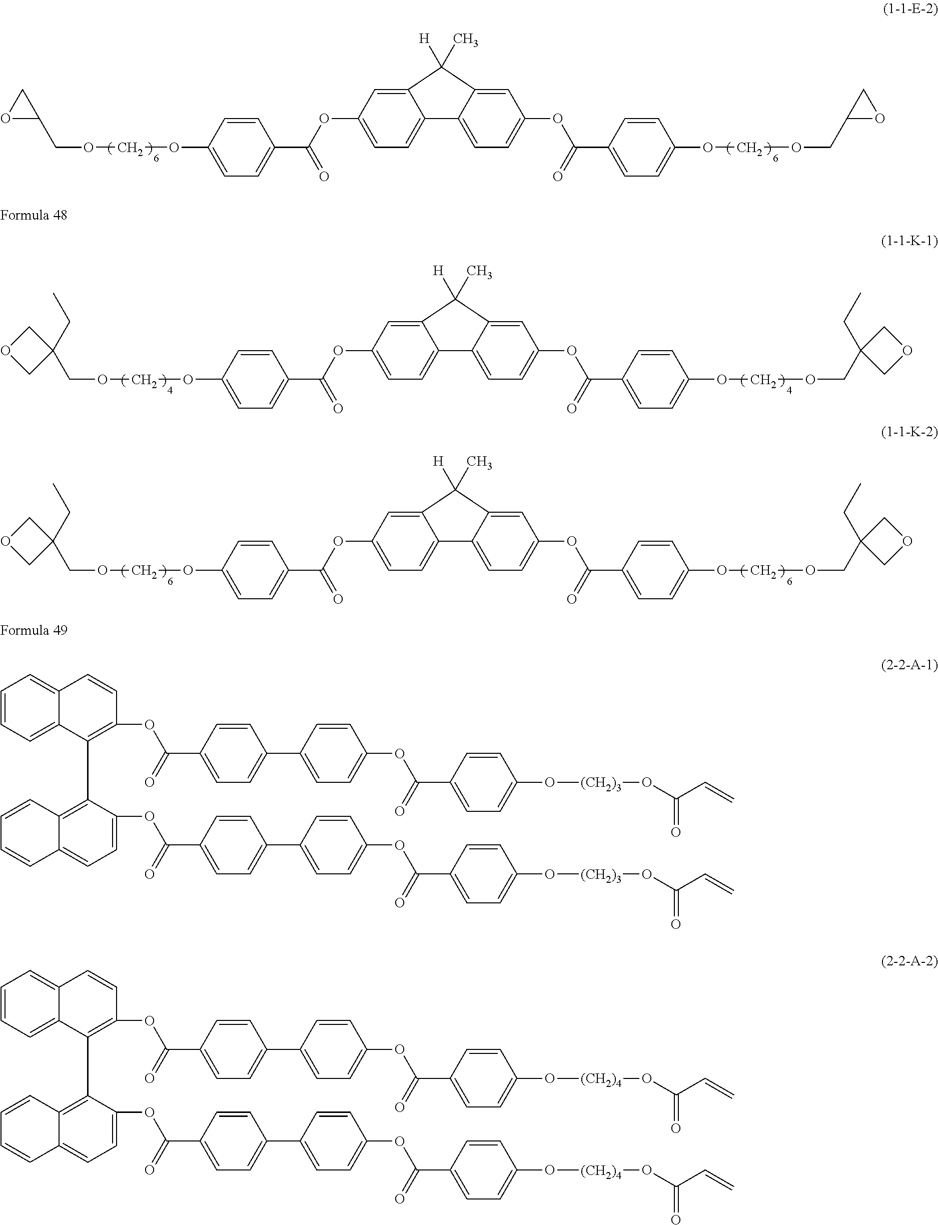

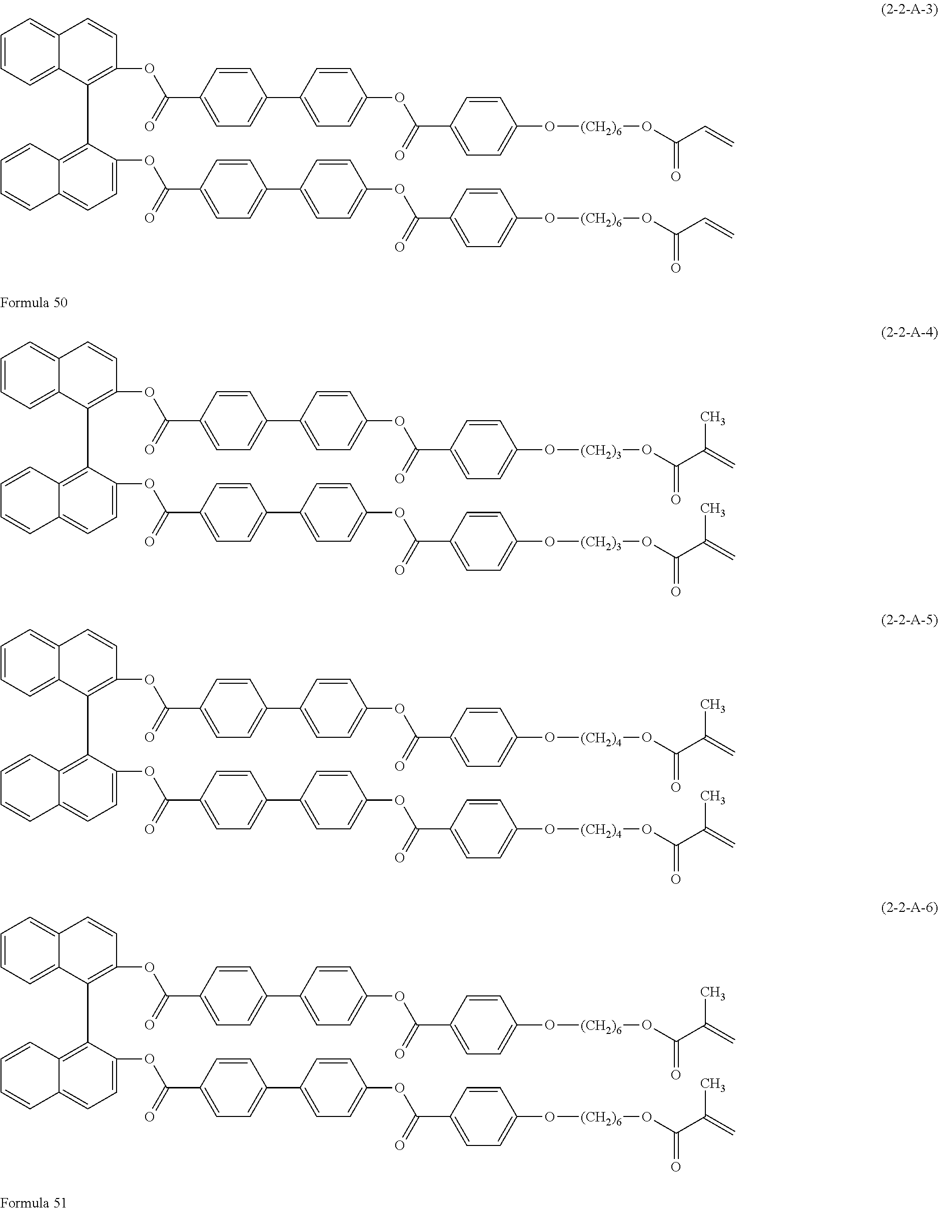

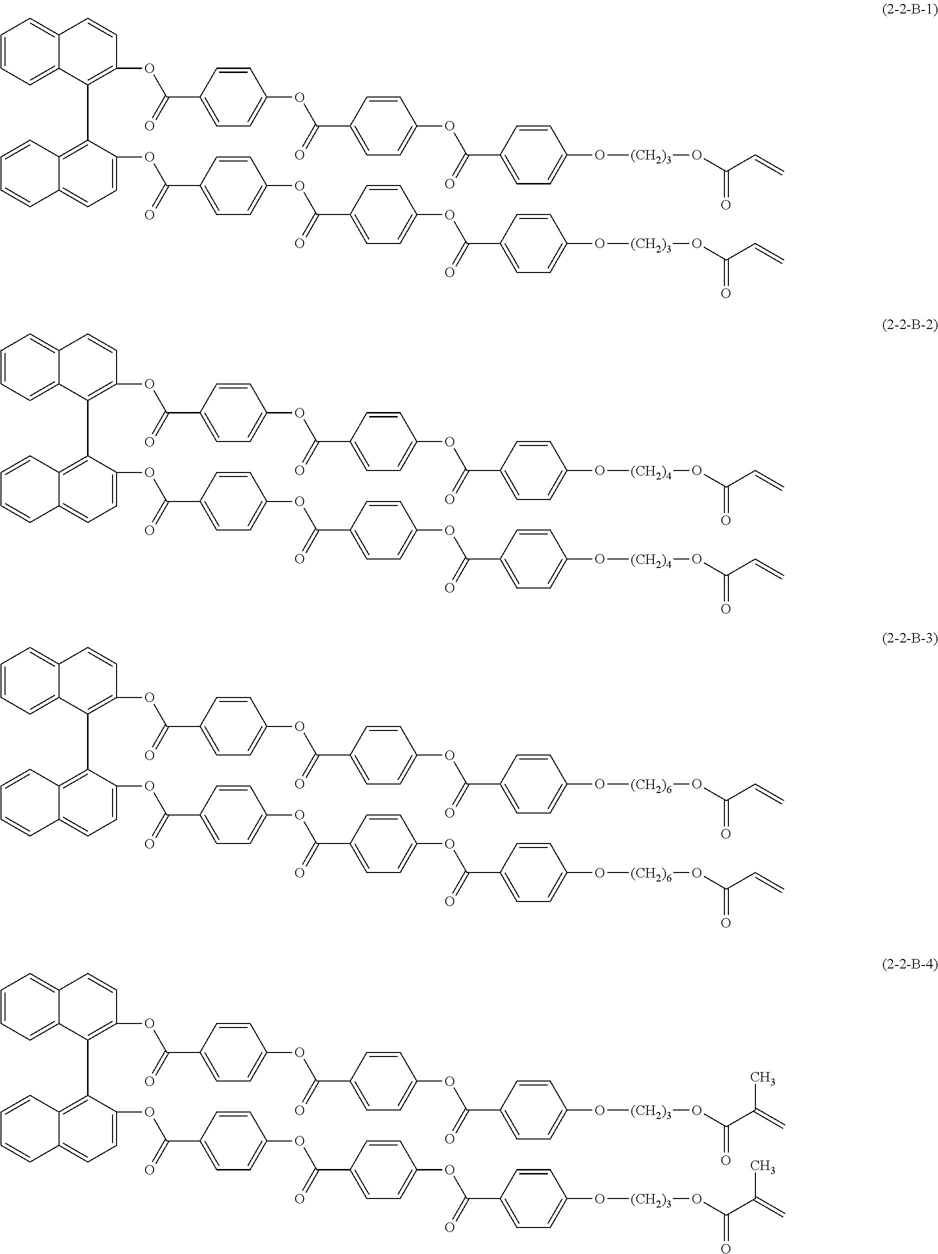

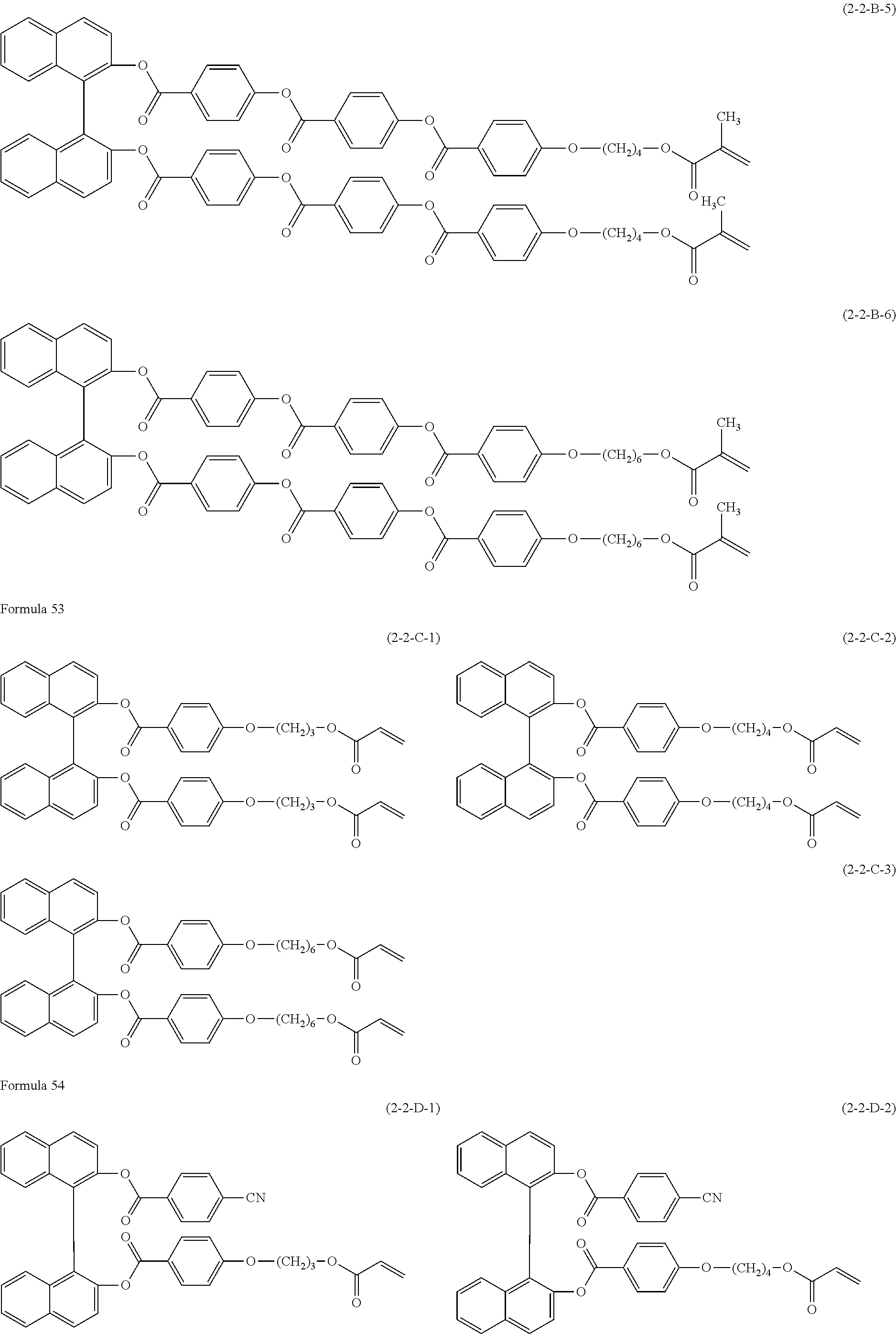

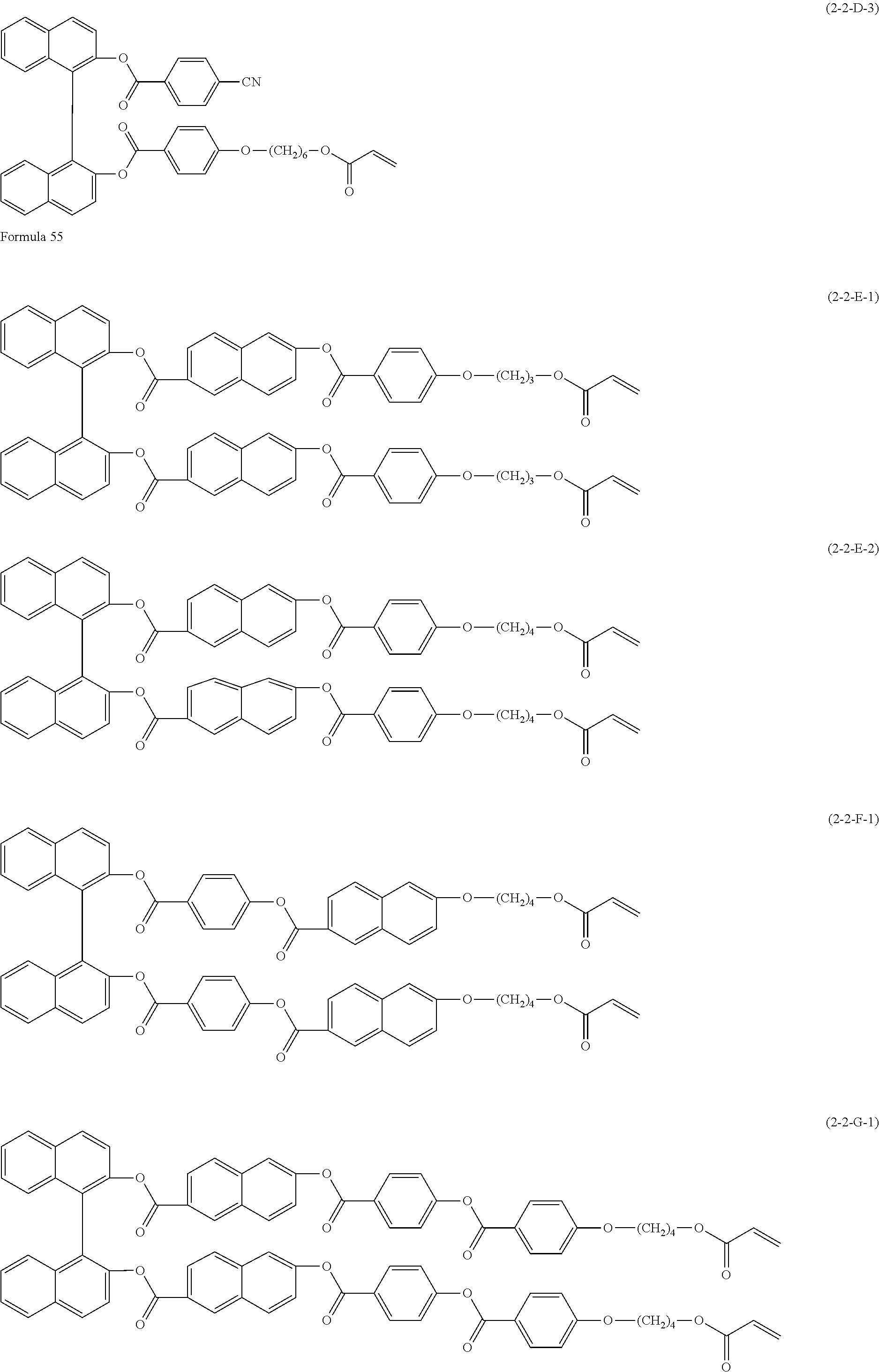

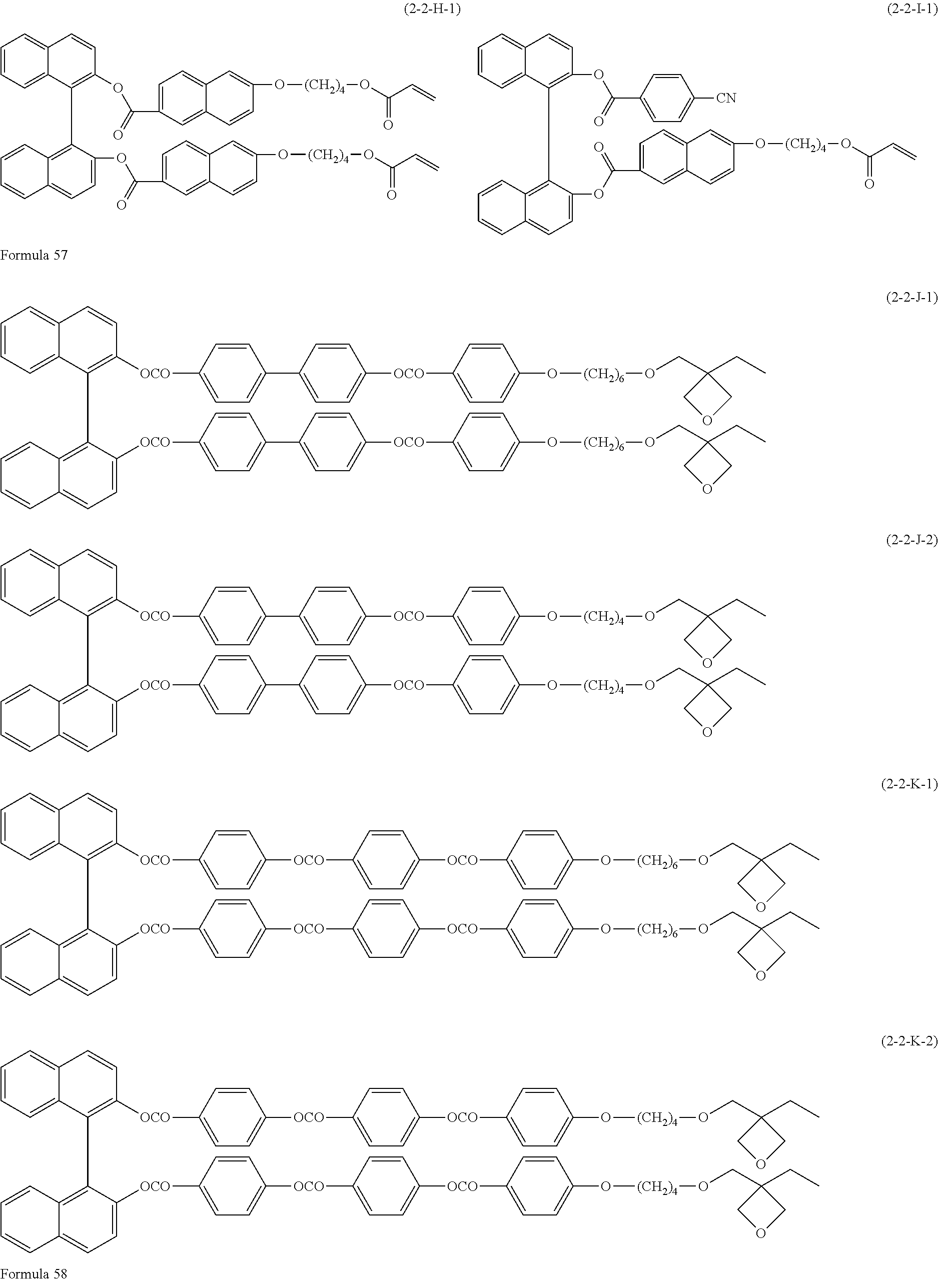

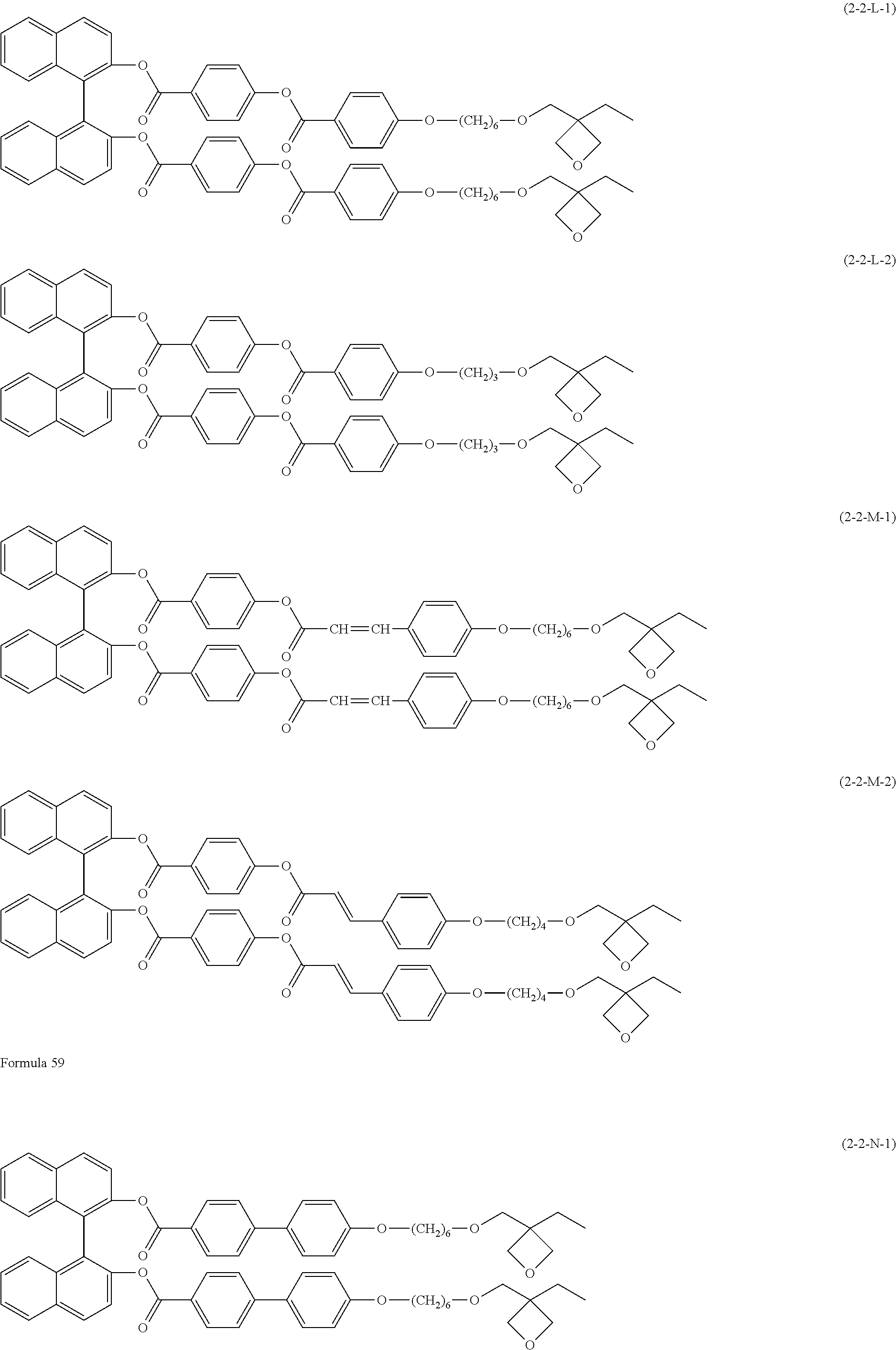

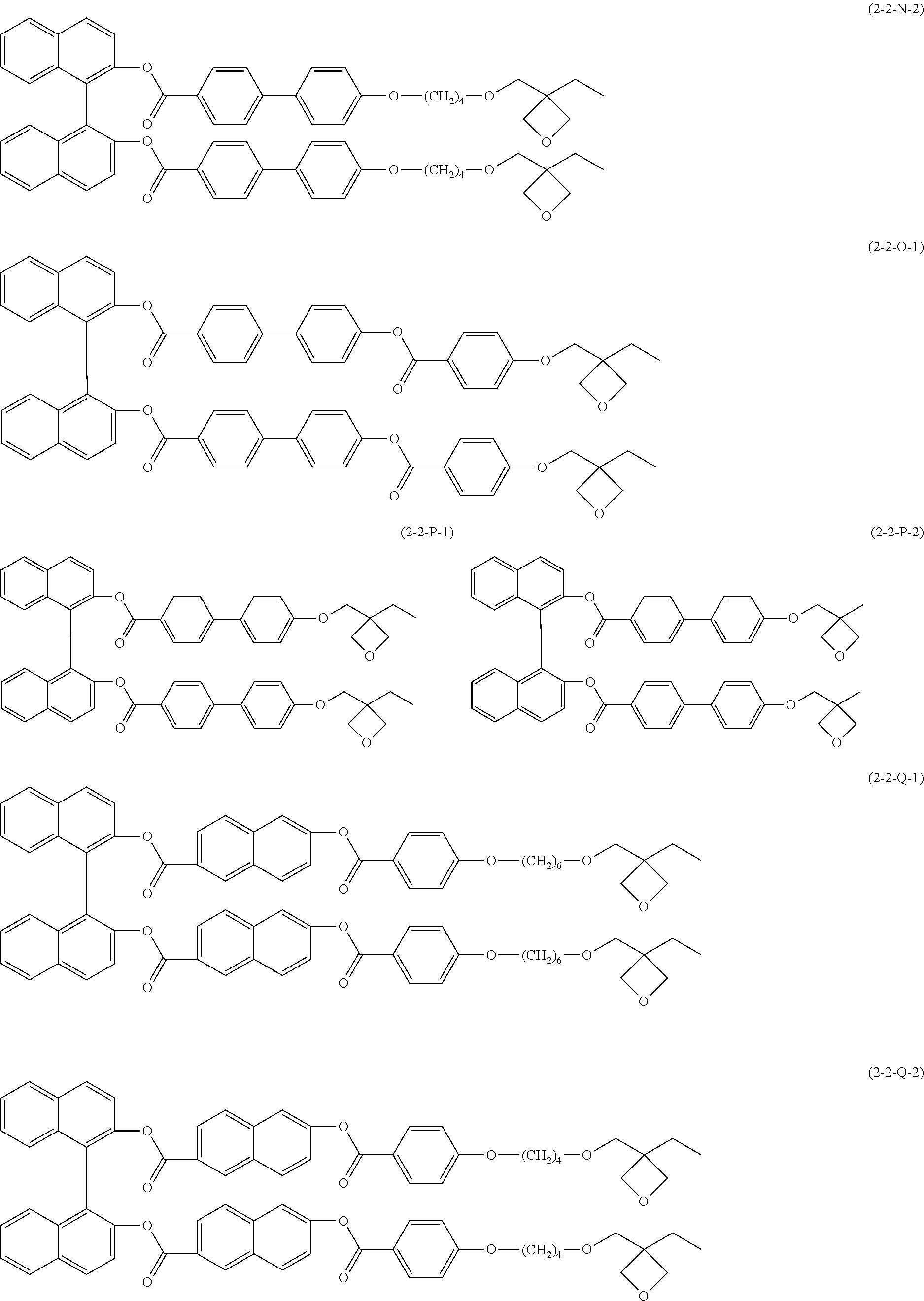

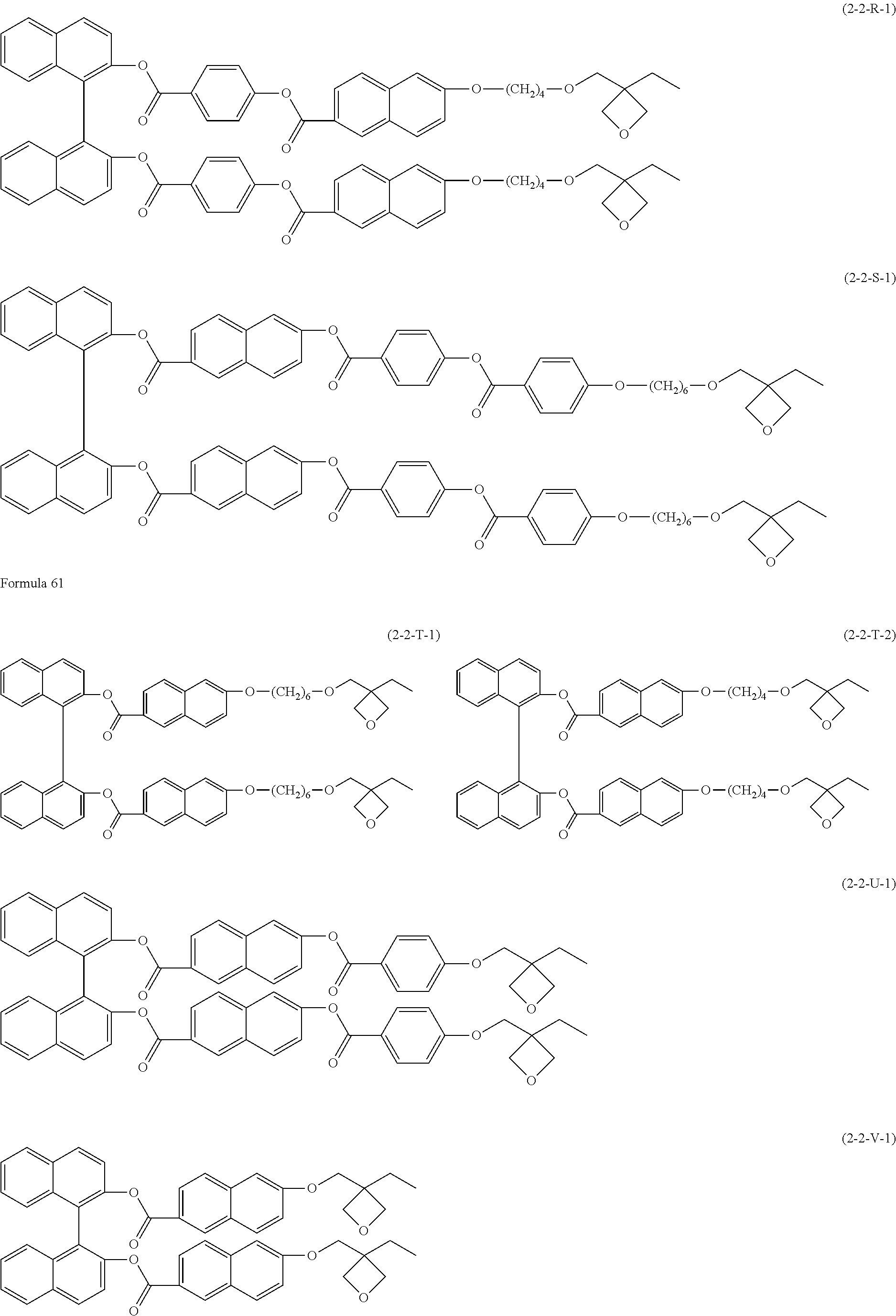

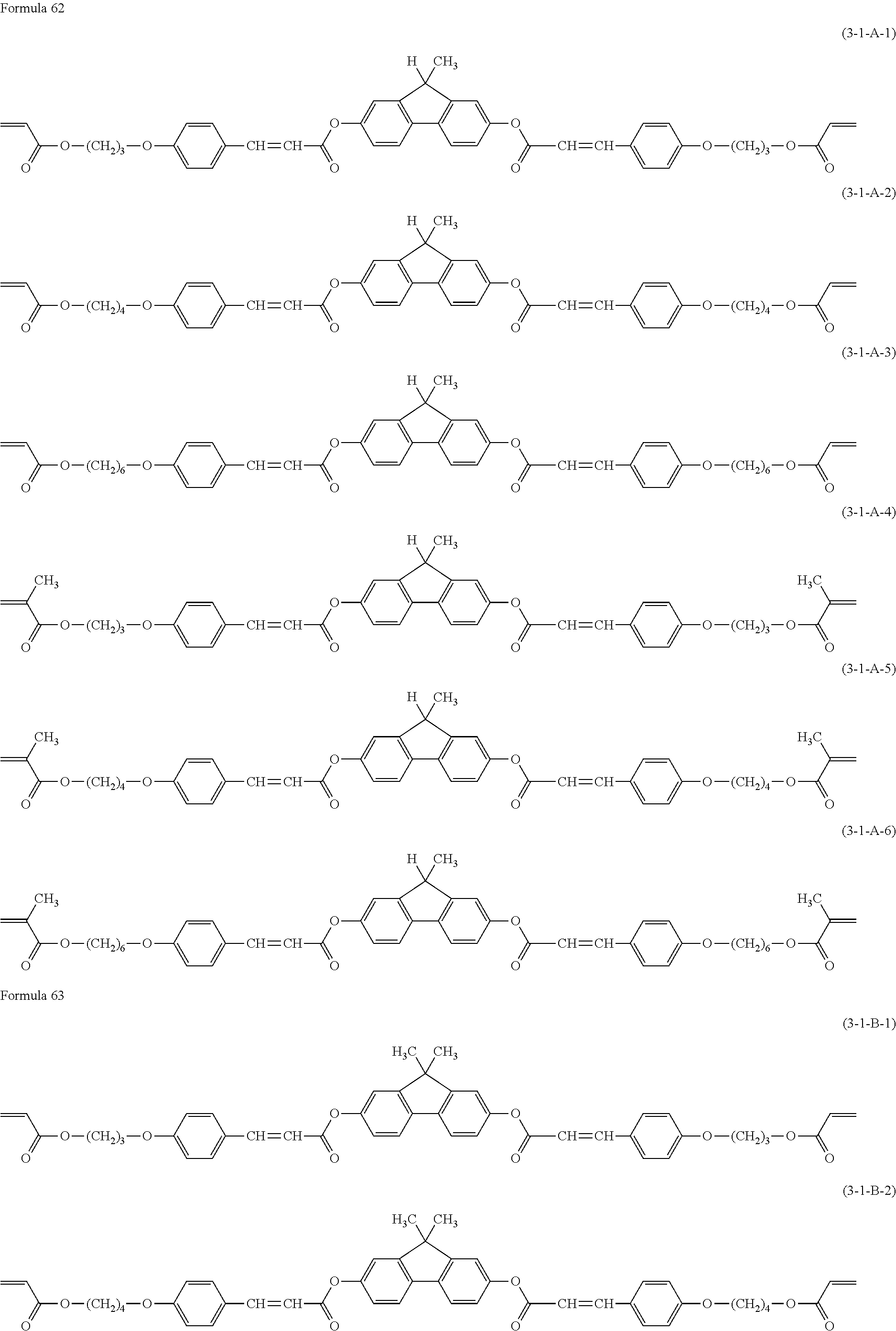

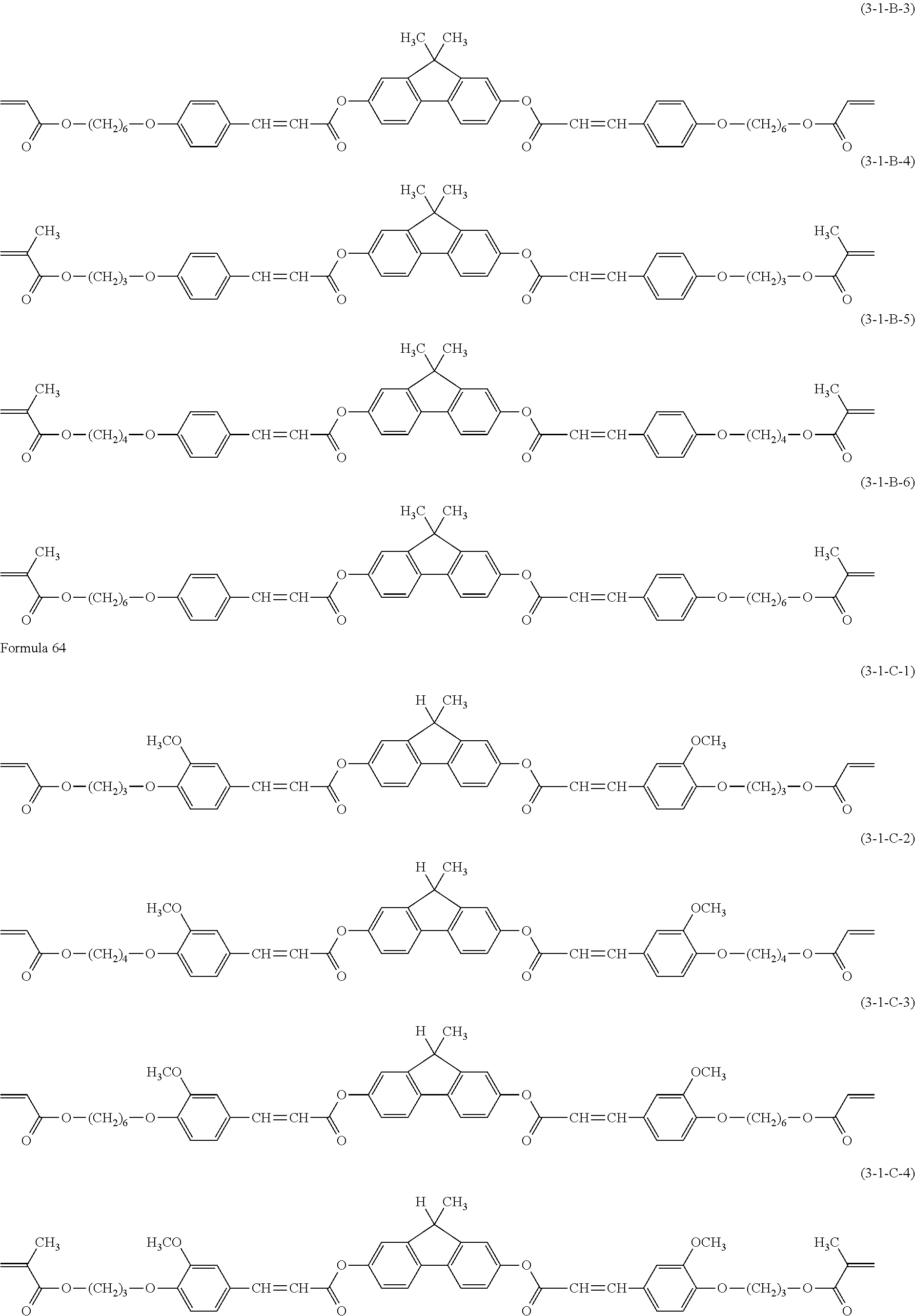

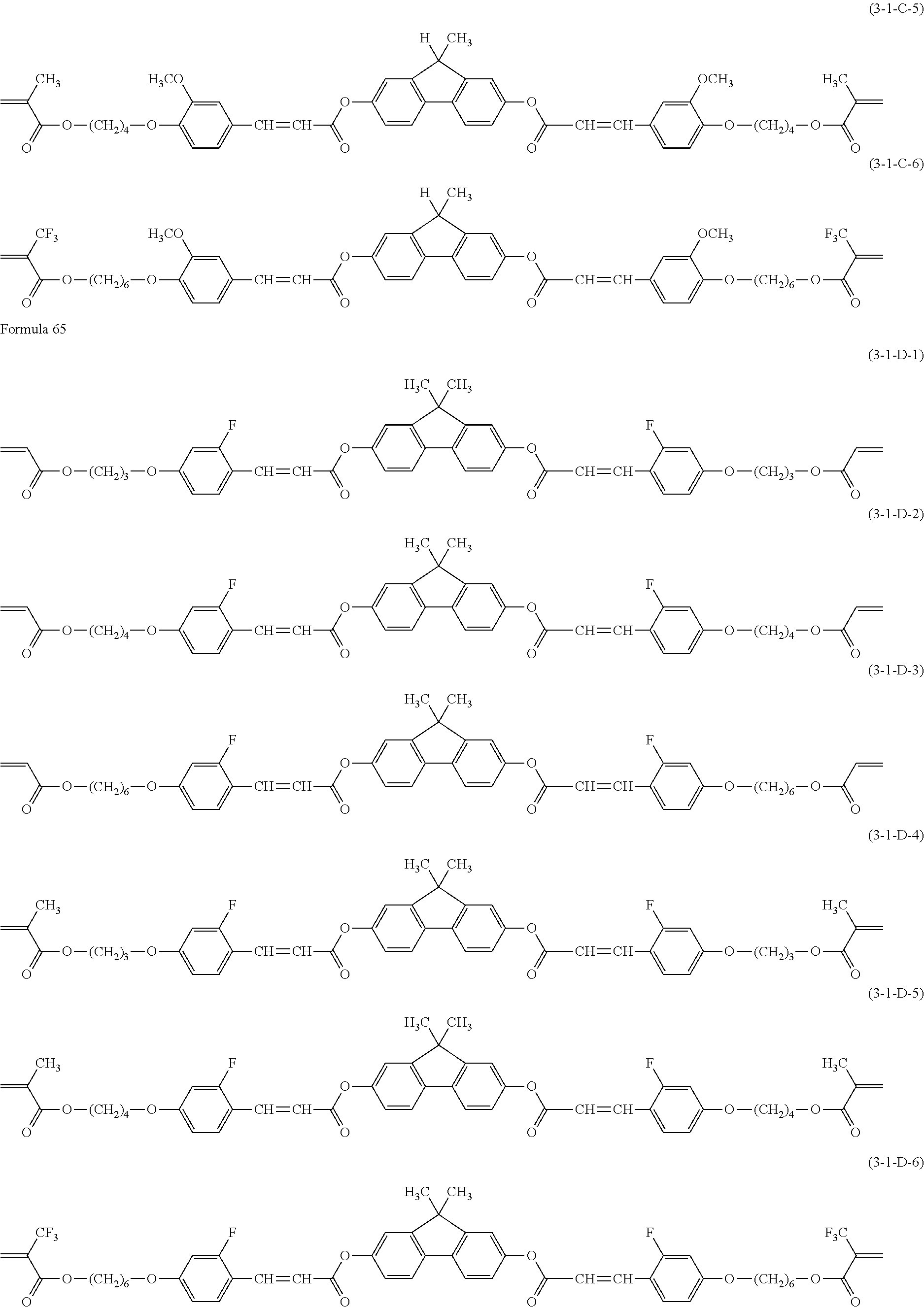

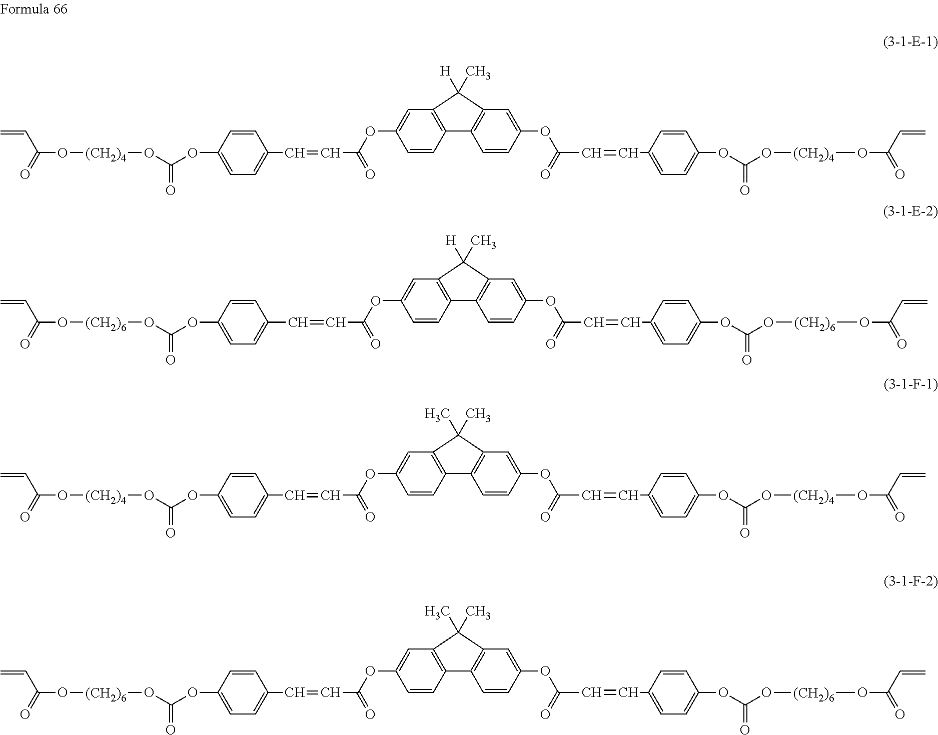

wherein, in formulas (3-1-A1) to (3-1-F-2), a trans isomer is preferred, and both of —CH═CH— further preferably take a trans form.

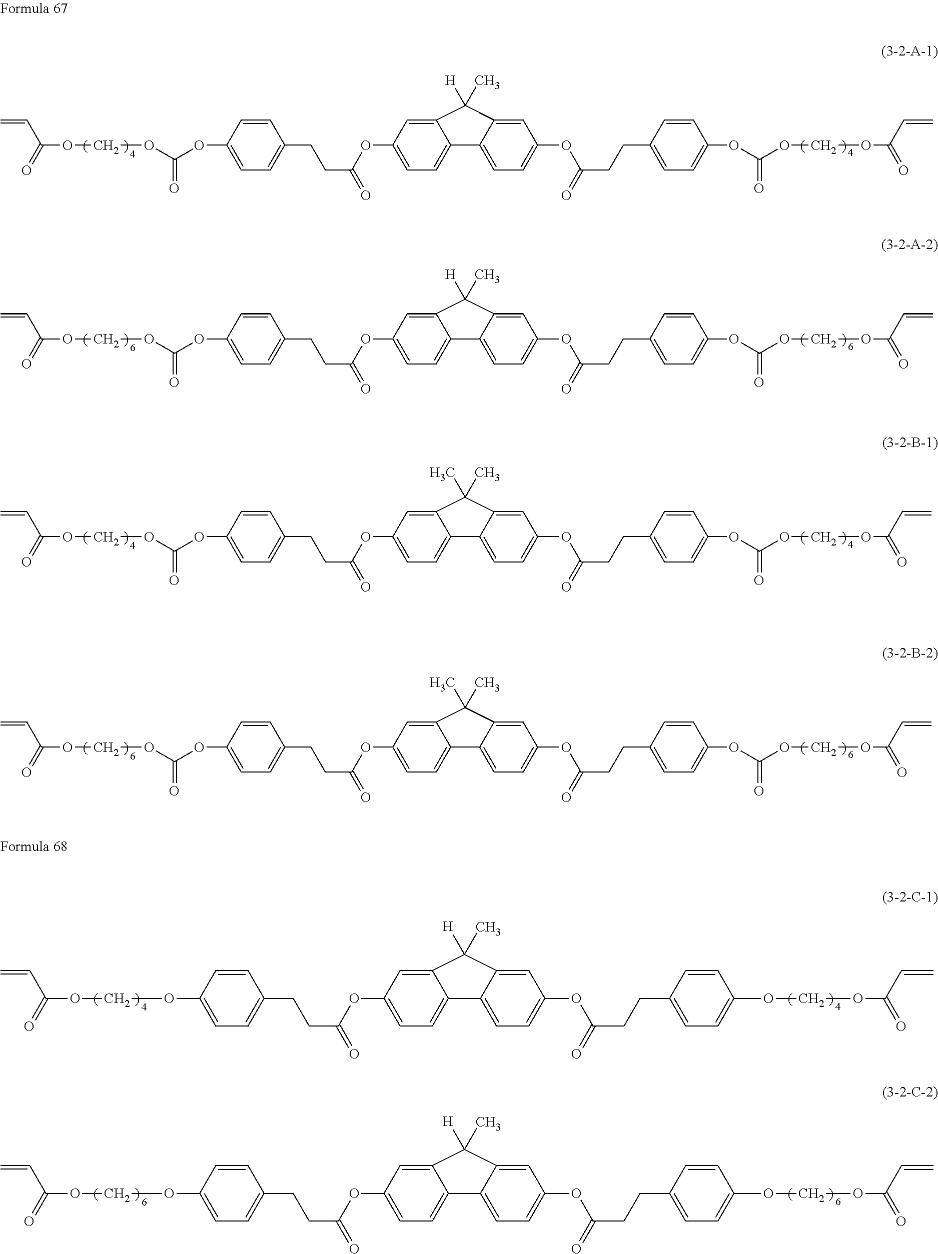

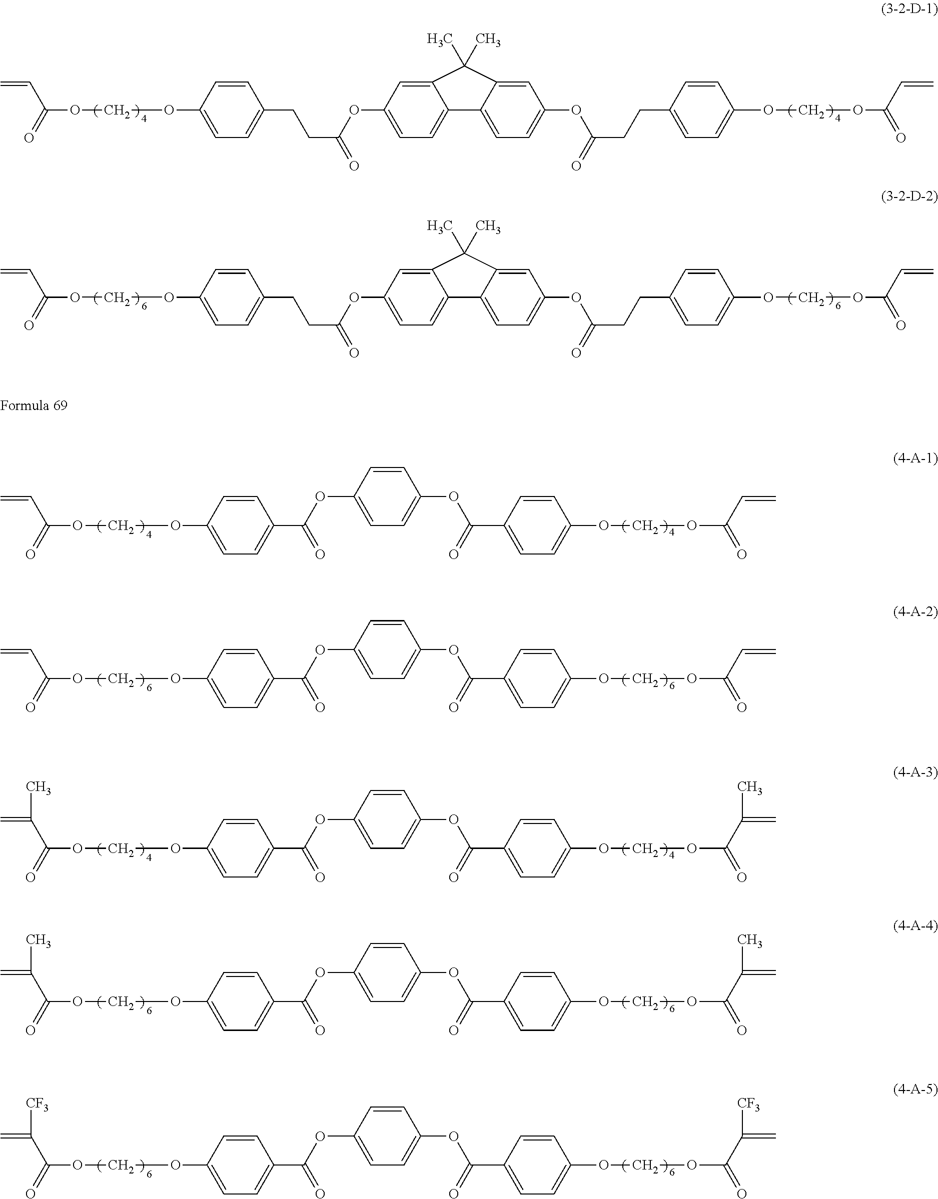

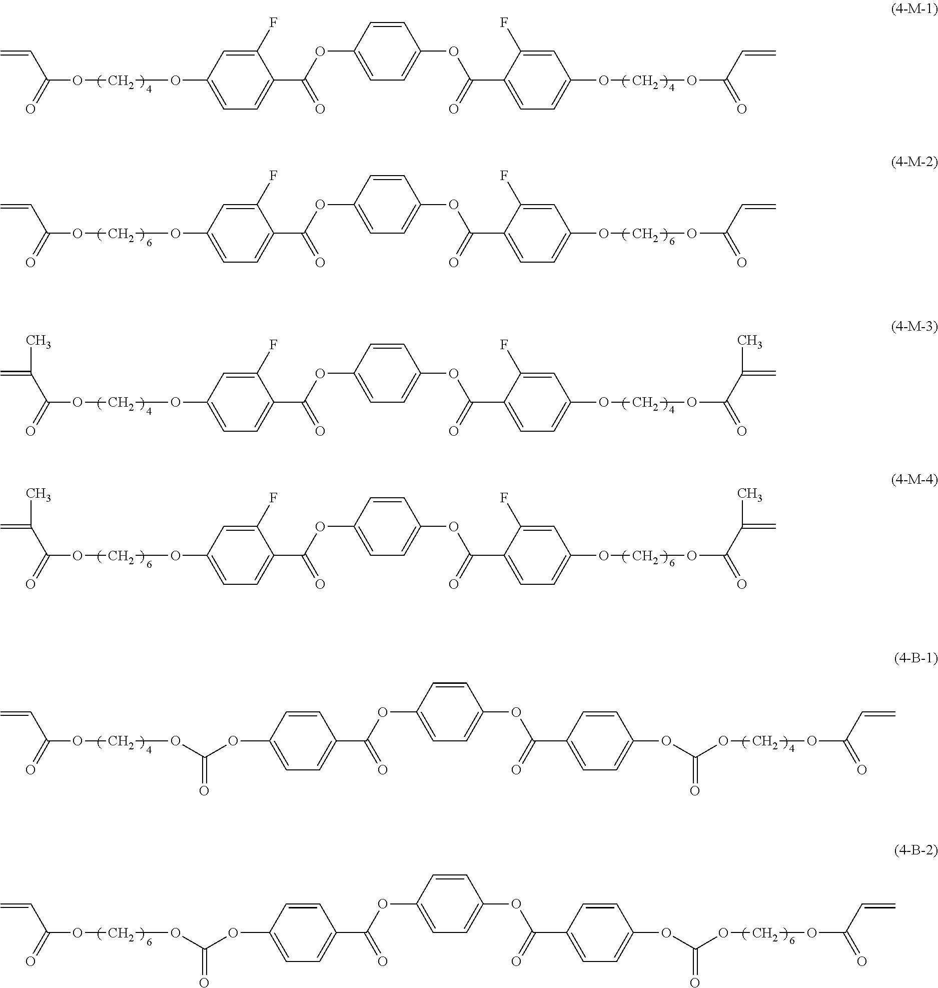

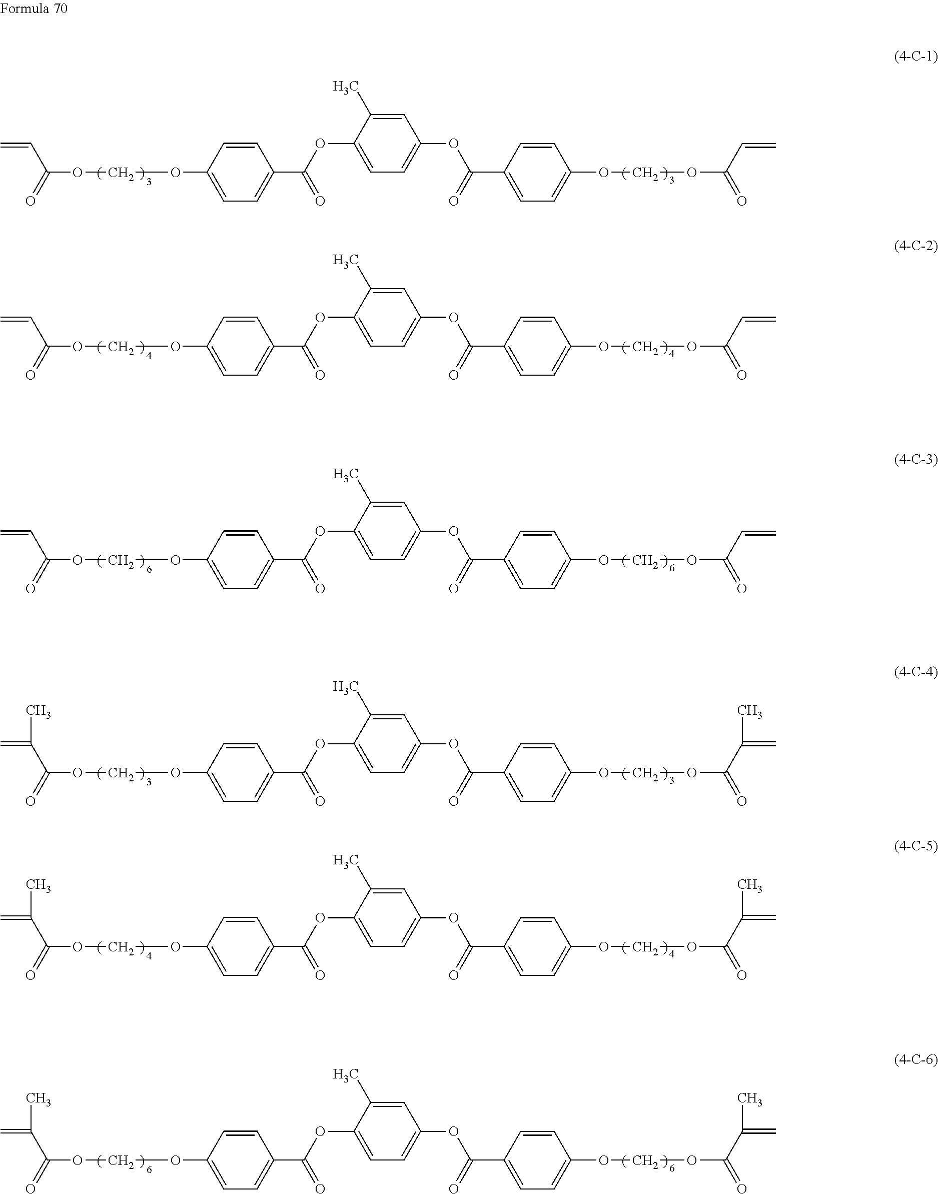

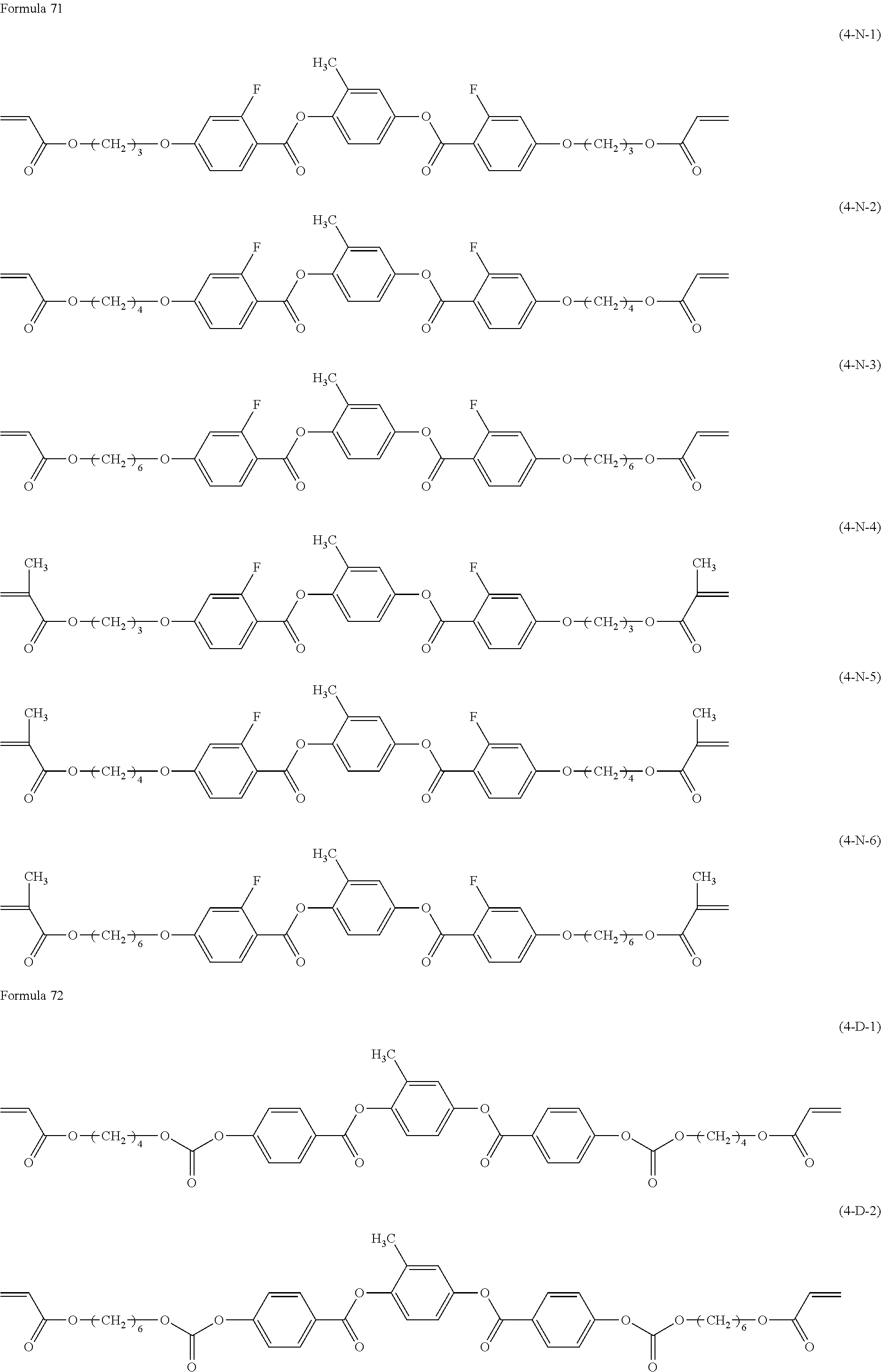

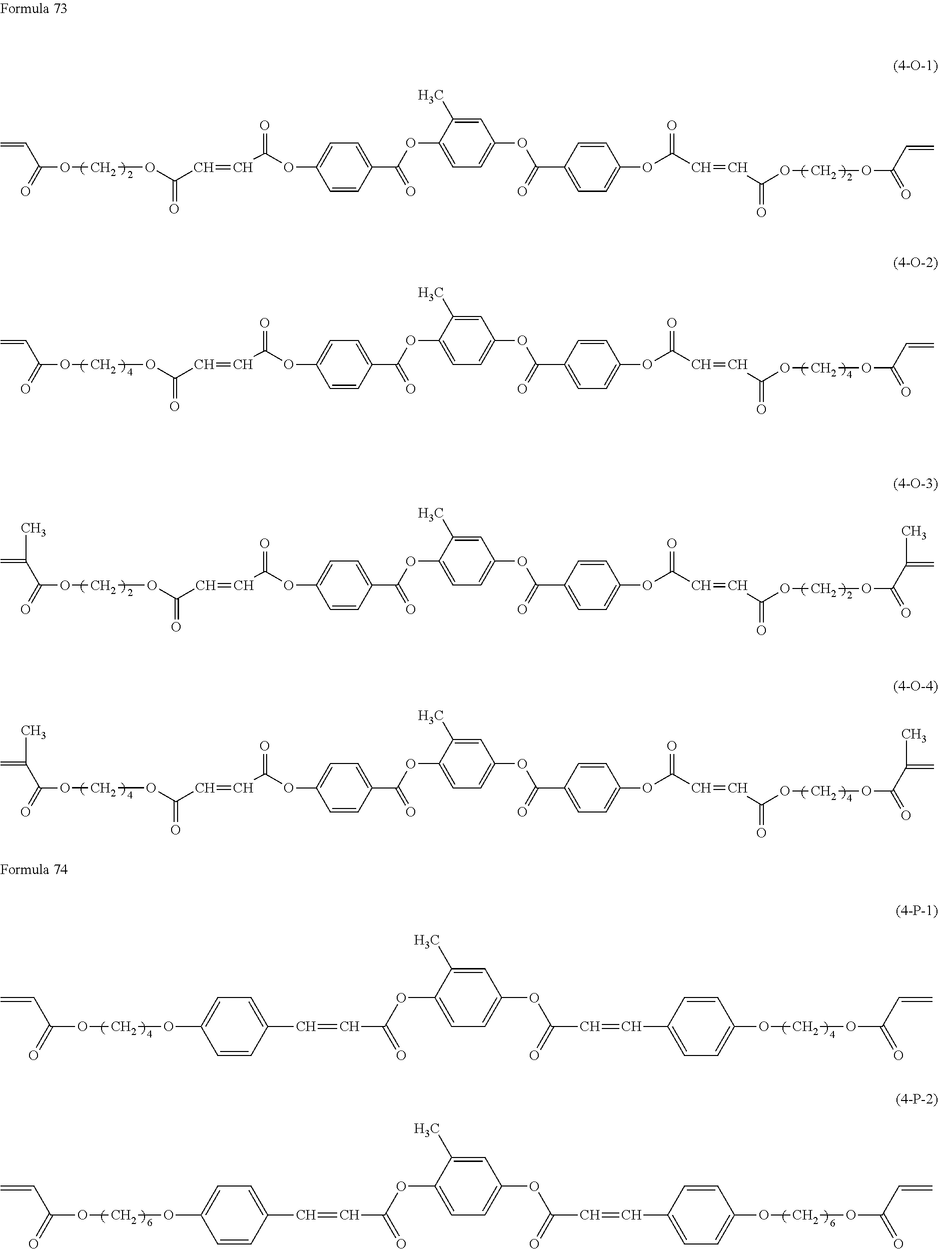

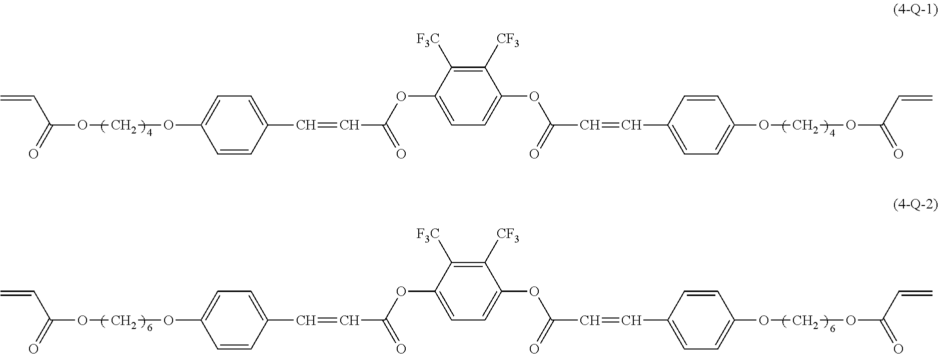

wherein, in formulas (4-P-1) to (4-Q-2), a trans isomer is preferred, and both of —CH═CH— further preferably take a trans form.

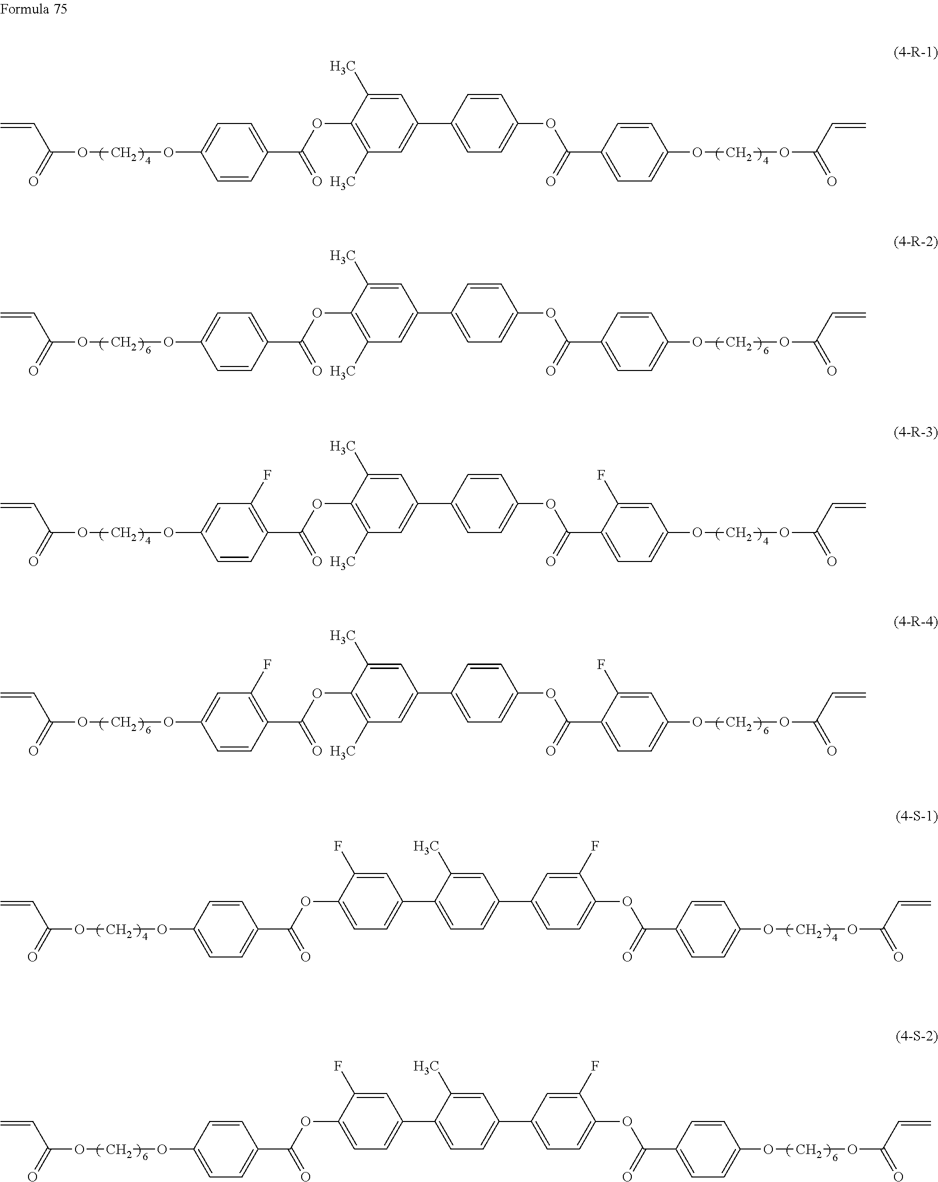

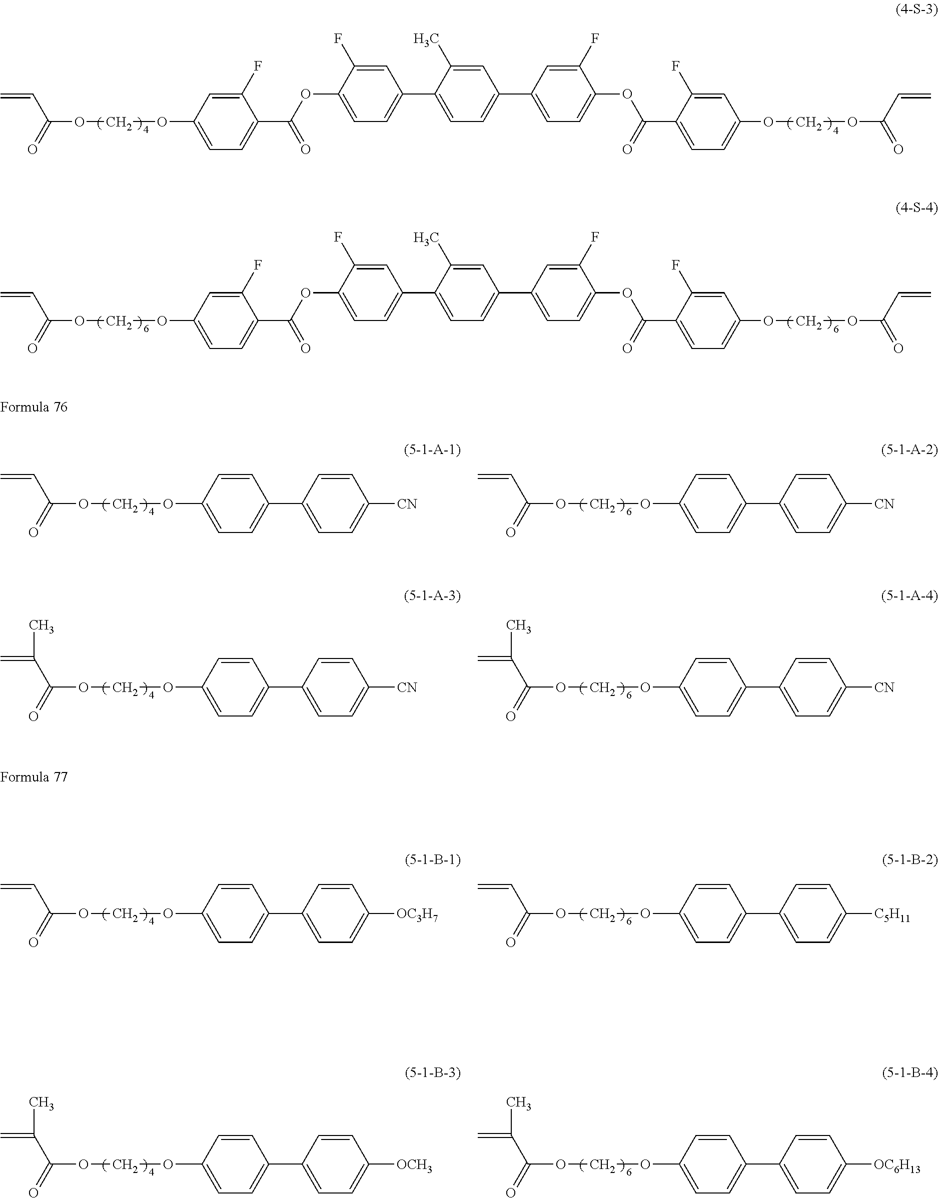

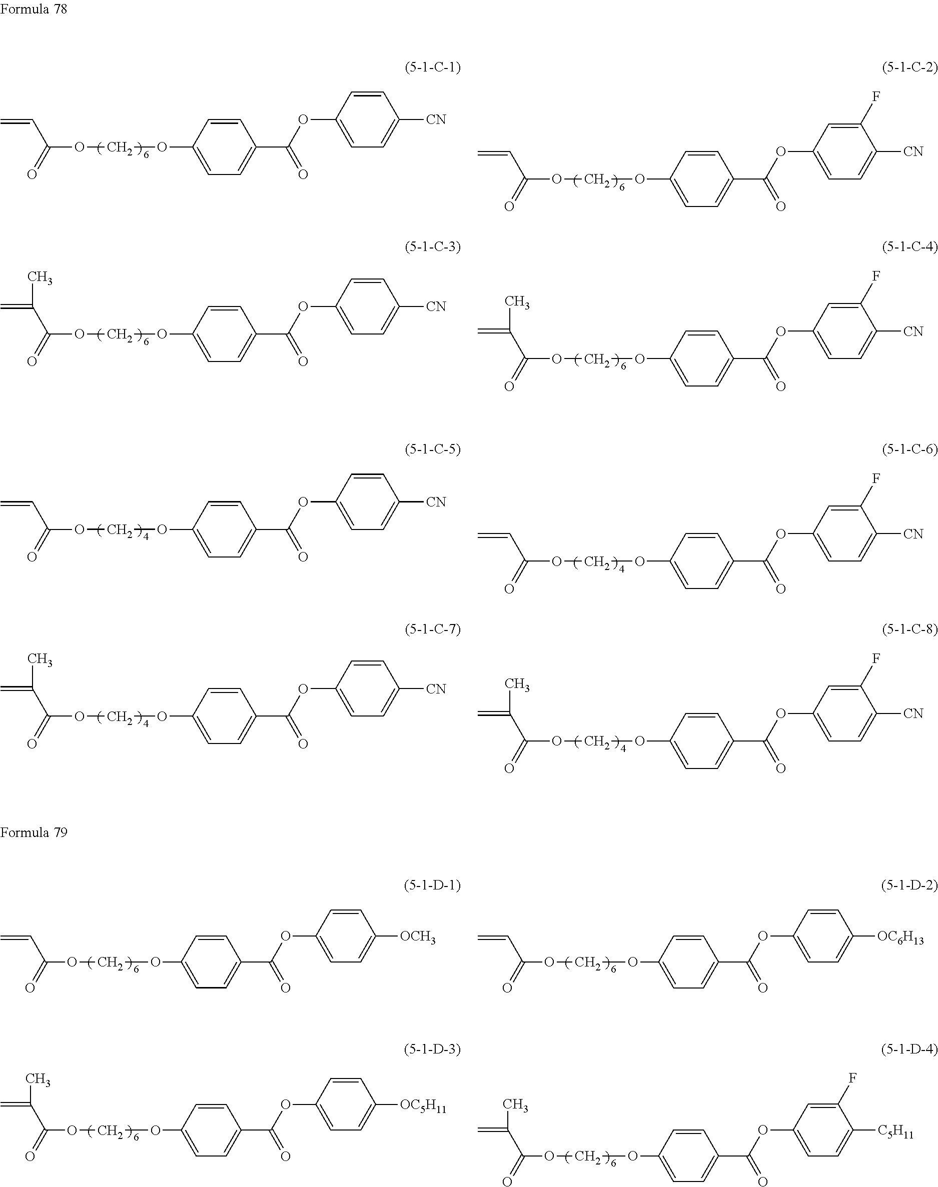

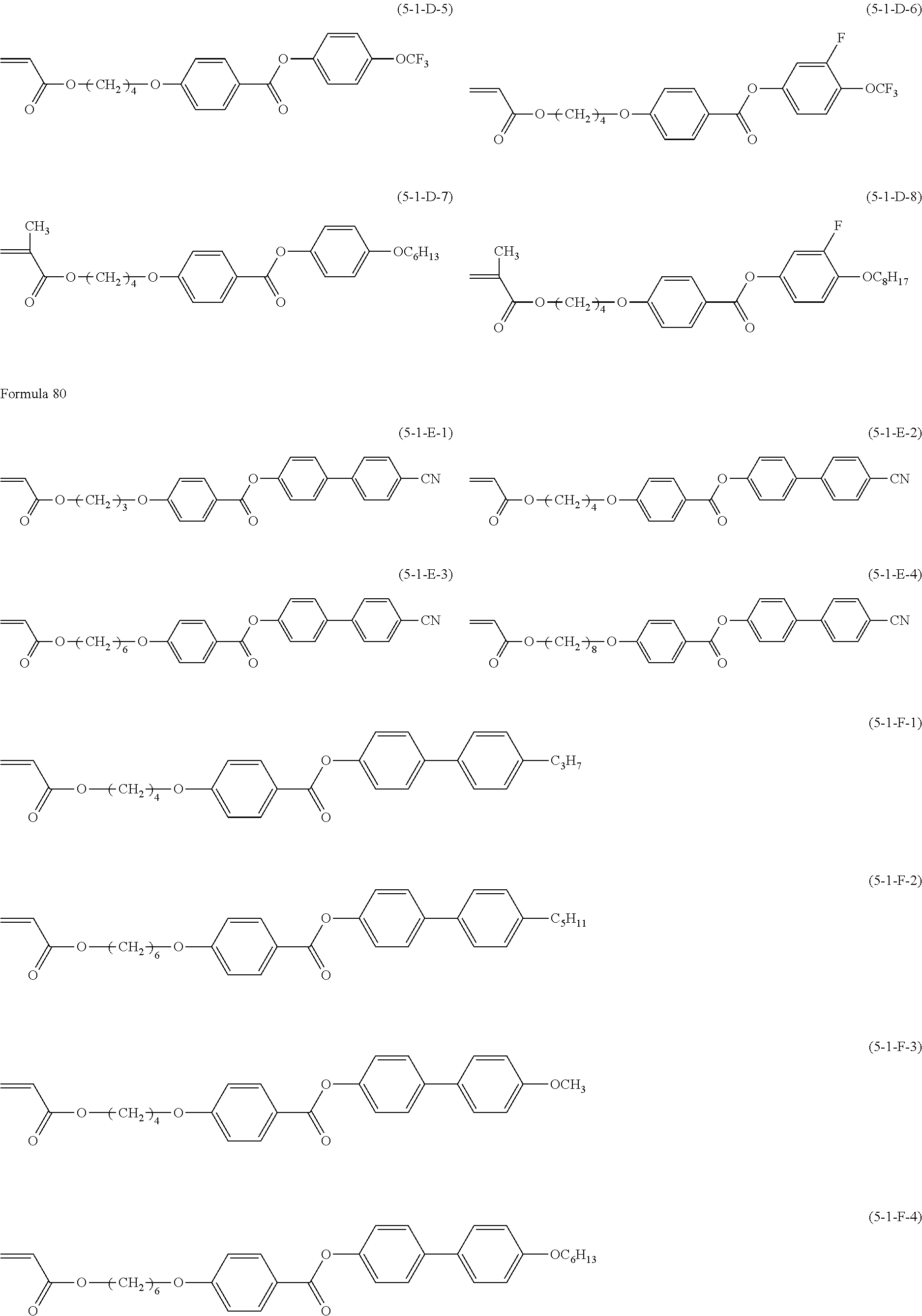

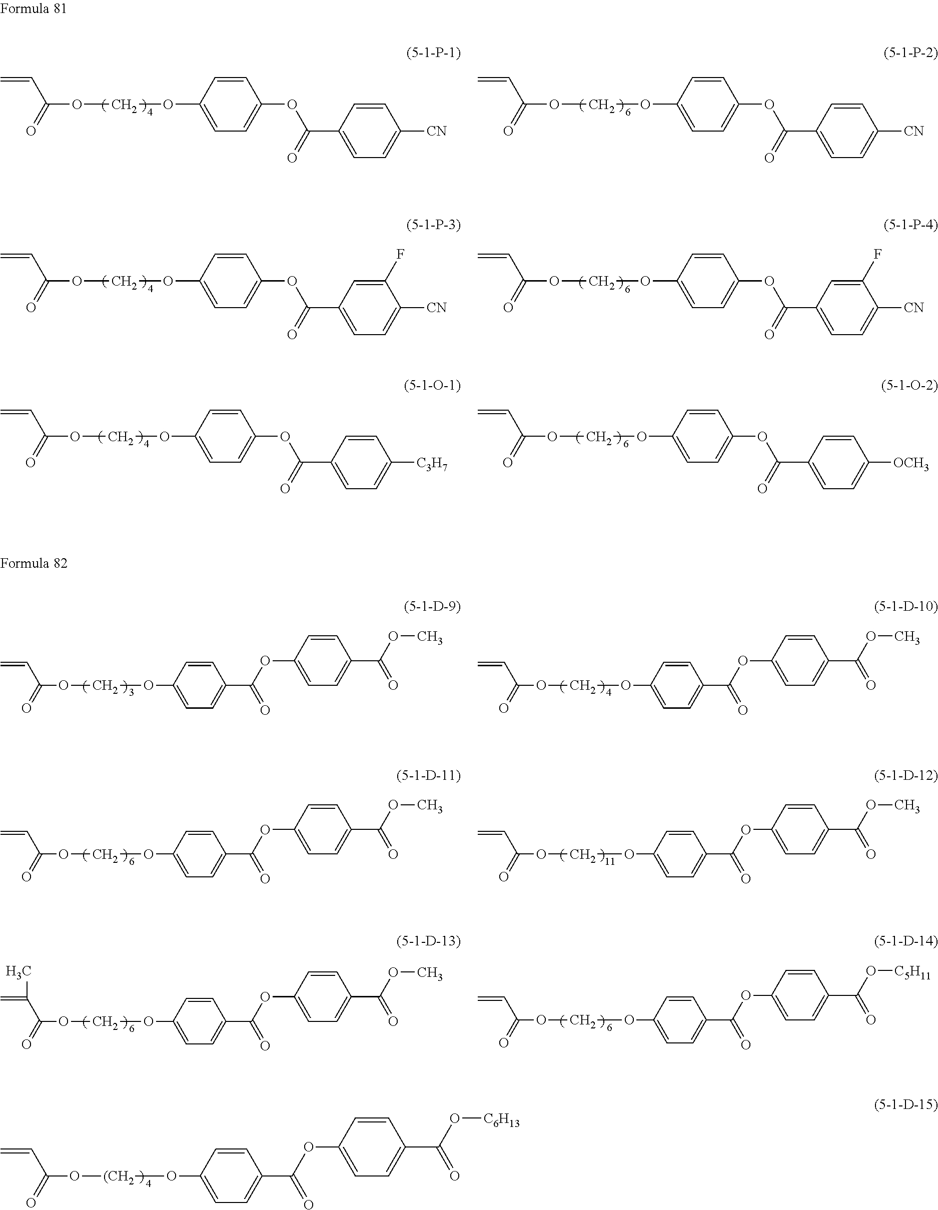

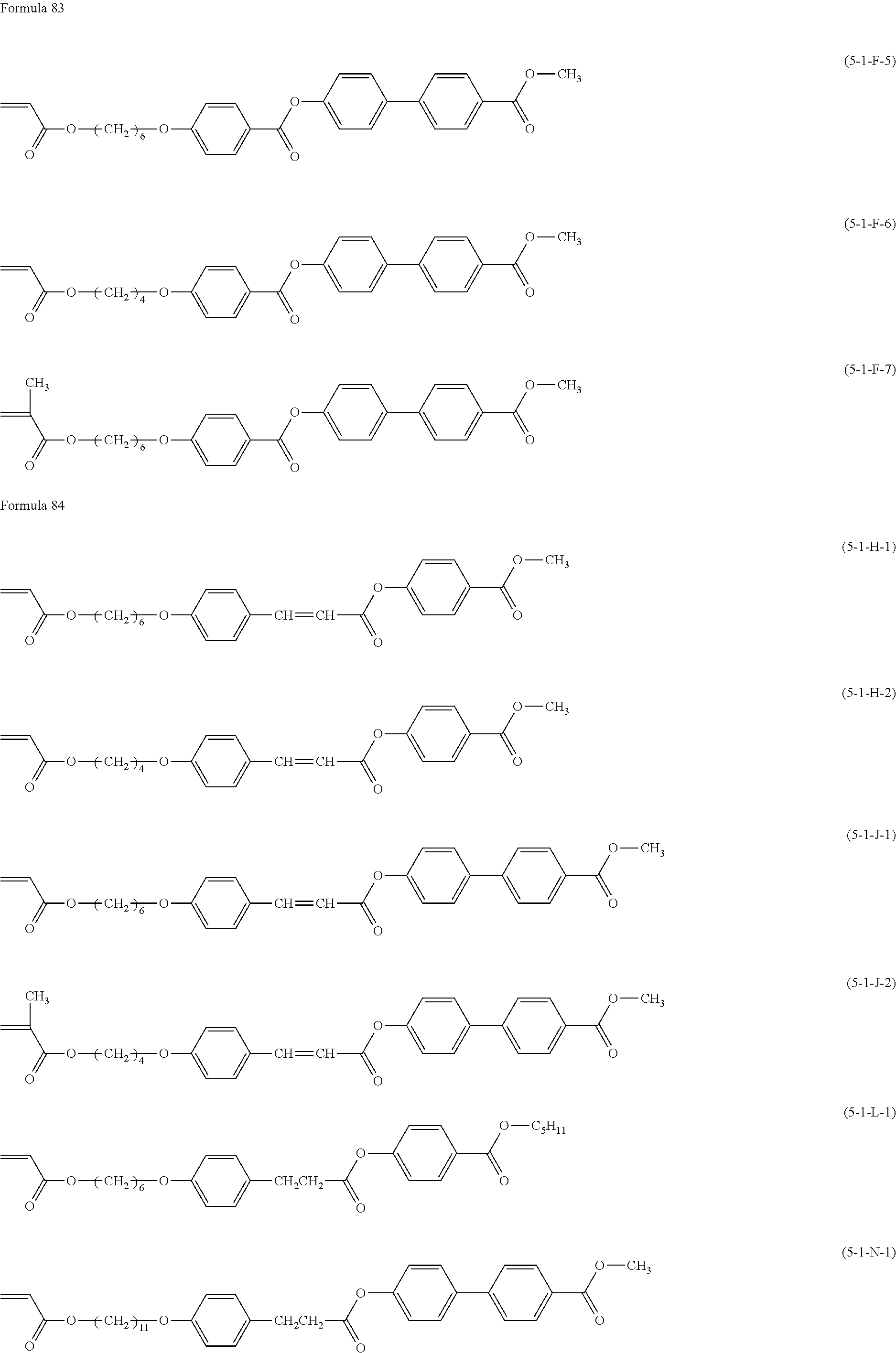

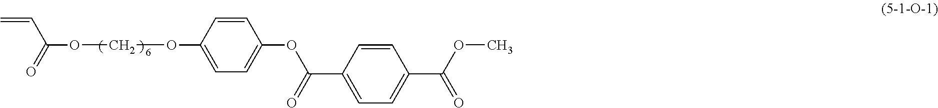

wherein, in formulas (5-1-H-1) to (5-1-H-2) and formulas (5-14-1) to (5-14-2), —CH═CH— preferably take a trans form.

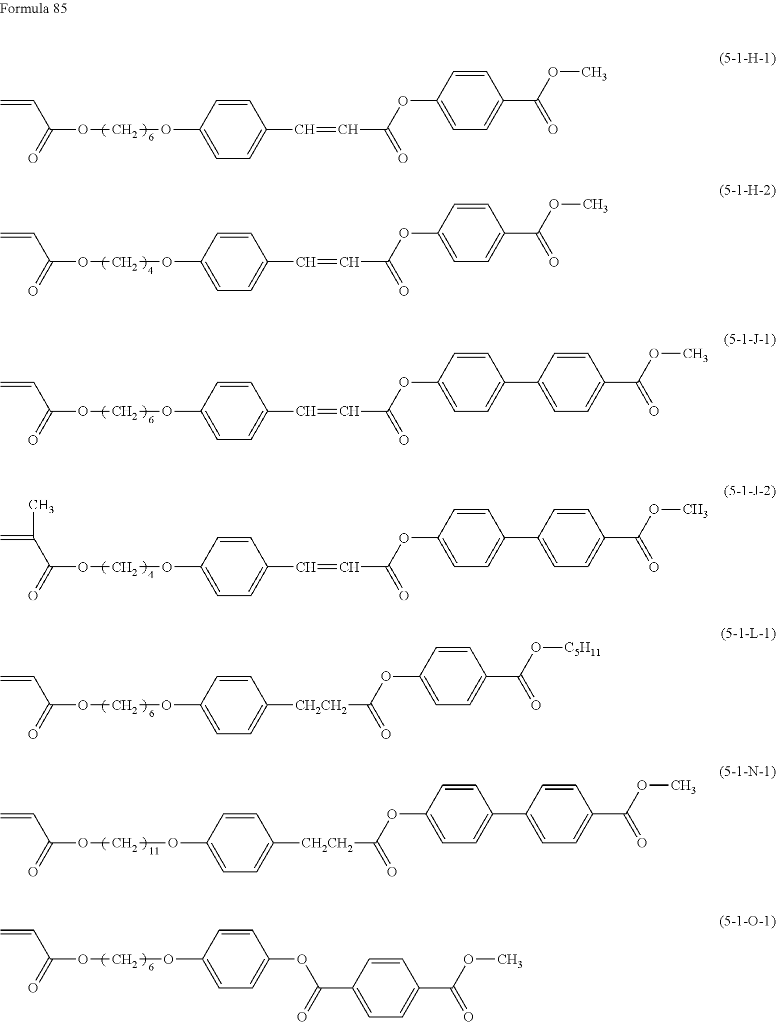

wherein, in formulas (5-1-H-1) to (5-1-H-2) and formulas (5-14-1) to (5-14-2), —CH═CH— preferably take a trans form.

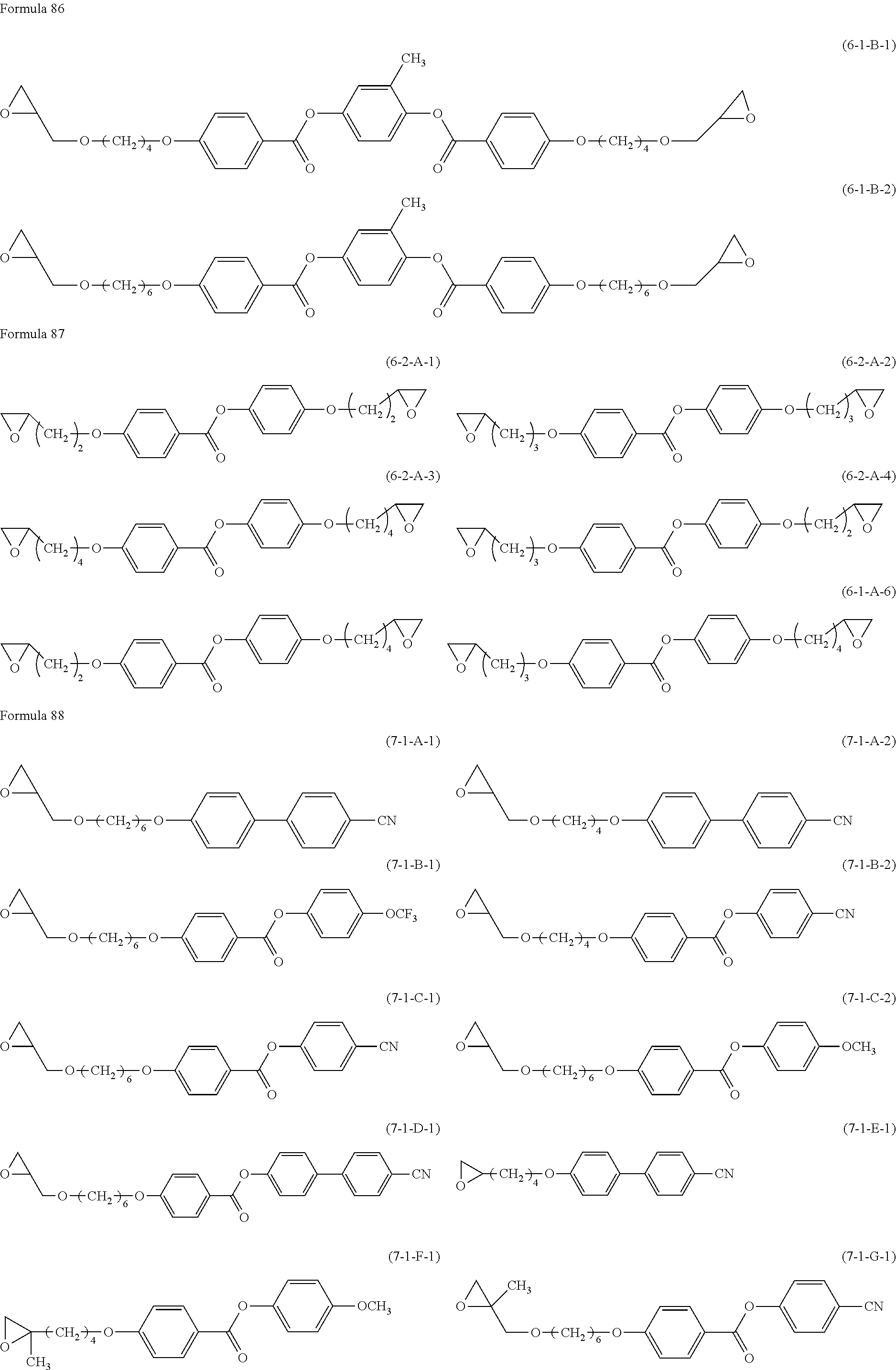

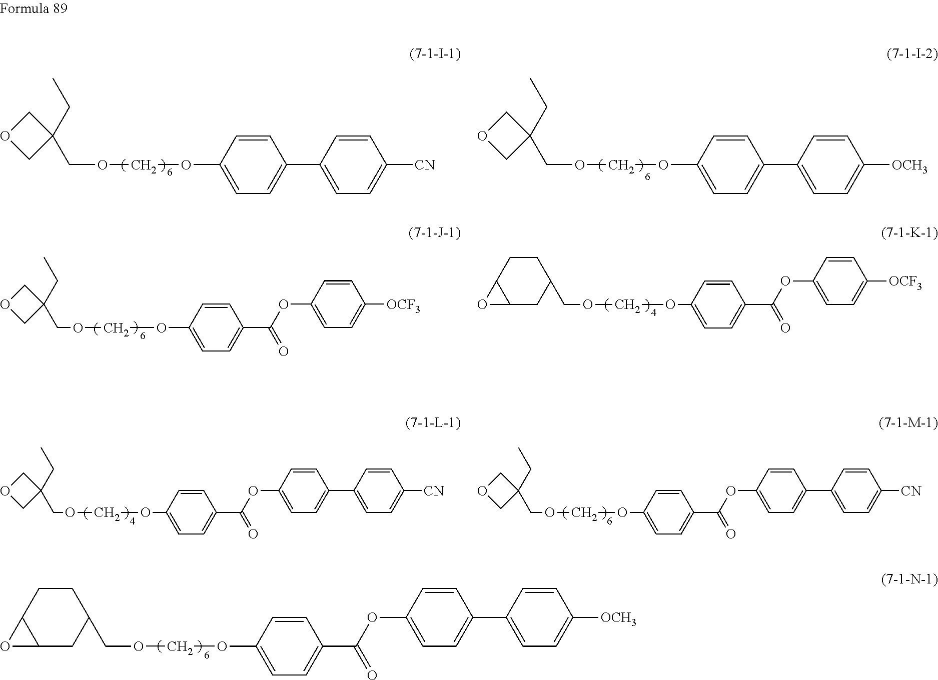

Next, specific examples of any other polymerizable compound, the additive and the organic solvent are described. The compounds may include a commercial item. Specific examples of any other polymerizable compound include a compound having one polymerizable group, a compound having two polymerizable groups, a compound having three or more polymerizable groups, a non-liquid crystalline polymerizable compound having a functional group including a hydroxyl group and an acryloyl group or a methacryloyl group in one compound, a polymerizable compound having a carboxyl group and a polymerizable compound having a phosphate group.

Specific examples of the compound having one polymerizable group but having no functional group including the hydroxyl group include styrene, nucleus-substituted styrene, acrylonitrile, vinyl chloride, vinylidene chloride, vinyl pyridine, N-vinyl pyrrolidone, vinylsulfonic acid, fatty acid vinyl ester (vinyl acetate), α,β-ethylenic unsaturated carboxylic acid (acrylic acid, methacrylic acid, maleic acid, fumaric acid and itaconic acid), alkyl ester of (meth)acrylic acid (the number carbons of alkyl: 1 to 18), hydroxy alkyl ester of (meth)acrylic acid (the number of carbons of hydroxyalkyl: 1 to 18), aminoalkyl ester of (meth)acrylic acid (the number of carbons of aminoalkyl: 1 to 18), ether oxygen-containing alkyl ester of (meth)acrylic acid (the number of carbons of ether oxygen-containing alkyl: 3 to 18, such as methoxyethyl ester, ethoxyethyl ester, methoxypropyl ester, methylcarbyl ester, ethylcarbyl ester and butylcarbyl ester), N-vinylacetamide, vinyl p-t-butyl benzoate, vinyl N,N-dimethylaminobenzoate, vinyl benzoate, vinyl pivalate, vinyl 2,2-dimethylbutanoate, vinyl 2,2-dimethylpentanoate, vinyl 2-methyl-2-butanoate, vinyl propionate, vinyl stearate, vinyl 2-ethyl-2-methylbutanoate, dicyclopentanyloxylethyl (meth)acrylate, isobornyloxylethyl (meth)acrylate, isobornyl (meth)acrylate, adamantyl(meth)acrylate, dimethyladamantyl (meth)acrylate, dicyclopentanyl (meth)acrylate, dicyclopentenyl (meth)acrylate and mono(meth)acrylic ester of polyalkylene glycol such as mono(meth)acrylate of polyethylene glycol capped with alkyl having 1 to 6 carbons at a terminal (repeating units (polymerization degree): 2 to 20), mono(meth)acrylate of polyethylene glycol capped with alkyl having 1 to 6 carbons at a terminal (repeating units (degree of polymerization): 2 to 20), mono(meth)acrylate of polypropylene glycol capped with alkyl having 1 to 6 carbons at a terminal (repeating units (degree of polymerization): 2 to 20) and a copolymer (degrees of polymerization: 2 to 20) of ethylene oxide and propylene oxide.

Specific examples of the compound having two polymerizable groups but having no functional group including the hydroxyl group include 1,4-butanediol diacrylate, 1,6-hexanediol diacrylate, 1,9-nonanediol diacrylate, neopentylglycol diacrylate, dimethyloltricyclodecane diacrylate, triethyleneglycol diacrylate, dipropyleneglycol diacrylate, tripropyleneglycol diacrylate, tetraethyleneglycol diacrylate, bisphenol A EO-added diacrylate, bisphenol A glycidyl diacrylate (Viscoat V#700), polyethylene glycol diacrylate and a methacrylate compound of the compound thereof. The compounds are suitable for further improving film-formation capability of a polymer.

Specific examples of the compound having three or more polymerizable groups but having no functional group including the hydroxyl group include trimethylolpropane tri(meth)acrylate, trimethylol EO-added tri(meth)acrylate, tris(meth)acryloyloxyethyl phosphate, tris(meth)(acryloyloxyethyl)isocyanurate, alkyl-modified dipentaerythritol tri(meth)acrylate, EO-modified trimethylolpropane tri(meth)acrylate, PO-modified trimethylolpropane tri(meth)acrylate, pentaerythritol tetra(meth)acrylate, alkyl-modified dipentaerythritol tetra(meth)acrylate, ditrimethylolpropane tetra(meth)acrylate, dipentaerythritol hexa(meth)acrylate, alkyl-modified dipentaerythritol penta(meth)acrylate, Viscoat V#802 (the number of functional groups=8) and Viscoat V#1000 (the number of functional groups=14 on average). “Viscoat” is a trade name of products from Osaka Organic Chemical Industry Ltd. A compound having 16 or more functional groups can be obtained by using Boltorn H₂O (16 functional groups), Boltorn H30 (32 functional groups) and Boltorn H40 (64 functional groups) sold by Perstorp Specialty Chemicals AB as a raw material and acrylating the raw material.

The non-liquid crystalline polymerizable compound having the functional group including the hydroxyl group and having acryloyl group or methacryloyl group may include a commercial item. Preferred examples include butanediol monoacrylate, a reaction product between butyl glycidyl ether and (meth)acrylic acid (Denacol DA151 (registered trademark), made by Nagase & Co., Ltd.), 3-chloro-2-hydroxypropyl methacrylate, glycerol methacrylate (Blemmer (registered trademark) GLM, made by NOF Corporation), glycerol acrylate, glycerol dimethacrylate (Blemmer GMR series, made by NOF Corporation), glycerol triacrylate (EX-314, made by Nagase ChemteX Corporation), 2-hydroxyethyl acrylate (BHEA, made by Nippon Shokubai Co., Ltd.), 2-hydroxyethyl methacrylate (HEMA, made by Nippon Shokubai Co., Ltd.), 2-hydroxypropyl acrylate (HPA, made by Nippon Shokubai Co., Ltd.), 2-hydroxypropyl methacrylate (HPMA, made by Nippon Shokubai Co., Ltd.), caprolactone-modified 2-hydroxyethyl acrylate, caprolactone-modified 2-hydroxyethyl methacrylate, phenoxyhydroxypropyl acrylate (M-600A, made by Kyoeisha Chemical Co., Ltd.), 2-hydroxy-3-acryloyloxypropyl methacrylate (G-201P, made by Kyoeisha Chemical Co., Ltd.), Kayarad (registered trademark) R167, made by Nippon Kayaku Co., Ltd., triglycerol diacrylate (Epoxy Ester 80MFA, made by Kyoeisha Chemical Co., Ltd.), pentaerythritol tri(meth)acrylate, dipentaerythritolmonohydroxy penta(meth)acrylate, 2-acryloyloxyethyl succinate, 2-acryloyloxyethyl hexahydrophthalate, 2-acryloyloxyethyl phthalate, 2-acryloyloxyethyl-2-hydroxyethyl phthalate, 2-acryloyloxyethyl acid phosphate, 2-methacryloyloxyethyl acid phosphate, 2-methacryloyloxyethyl succinate, 2-methacryloyloxyethyl hexahydrophthalate, 2-acryloyloxyethyl-2-hydroxyethyl phthalate, 4-(2-acryloyloxyeth-1-yloxy)benzoic acid, 4-(3-acryloyloxy-n-prop-1-yloxy)benzoic acid, 4-(2-methacryloyloxyeth-1-yloxy)benzoic acid, 4-(4-acryloyloxy-n-but-1-yloxy)benzoic acid, 4-(6-acryloyloxy-n-hex-1-yloxy)benzoic acid, 4-(6-acryloyloxy-n-hex-1-yloxy)-2-methylbenzoic acid, 4-(6-methacryloyloxy-n-hex-1-yloxy)benzoic acid, 4-(10-acryloyloxy-n-dec-1-yloxy)benzoic acid, 2-acryloyloxyethyl acid phosphate and 2-methacryloiloxy-ethyl acid phosphate.

Specific examples of monomethacrylate of polyethylene glycol having a degree of polymerization from 2 to 20, as exemplified by formula (T-1) described below, include Blemmer PE-90 (n=2), PE-200 (n=4.5) and PE-350 (n=8), as made by NOF Corporation. The number of repeating units (degree of polymerization) of a polyethylene glycol chain herein is further preferably 2 to 10, in which n represents the mean number of constitutional units.

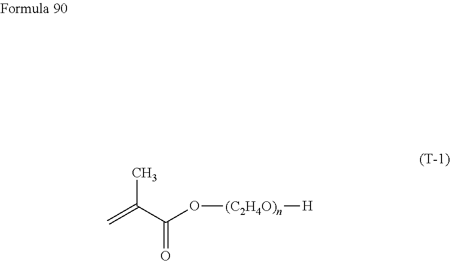

Specific examples of monoacrylic ester of polyethylene glycol having a degree of polymerization from 2 to 20 include, as exemplified by formula (T-2) described below, Blemmer AE-90 (n=2), AE-200 (n=4.5) and AE-400 (n=10), as made by NOF Corporation. The number of repeating units (degree of polymerization) of a polyethylene glycol chain herein is further preferably 2 to 10.

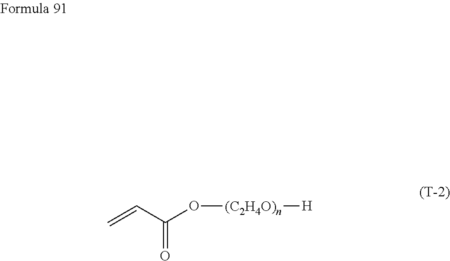

Specific examples of monomethacrylate of polypropylene glycol having a degree of polymerization from 2 to 20 include, as exemplified by formula (T-3) described below, Blemmer PP-1000 (n=4 to 6), PP-500 (n=9) and PP-800 (n=13), as made by NOF Corporation. The number of repeating units (degree of polymerization) of a polyethylene glycol chain is further preferably 3 to 13.

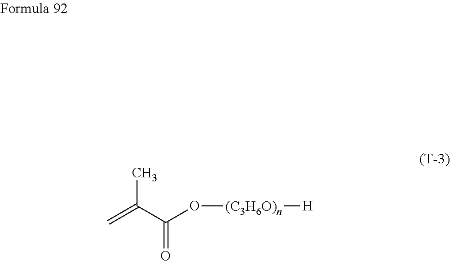

Specific examples of monoacrylate of polypropylene glycol having a degree of polymerization from 2 to 20 include, as exemplified by formula (T-4) described below, Blemmer AP-150 (n=3), AP-400 (n=6), AP-550 (n=9) and AP-800 (n=13), as made by NOF Corporation. The number of repeating units (degree of polymerization) of a polyethylene glycol chain is further preferably 3 to 13.

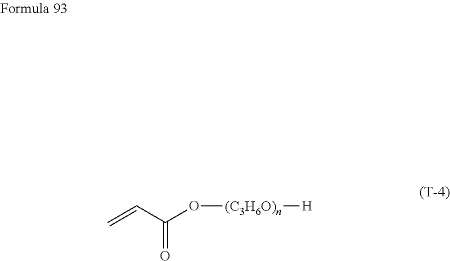

Specific examples of poly(ethylene glycol-propylene glycol) monomethacrylate include, as exemplified by formula (T-5) described below, Blemmer 50PEP-300, made by NOF Corporation. Ethylene or propylene that means R herein is randomly copolymerized. The mean number (m) of constitutional units of ethyleneoxy and propyleneoxy is approximately 2.5 and approximately 3.5, respectively. Further, m described below also represents the mean number of constitutional units of each alkylene.

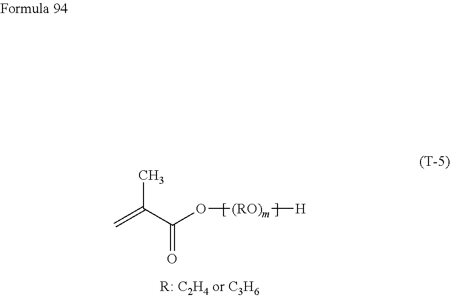

Specific examples of polyethylene glycol-polypropylene glycol monomethacrylate include, as exemplified by formula (T-6) described below, Blemmer 70PEP-350 B (m=5, n=2), made by NOF Corporation.

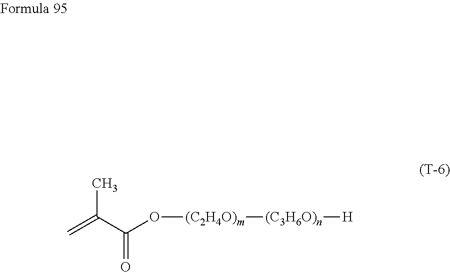

Specific examples of polyethylene glycol-polypropylene glycol monoacrylate include Blemmer AEP series.

Specific examples of poly(ethylene glycol-tetramethylene glycol) monomethacrylate include, as exemplified by formula (T-7) described below, Blemmer 55PET-400, 30PET-800 and 55PET-800, as made by NOF Corporation. The number of repeating units of a poly(ethylene glycol-tetramethylene glycol) chain herein is further preferably 2 to 10. In the formula, ethylene or butylene that means R is randomly copolymerized. The mean number (m) of constitutional units of ethyleneoxy and butyleneoxy is 5 and 2 in 55PET-400, 6 and 10 in 30PET-800, and 10 and 5 in 55PET-800, respectively.

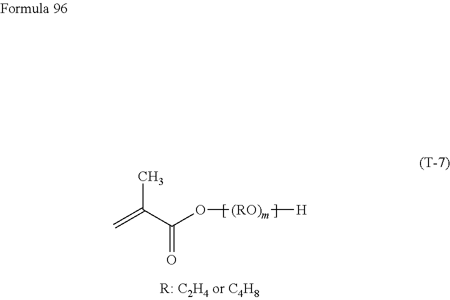

Specific examples of poly(ethylene glycol-tetramethylene glycol) monoacrylate include Blemmer AET series, made by NOF Corporation.

Specific examples of poly(propylene glycol-tetramethylene glycol) monomethacrylate include, as exemplified by formula (T-8) described below, Blemmer 30PPT-800, 50PPT-800 and 70PPT-800, as made by NOF Corporation. The number of repeating units of a poly(propylene glycol-tetramethylene glycol) chain herein is further preferably 3 to 10. In the formula, propyleneoxy or butyleneoxy that means R is randomly copolymerized. The mean number (m) of constitutional units of propylene and butylene is 4 and 8 in 30PPT-800, 7 and 6 in 50PPT-800 and 10 and 3 in 70PPT-800, respectively.

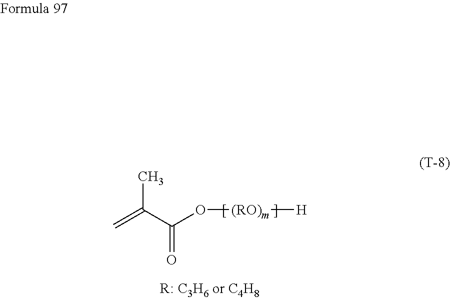

Specific examples of poly(propylene glycol-tetramethylene glycol) monoacrylate include Blemmer APT series, made by NOF Corporation.

Specific examples of propylene glycol-polybutylene glycol mono((meth)acrylate) include, as exemplified by formula (T-9) described below, Blemmer 10PPB-500B (n=6), and as exemplified by formula (T-10) described below, 10APB-500B (n=6), as made by NOF Corporation. The number of repeating units of a propylene glycol-polybutylene glycol chain herein is further preferably 6.

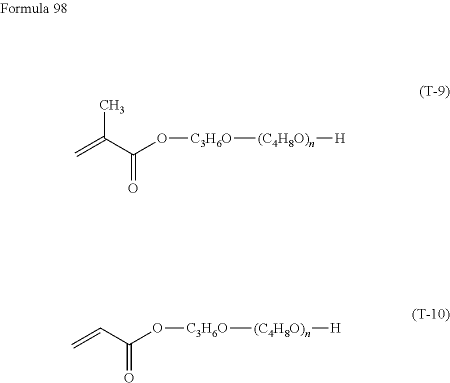

Specific preferred examples of the polymerizable compound having carboxyl group are described below, and may include a commercial item.

Specific preferred examples include 2-methacryloyloxyethyl succinate (Light Ester HO-MS (N), made by Kyoeisha Chemical Co., Ltd.), 2-methacryloyloxyethyl hexahydrophthalate (Light Ester HO-HH(N), made by Kyoeisha Chemical Co., Ltd.), 2-acryloyloxyethyl succinate (Light Ester HOA-MS(N), made by Kyoeisha Chemical Co., Ltd.), 2-acryloyloxyethyl hexahydrophthalate (Light Acrylate HOA-HH(N), made by Kyoeisha Chemical Co., Ltd.), 2-acryloyloxyethyl phthalate (Light Acrylate HOA-MPL(N), made by Kyoeisha Chemical Co., Ltd.), 2-acryloyloxyethyl-2-hydroxyethyl phthalate (Light Acrylate HOA-MPE(N), made by Kyoeisha Chemical Co., Ltd.), 4-(2-acryloyloxyeth-1-yloxy)benzoic acid (ST01630, made by Synthon Chemicals GmbH & Co. KG), 4-(3-acryloyloxy-n-prop-1-yloxy)benzoic acid (ST02453, made by Synthon Chemicals GmbH & Co. KG), 4-(2-methacryloyloxyeth-1-yloxy)benzoic acid (ST01889, made by Synthon Chemicals GmbH & Co. KG), 4-(4-acryloyloxy-n-but-1-yloxy)benzoic acid (ST01680, made by Synthon Chemicals GmbH & Co. KG), 4-(6-acryloyloxy-n-hex-1-yloxy)benzoic acid (ST00902, made by Synthon Chemicals GmbH & Co. KG), 4-(6-acryloyloxy-n-hex-1-yloxy)-2-methylbenzoic acid (ST03606, made by Synthon Chemicals GmbH & Co. KG), 4-(6-methacryloyloxy-n-hex-1-yloxy)benzoic acid (ST01618, made by Synthon Chemicals GmbH & Co. KG) and 4-(10-acryloyloxy-n-dec-1-yloxy)benzoic acid (ST03604, made by Synthon Chemicals GmbH & Co. KG).

Specific preferred examples of the polymerizable compound having the phosphate group are described below, and may include a commercial item. Specific examples include 2-acryloyloxyethyl acid phosphate (Light Acrylate P-1A(N), made by Kyoeisha Chemical Co., Ltd.), 2-methacryloyloxyethyl acid phosphate (Light Ester P-1M, made by Kyoeisha Chemical Co., Ltd.), Light Ester P-2M, made by Kyoeisha Chemical Co., Ltd. and KAYAMER (registered trademark) PM-2, made by Nippon Kayaku Co., Ltd.

As an epoxy resin that can be used, various kinds of epoxy resins can be used. Specific examples include an epoxy resin derived from divalent phenols, such as a bisphenol A type epoxy resin, a bisphenol F type epoxy resin, a bisphenol S type epoxy resin, a bisphenol AD type epoxy resin, a resorcinol type epoxy resin, a hydroquinone type epoxy resin, a catechol type epoxy resin, a dihydroxynaphthalene type epoxy resin, a biphenyl type epoxy resin and a tetramethylbiphenyl type epoxy resin, an epoxy resin derived from trivalent or higher valent phenols, such as a phenol novolak type epoxy resin, a cresol novolak type epoxy resin, a triphenylmethane type epoxy resin, a tetraphenylethane type epoxy resin, a dicyclopentadiene-phenol-modified type epoxy resin, a phenol aralkyl type epoxy resin, a biphenyl aralkyl type epoxy resin, a naphthol novolak type epoxy resin, an naphthol aralkyl type epoxy resin, a naphthol-phenol co-condensed novolak type epoxy resin, a naphthol-cresol co-condensed novolak type epoxy resin, an aromatic hydrocarbon formaldehyde resin-modified phenol resin type epoxy resin and a biphenyl-modified novolak type epoxy resin, a tetrabromobisphenol A type epoxy resin, a brominated phenol novolak type epoxy resin, a polycarboxylate polyglycidyl ester, a polyol polyglycidyl ether, a fatty acid-based epoxy resin, an alicyclic epoxy resin, a glycidylamine type epoxy resin, a triphenolmethane type epoxy resin and a dihydroxybenzene type epoxy resin, but are not limited thereto. Moreover, the epoxy resins described above may be used alone or two or more kinds may be mixed.

Specific examples of epoxy-based compounds include alkyl monoglycidyl ether having 2 to 25 carbons (butyl glycidyl ether, 2-ethylhexyl glycidyl ether, decyl glycidyl ether, stearyl glycidyl ether), butanediol diglycidyl ether, 1,6-hexanediol diglycidyl ether, neopentyl glycol diglycidyl ether, dodecanediol diglycidyl ether, pentaethyl triol polyglycidyl ether, trimethylolpropane polyglycidyl ether, glycerol polyglycidyl ether, phenyl glycidyl ether, p-sec-butylphenyl glycidyl ether, p-tert-butylphenyl glycidyl ether, resorcinol glycidyl ether, allyl glycidyl ether, tetrafluoropropyl glycidyl ether, octafluoropropyl glycidyl ether, dodecafluoropentyl glycidyl ether, styrene oxide, 1,7-octadiene diepoxide, limonene diepoxide, limonene monooxide, α-pinene epoxide, β-pinene epoxide, cyclohexene epoxide, cyclooctene epoxide, vinylcyclohexane oxide, butoxy polyethylene glycol glycidyl ether, polyethylene glycol diglycidyl ether, 3,4-epoxycyclohexenylmethyl-3′,4′-epoxycyclohexene carboxylate, 3,4-epoxycyclohexenylethyl-3′,4′-epoxycyclohexene carboxylate, 1,2-epoxy-4-vinylcyclohexane, vinylcyclohexene dioxide, allylcyclohexene dioxide, 1-epoxyethyl-3,4-epoxycyclohexane, 3,4-epoxy-4-methylcyclohexyl-2-propyleneoxide, bis(3,4-epoxycyclohexyl)ether, bis(3,4-epoxycyclohexylmethyl)adipate, phthalic acid diglycidyl ester, terephthalic acid diglycidyl ester, hexahydrophthalic acid diglycidyl ester, tetrahydrophtalic acid diglycidyl ester, tris(2,3-epoxypropyl)isocyanurate, 3-ethyl-3-hydroxymethyloxetane, 3-ethyl-3-(phenoxymethyl)oxetane, di(1-ethyl(3-oxetanyl))methyl ether and 3-ethyl-3-(2-ethylhexyl methyl)oxetane.

Moreover, a compound having an acrylic functional group and an epoxy-based functional group can also be simultaneously used. Specific examples include (3-ethyloxetane-3-yl)methyl methacrylate, (3-ethyloxetane-3-yl)methyl acrylate, and as a commercial item, a compound selected from OXE-10 and OXE-30, made by Osaka Organic Chemical Industry Ltd.

Specific examples of the surfactant include a cationic surfactant, an anionic surfactant and a nonionic surfactant. An alignment defect can be suppressed by adding the surfactant.

Specific examples of the ionic surfactant include a titanate compound, imidazoline, a quaternary ammonium salt, alkylamine oxide, a polyamine derivative, a polyoxyethylene-polyoxypropylene condensate, polyethylene glycol and an ester thereof, sodium lauryl sulfate, ammonium lauryl sulfate, amines lauryl sulfate, alkyl-substituted aromatic sulfonate, alkyl phosphate, an aliphatic or aromatic sulfonic acid-formalin condensate, laurylamidopropyl betaine, laurylaminoacetic acid betaine, polyethylene glycol fatty acid esters, polyoxyethylene alkylamine, perfluoroalkyl sulfonate and perfluoroalkyl carboxylate.

Specific examples of kinds of the nonionic surfactants include vinyl-based, silicone-based, fluorine-based and hydrocarbon-based surfactants.

Specific examples of the vinyl-based nonionic surfactant include polyalkyl acrylate, polyalkyl methacrylate, polyalkyl vinyl ether, polybutadiene, polyolefin and polyvinyl ether.

Specific examples of the silicone-based nonionic surfactant include polydimethyl siloxane, polyphenyl siloxane, specially-modified siloxane, fluorine-modified siloxane and surface-treated siloxane.

Specific examples of the fluorine-based nonionic surfactant include a fluorine-based polymer. Specific examples include Ftergent M series (251, 212M, 215M and 250), F series (209F, 222F and 245F), G series (208G, 218GL and 240G), P-D series (212P, 220P, 228P, FTX-218 and DEX-18), oligomer series (710FL, 710FM, 710FS, 730FL and 730LM), reaction type oligomer series (601AD, 602AD and 650A), functional group-containing series (681 and 682), all made by Neos Company Limited, and Megafac series (F-251, F-281, F-410, F-430, F-444, F-477, F-552 to F-563, F-565, F-567 to F-571, R-40, R-41, R-43, R-94, RS-72-K, RS-75, RS-76-E, RS-76-NS and RS-90), all made by DIC Corporation.

Specific examples of the hydrocarbon-based nonionic surfactant include polyethylene, polypropylene, polyisobutylene, paraffin, liquid paraffin, chlorinated polypropylene, chlorinated paraffin and chlorinated liquid paraffin.

Specific examples include surfactants described in paragraphs 0196 to 0199 in JP 2011-246365 A, surfactants described in paragraph 0019 in JP 2009-242563 A, TEGO Flow 300, TEGO Flow 370 and TEGO Flow ZFS460 (made by Evonik Degussa GmbH), and surfactants described in paragraphs 0014 to 0016 in JP 2009-242563 A.

The surfactants may be used alone or in combination of two or more surfactants.

Above all, as the kind of the surfactants, the vinyl-based surfactant such as polyalkyl acrylate (acrylic polymer), polyalkyl methacrylate or the like being the nonionic surfactant is preferred due to a trend of a smaller influence on the twist alignment from a viewpoint of a lower degree of segregation on a surface of the coating film (without excessive localization) in comparison with the silicone-based or fluorine-based nonionic surfactant.

Specific examples of the surfactant containing as a main component such an acryl-based polymer or acryl (co)polymer include Polyflow series (No. 7, No. 50E, No. 50 EHF, No. 54N, No. 75, No. 77, No. 85, No. 85HF, No. 90, No. 90D-50, No. 95 and No. 99C), TEGO Flow series (300, 370 and ZFS460), BYK series (350, 352, 354, 355, 356, 358N, 361N, 381, 392, 394, 3441 and 3440).

Addition of the surfactants as described above minimizes an influence on the twist alignment to allow suppression of tilt alignment on a side of the air interface. Moreover, in order to optimize applicability onto the substrate, a surfactant classified as a (substrate) wetting agent may be simultaneously used within the range in which the twist alignment is not influenced. The wetting agent is effective in decreasing surface tension of the polymerizable liquid crystal solution and improving applicability to a coating substrate. Specific examples of such a wetting agent include Polyflow series (KL-100, KL-700 and LE-604), TEGO Twin series (4000) and TEGO Wet series (KL245, 250, 260, 265, 270, 280, 500, 505 and 510).

In addition, in order to cause integration with the polymerizable liquid crystal compound, the surfactant may have a polymerizable group. Specific examples of the polymerizable group to be introduced into the surfactant include an ultraviolet light reaction-type functional group and a thermally polymerizable functional group. From a viewpoint of reactivity with the polymerizable liquid crystal compound, the ultraviolet light reaction-type functional group is preferred.

In addition, as an auxiliary agent of the wetting agent, a surfactant containing as a main component a fluoride-modified polymer or a fluorine-modified acrylic polymer may be applied. Specific examples of such an agent include 3000 series (3277, 3700 and 3770), made by AFCONA Additives Co., Ltd.

Polyflow described above is a name of products sold by Kyoeisha Chemical Co., Ltd. BYK is a name of products sold by BYK-Chemie Japan K.K. TEGO is a name of products sold by Evonik Industries AG.

In order to optimize a rate of polymerization of the polymerizable liquid crystal composition constituting the infrared reflecting film according to the invention, a polymerization initiator described below may be used. When the polymerizable group of the polymerizable liquid crystal composition is radically polymerizable, the polymerization initiator that generates a radical may be mainly used. When a polymerizable liquid crystal compound having a fluorene moiety as the mesogen skeleton is mainly used, from a viewpoint of curability, a photopolymerization initiator having oxime ester may be applied.

Examples of the photopolymerization initiator having oxime ester are described. The photopolymerization initiator may include a commercial item. Specific examples include compounds No. 1 to No. 108 described in paragraphs 0032 to 0046 in JP 2011-132215 A, compounds described in JP 2004-534797 A, compounds described in WO 2009/147031 A, compounds described in JP 2000-80068 A, compounds having oxime ester moieties described in JP 2006-251374 A, compounds having oxime ester moieties described in JP 2009-286976 A and compounds having oxime ester moieties described in JP 2009-29929 A.

Preferred compounds among the compounds include NCI-930 or NCI-1919 (made by ADEKA Corporation), Irgacure OXE 01 or Irgacure OXE02 (made by BASF Japan Ltd.), and particularly from a viewpoint of less influence on the twist alignment, NCI-930 or Irgacure OXE 01 is preferably used. A preferred ratio of the photopolymerization initiator having oxime ester is approximately 0.001 to approximately 0.20 in terms of a weight ratio based on the total weight of the achiral polymerizable liquid crystal compound and the optically active compound. A further preferred ratio is approximately 0.005 to approximately 0.15 based thereon. A still preferred ratio is approximately 0.01 to approximately 0.10 based thereon.

In order to regulate a rate of polymerization of the polymerizable liquid crystal composition, a publicly known photoradical polymerization initiator different from the photopolymerization initiator having oxime ester described above may also be used. A preferred amount of addition of the publicly known photoradical polymerization initiator is approximately 0.0001 to approximately 0.20 in terms of a weight ratio based on the total weight of the achiral polymerizable liquid crystal compound and the optically active compound. A further preferred weight ratio is in the range of approximately 0.001 to approximately 0.15 based thereon. A still further preferred ratio is in the range of approximately 0.01 to approximately 0.15 based thereon.

Specific examples of the photoradical polymerization initiator include 2-hydroxy-2-methyl-1-phenylpropane-1-one (Darocur 1173), 1-hydroxycyclohexyl phenyl ketone, 2,2-dimethoxy-1,2-diphenylethane-1-one (Irgacure 651), 1-hydroxy-cyclohexyl phenyl ketone (Irgacure 184), Irgacure 127, Irgacure 500 (mixture of Irgacure 184 and benzophenone), Irgacure 2959, Irgacure 907, Irgacure 369, Irgacure 379, Irgacure 754, Irgacure 1300, Irgacure 819, Irgacure 1700, Irgacure 1800, Irgacure 1850, Irgacure 1870, Darocur 4265, Darocur MBF, Darocur TPO, Irgacure 784 and Irgacure 754. Both of Darocur and Irgacure described above are names of products sold by BASF Japan Ltd. A publicly known sensitizer (isopropylthioxanthone, diethylthioxanthone, ethyl-4-dimethylaminobenzoate (Darocur EDB), 2-ethylhexyl-4-dimethylaminobenzoate (Darocur EHA) or the like) may be added to the initiators. NCI-831 made by ADEKA Corporation may also be used.

As the photoradical polymerization initiator, the photoradical polymerization initiator described below can also be used.

The initiator include p-methoxyphenyl-2,4-bis(trichloromethyl)triazine, 2-(p-butoxystyryl)-5-trichloromethyl-1,3,4-oxadiazole, 9-phenylacridine, 9,10-benzphenazine, a benzophenone-Michler's ketone mixture, a hexaarylbiimidazole-mercaptobenzimidazole mixture, 1-(4-isopropylphenyl)-2-hydroxy-2-methylpropane-1-one, benzyl dimethyl ketal, 2-methyl-1-[4-(methylthio)phenyl]-2-morpholinopropane-1-one, a 2,4-diethylxanthone-methyl p-dimethylaminobenzoate mixture and a benzophenone-methyltriethanolamine mixture.

When a compound having a cationically polymerizable polymerization group such as an epoxy group is used as the polymerizable liquid crystal compound, in order to optimize the rate of polymerization of the cationically polymerizable compound having the epoxy group or the like, a publicly-known photocationic polymerization initiator may also be used. A preferred amount of addition of the photocationic polymerization initiator is approximately 0.0001 to approximately 0.1 in terms of a weight ratio based on the total weight of the cationic polymerization compound. A further preferred weight ratio is approximately 0.001 to approximately 0.07 based thereon.

Specific examples of the photopolymerization initiator is described below. Heating may be performed in a temperature range in which the liquid crystal phase is maintained during irradiation with light. To the polymerizable liquid crystal composition used in the invention, an ordinary photocationic polymerization initiator can be added and thus used. Specific examples of the photocationic polymerization initiator include a diaryliodonium salt (abbreviate as DAS hereinafter) and a triarylsulfonium salt (abbreviate as TAS hereinafter).

Specific examples of DAS described above include diphenyliodonium tetrafluoroborate, diphenyliodonium hexafluorophosphonate, diphenyliodonium hexafluoroarsenate, diphenyliodonium trifluoromethanesulfonate, diphenyliodonium trifluoroacetate, diphenyliodonium-p-toluenesulfonate, diphenyliodonium tetra(pentafluorophenyl)borate, 4-methoxyphenyl phenyliodonium tetrafluoroborate, 4-methoxyphenyl phenyliodonium hexafluorophosphonate, 4-methoxyphenyl phenyliodonium hexafluoroarsenate, 4-methoxyphenyl phenyliodonium trifluoromethanesulfonate, 4-methoxyphenyl phenyliodonium trifluoroacetate, 4-methoxyphenyl phenyliodonium-p-toluenesulfonate, 4-methoxyphenyl phenyliodonium diphenyliodonium tetra(pentafluorophenyl)borate, bis(4-t-butylphenyl)iodonium diphenyliodonium tetrafluoroborate, bis(4-t-butylphenyl)iodonium diphenyliodonium hexafluoroarsenate, bis(4-t-butylphenyl)iodonium diphenyliodonium trifluoromethanesulfonate, bis(4-t-butylphenyl)iodonium trifluoroacetate, bis(4-t-butylphenyl)iodonium-p-toluenesulfonate and bis(4-t-butylphenyl)iodonium diphenyliodonium tetra(pentafluorophenyl)borate.

In DAS, high sensitivity can also be achieved by adding the photosensitizer such as thioxanthone, phenothiazine, chlorothioxanthone, xanthone, anthracene, diphenylanthracene and rubrene.

Specific examples of TAS include triphenyl sulfonium tetrafluoroborate, triphenyl sulfonium hexafluorophosphonate, triphenyl sulfonium hexafluoroarsenate, triphenyl sulfonium trifluoromethanesulfonate, triphenyl sulfonium trifluoroacetate, triphenyl sulfonium-p-toluenesulfonate, triphenyl sulfonium tetra(pentafluorophenyl)borate, 4-methoxyphenyl diphenyl sulfonium tetrafluoroborate, 4-methoxyphenyl diphenyl sulfonium hexafluorophosphonate, 4-methoxyphenyl diphenyl sulfonium hexafluoroarsenate, 4-methoxyphenyl diphenyl sulfonium trifluoromethanesulfonate, 4-methoxyphenyl diphenyl sulfonium trifluoroacetate, 4-methoxyphenyl diphenyl sulfonium-p-toluenesulfonate, 4-methoxyphenyl diphenyl sulfonium triphenyl sulfonium tetra(pentafluorophenyl)borate, 4-phenylthiophenyl diphenyl sulfonium tetrafluoroborate, 4-phenylthiophenyl diphenyl sulfonium hexafluorophosphonate, 4-phenylthiophenyl diphenyl sulfonium hexafluoroarsenate, 4-phenylthiophenyl diphenyl sulfonium trifluoromethanesulfonate, 4-phenylthiophenyl diphenyl sulfonium-p-toluene sulfonate, and 4-phenylthiophenyl diphenyl sulfonium tetra(pentafluorophenyl)borate.

Specific examples of trade names of the photocationic polymerization initiator include CPI series (CPI-100P, 200K) made by San-Apro Ltd., Cyracure UVI-6990, Cyracure UVI-6974 and Cyracure UVI-6992 being a UCC product, Adeka Optomer SP series (SP-150, SP-170, SP-171, SP-056, SP-066, SP-130, SP-140, SP-082, SP-103, SP-601, SP-606 and SP-701), made by ADEKA Corporation, PHOTOINITIATOR 2074, made by Rhodia S.A., Irgacure 250, 270 and 290, made by BASF Japan Ltd., WPI series and WPAG series, made by Wako Pure Chemical Industries, Ltd., UV-9380C, made by GE Silicones, Inc., TPS series, TAZ series, DPI series, BPI series, MDS series, DTS series, SI series, PI series, NDI series, PAI series, NAI series, NI series, DAM series, MBZ series, PYR series, DNB series and NB series, made by Midori Kagaku Co., Ltd., and a number of products are sold.

When a salt is predicted to be generated to cause polymerization inhibition during simultaneous use of the radical polymerization initiator and a photo-acid generator, a change of the photo-acid generator to a photo-base generator is recommended. Specific examples of trade names of the photo-base generator include WPBG series (WPBG-018, WPBG-027, WPBG-082, WPBG-140, WPBG-165, WPBG-166, WPBG-167, WPBG-168, WPBG-172 and WPBG-266), made by Wako Pure Chemical Industries, Ltd.

The thermal polymerization initiator may be used in the invention. Specific examples of trade names include Adeka Opton series (CP-66), made by ADEKA Corporation, San-Aid (main agent) SI-60, SI-80, SI-100, SI-110, SI-145, SI-150, SI-160 and SI-180, and San-Aid (auxiliary agent) SI, made by Sanshin Chemical Industry Co., Ltd. The initiators may be simultaneously used with the photoradical initiator and the photocationic polymerization initiator, or with the photoradical initiator.

The infrared reflecting layer obtained in the invention is a thin film (thickness as described later), and when the radical polymerization is applied as a main reaction, the reaction tends to be susceptible to oxygen inhibition action (polymerization inhibition action) caused by oxygen in air. When the cationic polymerization is applied as the main reaction, the reaction tends to be susceptible to the polymerization suppression action caused by humidity in atmosphere. When a reflecting film having a uniform helical pitch in a thickness direction is formed, in order to minimize the polymerization inhibition action described above, rapid progress of the polymerization reaction is desired. For the purpose, a polymerization initiator having both a large optical absorption coefficient and quantum efficiency to generate a large amount of radicals or cationic species (anionic species) at one time is preferred. In order to satisfy both cure on a surface and in a deep part (near a support substrate interface), an amount of addition is preferably optimized as described above.

The photopolymerization initiator is desirably selected from initiators having an absorption maximal wavelength in the range of approximately 250 to approximately 400 nanometers (ultraviolet light region). Moreover, an absorption spectrum (entire absorption spectrum of a plurality of photopolymerization initiators) of the photopolymerization initiator is preferably selected so as to coincide with a radiation spectrum of a light source.

On the other hand, when a reflecting film having a nonuniform helical pitch in the thickness direction is formed, the polymerization reaction is preferably nonuniformized by minimization of the rate of polymerization and warming by suitable temperature.

Mechanical characteristics of the polymer can also be controlled by adding one kind or two or more kinds of chain transfer agents to the polymerizable liquid crystal composition. A length of a polymer chain or lengths of two crosslinked polymer chains in a polymer film can be controlled by using the chain transfer agent. The lengths can also be simultaneously controlled. When an amount of the chain transfer agent is increased, the length of the polymer chain decreases. Specific examples of preferred chain transfer agents include a thiol compound and a styrene dimer. Specific examples of monofunctional thiol include dodecanethiol, 2-ethylhexyl-(3-mercaptopropionate) and 2-ethylhexyl-(3-mercapto acetate). Specific examples of polyfunctional thiol include trimethylolpropanetris(3-mercaptopropionate), pentaerythritoltetrakis(3-mercaptopropionate), 1,4-bis(3-mercaptobutyryloxy)butane (Karenz MT BD1), pentaerythritoltetrakis(3-mercaptobutylate) (Karenz MT PE1) and 1,3,5-tris(3-mercaptobutyloxyethyl)-1,3,5-triazine-2,4,6(1H,3H,5H)-trione (Karenz MT NR1). “Karenz” is a trade name of products from Showa Denko K.K. Specific examples of thiol compounds other than the compounds described above include thiol compounds described in paragraphs 0042 to 0043 in WO 2013/080855 A and compounds described in 11^{th} line on p. 23 to 27^{th} line on p. 24 in WO 2008/077261 A. Specific examples of the styrene dimer include α-methylstyrenedimer (2,4-diphenyl-4-methyl-1-pentene) and 1,1-diphenylethylene. Moreover, Quinoexter QE-2014 can also be utilized. “Quinoexter” is a trade name of products from Kawasaki Kasei Chemicals Ltd.

A polymerization preventive agent can be added to the polymerizable liquid crystal composition in order to prevent start of polymerization during storage. A publicly known polymerization preventive agent can be used, and preferred examples thereof include 2,5-di(t-butyl)hydroxytoluene (BHT), hydroquinone, Methyl Blue, diphenylpicryl hydrazide (DPPH), benzothiazine, 4-nitrosodimethylaniline (NIDI) and o-hydroxybenzophenone.

A polymerization inhibitor can also be added in order to improve storage stability of the polymerizable liquid crystal composition. When a radical is generated within the composition or the solution of the composition, the polymerization reaction of the polymerizable compound is accelerated. The polymerization inhibitor is preferably added in order to prevent such a reaction. As the polymerization inhibitor, a phenolic antioxidant, a sulfur-based antioxidant, a phosphate-based antioxidant and a lactone-based antioxidant can be utilized.

In order to further improve weather resistance of the infrared reflecting film obtained by curing the polymerizable liquid crystal composition, an ultraviolet light absorber, a light stabilizer (radical scavenger), an antioxidant and so forth may be added. Specific examples of the ultraviolet light absorber include Tinuvin PS, Tinuvin P, Tinuvin 99-2, Tinuvin 109, Tinuvin 213, Tinuvin 234, Tinuvin 326, Tinuvin 328, Tinuvin 329, and Tinuvin 384-2, Tinuvin 571, Tinuvin 900, Tinuvin 928, Tinuvin 1130, Tinuvin 400, Tinuvin 405, Tinuvin 460, Tinuvin 479, Tinuvin 5236, and ADK STAB LA-32, ADK STAB LA-34, ADK STAB LA-36, ADK STAB LA-31, ADK STAB 1413 and ADK STAB LA-51. “Tinuvin” is a trade name of products from BASF Japan Ltd and “ADK STAB” is a trade name of products from ADEKA Corporation.

Specific examples of the light stabilizer include Tinuvin 111FDL, Tinuvin 123, Tinuvin 144, Tinuvin 152, Tinuvin 292, Tinuvin 622, Tinuvin 770, Tinuvin 765, Tinuvin 780, Tinuvin 905, Tinuvin 5100, Tinuvin 5050 and 5060, Tinuvin 5151, Chimassorb 119FL, Chimassorb 944FL, Chimassorb 944LD, and ADK STAB LA-52, ADK STAB LA-57, ADK STAB LA-62, ADK STAB LA-67, ADK STAB LA-63p, ADK STAB LA-68LD, ADK STAB LA-77, ADK STAB LA-82, ADK STAB LA-87, Cyasorb UV-3346 made by Cytec, Inc., Uvinul 4050H, Uvinul 4077H, Uvinul 4092H, Uvinul 5050H, Uvinul 5062H and GOODRITE UV-3034 by Goodrich Corporation. “Chimassorb” and “Uvinul” are trade names of products from BASF Japan Ltd.

Specific examples of the antioxidant include ADK STAB AO-20, AO-30, AO-40, AO-50, AO-60 and AO-80, as made by ADEKA Corporation, Sumilizer (registered trademark) BHT, Sumilizer BBM-S and Sumilizer GA-80 as sold by Sumitomo Chemical Co., Ltd., and Irganox 1076, Irganox 1010, Irganox 3114, and Irganox 245 as sold by BASF Japan Ltd. Commercial items may also be used. Alternatively, antioxidants described in paragraphs 0008 to 0014 in JP 2008/44989 A may also be used.

In order to control the adhesion properties with the substrate, a silane coupling agent may be further added to the polymerizable liquid crystal composition. Specific examples thereof include vinyltrialkoxysilane, 3-isocyanatepropyltriethoxysilane, N-(2-aminoethyl)3-aminopropyltrialkoxysilane, N-(1,3-dimethylbutylidene)-3-triethoxysilyl-1-propanamine, 3-glycidoxypropyltrialkoxysilane, 3-chlorotrialkoxysilane, 3-methacryloxypropyltrialkoxysilane and 3-methacryloxypropyltrialkoxysilane. Another example includes dialkoxymethylsilane in which one of alkoxy groups (three) is replaced to methyl in the compounds.

In order to increase crosslinking density during cure, a crosslinking agent may be further added to the polymerizable liquid crystal composition. The crosslinking agent includes such alkylols and alkoxies that cause an electrophilic substitution reaction to an aromatic ring. Specific examples of the alkylols include a polyfunctional alkanol aromatic compound such as 1,2-benzenedimethanol, 1,3-benzenedimethanol, 1,4-benzenedimethanol and 1,3,5-benzenetrimethanol, polyfunctional alkanol urea such as dimethylol urea, dimethylolethylene urea and dimethylolpropylene urea, a polyfunctional alkylalkanol compound such as trimethylolpropane and trimethylolpropane monoallyl ether, a polyfunctional alkanol melamine compound such as trimethylol melamine, triethylol melamine, hexamethylol melamine and hexaethylol melamine, and an alkanol benzoguanamine compound such as dimethylol benzoguanamine, trimethylol benzoguanamine and tetramethylol benzoguanamine. Specific examples of the alkoxies include 1,4-dimethoxymethylbenzene, 1,3,5-trimethoxymethylbenzene, 1,3,5-triazine-2,4,6-tri(dimethoxymethylamine), 1,3,5-triazine-2-methoxymethylamine-4,6-di(dimethoxymethylamine), 1,4-bis(methoxyphenoxy)benzene, trimethoxy methylmelamine, hexamethoxymethyl melamine, N,N′-dimethoxymethyl urea, N,N′-dimethoxymethyl-4,5-dimethoxy-2-imidazolidinone. As an amount of addition of such a crosslinking agent, the crosslinking agent can be added to the polymerizable liquid crystal composition generally in the range of approximately 1% by weight to approximately 50% by weight, and preferably, in the range of approximately 5% by weight to approximately 30% by weight.

The polymerizable liquid crystal composition may be occasionally directly applied onto the surface of the substrate. However, in order to facilitate application, the polymerizable liquid crystal composition is ordinarily diluted using a solvent, or each component of the polymerizable liquid crystal composition is dissolved into the solvent to prepare the solution of the polymerizable liquid crystal composition including the polymerizable liquid crystal composition and the solvent, and then the solution is applied. The solvent can be used alone or in combination of two or more kinds. Specific examples of the solvent include an ester solvent, an amide solvent, an alcohol solvent, an ether solvent, a glycol monoalkyl ether solvent, an aromatic hydrocarbon solvent, a halogenated aromatic hydrocarbon solvent, an aliphatic hydrocarbon solvent, a halogenated aliphatic hydrocarbon solvent, an alicyclic hydrocarbon solvent, a ketone solvent and an acetate solvent.

Preferred examples of the ester solvent include alkyl acetate (methyl acetate, ethyl acetate, propyl acetate, isopropyl acetate, butyl acetate, 3-methoxybutyl acetate, isobutyl acetate, pentyl acetate, cyclohexyl acetate and isopentyl acetate), ethyl trifluoroacetate, alkyl propionate (methyl propionate, methyl 3-methoxypropionate, ethyl propionate, propyl propionate and butyl propionate), alkyl butyrate (methyl butyrate, ethyl butylate, butyl butyrate, isobutyl butyrate and propyl butyrate), dialkyl malonate (diethyl malonate), alkyl glycolate (methyl glycolate and ethyl glycolate), alkyl lactate (methyl lactate, ethyl lactate, isopropyl lactate, n-propyl lactate, butyl lactate and ethylhexyl lactate), alkyl pyruvate (ethyl pyruvate), monoacetin, γ-butyrolactone and γ-valerolactone.

Preferred examples of the amide solvent include N-methyl-2-pyrrolidone, N,N-dimethylacetamide, N-methylpropionamide, N,N-dimethylformamide, N,N-diethylformamide, N,N-diethylacetamide, N,N-dimethylacetamide dimethyl acetal, N-methylcaprolactam and dimethylimidazolidinone.

Preferred examples of the alcohol solvent include methanol, ethanol, 1-propanol, 2-propanol, 1-methoxy-2-propanol, diacetone alcohol, t-butyl alcohol, sec-butyl alcohol, butanol, 2-ethylbutanol, n-hexanol, n-heptanol, n-octanol, 1-dodecanol, ethylhexanol, 3,5,5-trimethylhexanol, n-amyl alcohol, hexafluoro-2-propanol, glycerol, ethylene glycol, diethylene glycol, triethylene glycol, tetraethylene glycol, propylene glycol, dipropylene glycol, tripropylene glycol, hexylene glycol, 1,3-butanediol, 1,4-butanediol, 2,3-butanediol, 1,5-pentanediol, 2,4-pentanediol, 2,5-hexanediol, 3-methyl-3-methoxybutanol, cyclohexanol and methyl cyclohexanol.

Preferred examples of the ether solvent include ethylene glycol dimethyl ether, diethylene glycol dimethyl ether, diethylene glycol methyl ethyl ether, bis(2-propyl)ether, 1,3-dioxolane, 1,4-dioxane and tetrahydrofuran (THF).

Preferred examples of the glycol monoalkyl ether solvent include ethylene glycol monoalkyl ether (ethylene glycol monomethyl ether and ethylene glycol monobutyl ether), diethylene glycol monoalkyl ether (diethylene glycol monoethyl ether), triethylene glycol monoalkyl ether, propylene glycol monoalkyl ether (propylene glycol monomethyl ether and propylene glycol monobutyl ether), dipropylene glycol monoalkyl ether (dipropylene glycol monomethyl ether), ethylene glycol monoalkyl ether acetate (ethylene glycol monobutyl ether acetate), diethylene glycol monoalkyl ether acetate (diethylene glycol monoethyl ether acetate), triethylene glycol monoalkyl ether acetate, propylene glycol monoalkyl ether acetate (propylene glycol monoethyl ether acetate), propylene glycol monoethyl ether acetate, propylene glycol monobutyl ether acetate, dipropylene glycol monoalkyl ether acetate (dipropylene glycol monomethyl ether acetate) and diethylene glycol methyl ethyl ether.

Preferred examples of the aromatic hydrocarbon solvent include benzene, toluene, anisole, xylene, mesitylene, ethylbenzene, diethylbenzene, i-propylbenzene, n-propylbenzene, t-butylbenzene, s-butylbenzene, n-butylbenzene, a terpene derivative (p-cymene, 1,4-cineole, 1,8-cineole, D-limonene, D-limonene oxide, p-menthonaphtene, α-pinene, β-pinene, γ-terpinene and terpinoren) and tetralin. Preferred examples of the halogenated aromatic hydrocarbon solvent include chlorobenzene. Preferred examples of the aliphatic hydrocarbon solvent include hexane and heptane. Preferred examples of the halogenated aliphatic hydrocarbon solvent include chloroform, dichloromethane, carbon tetrachloride, dichloroethane, trichloroethylene and tetrachloroethylene. Preferred examples of the alicyclic hydrocarbon solvent include cyclohexane, methylcyclohexane and decalin.

Preferred examples of the ketone solvent include acetone, methyl ethyl ketone, methyl isobutyl ketone, 2-heptanone, cyclohexanone, cyclopentanone and methyl propyl ketone.

Preferred examples of the acetate solvent include ethylene glycol monomethyl ether acetate, propylene glycol monoethyl ether acetate, propylene glycol monoethyl ether acetate, methyl acetoacetate and 1-methoxy-2-propyl acetate.

From a viewpoint of solubility of the polymerizable liquid crystal compound, use of the amide solvent, the aromatic hydrocarbon or the ketone solvent is preferred, and when a boiling point of the solvent is taken into consideration, simultaneous use of the ester solvent, the alcohol solvent, the ether solvent and the glycol monoalkyl ether solvent is also preferred. Selection of the solvent is not particularly restricted, but when the plastic substrate is used as the support substrate, drying temperature is required to be decreased for preventing substrate deformation, and the solvent is required to cause no substrate erosion. Preferred examples of the solvent used in such a case include an aromatic hydrocarbon solvent, a ketone solvent, an ester solvent, an ether solvent, an alcohol solvent, an acetate solvent and a glycol monoalkyl ether solvent.

A ratio of the solvent in the solution of the polymerizable liquid crystal composition is in the range of approximately 50 to approximately 95% based on the total weight of the solution. A lower limit of the range is set to a numerical value in consideration of the solubility of the polymerizable liquid crystal compound and optimum viscosity upon application of the solution. Then, an upper limit thereof is set to a numerical value in consideration of an economic viewpoint such as solvent cost, and time and an amount of heat upon evaporating the solvent. A preferred ratio thereof is in the range of approximately 60 to approximately 90%, and further preferably, in the range of approximately 70 to approximately 85%.

In the description below, the polymer (optically anisotropic substance) obtained by polymerizing the polymerizable liquid crystal composition is referred to as the infrared reflecting film. The infrared reflecting film can be obtained in a manner described below. First, the solution of the polymerizable liquid crystal composition is applied onto the support substrate, and the resulting applied material is dried to form the coating film. The coating film is heated or irradiated with light to polymerize the polymerizable liquid crystal composition and to immobilize (cure) nematic alignment formed by the liquid crystal composition in the coating film in the liquid crystal state.

The support substrate that can be used only needs to be transparent and specifically, includes glass and a plastic film. Specific examples of the plastic film include a film of polyimide, polyamide-imide, polyamide, polyetherimide, polyether ether ketone, polyether ketone, polyketone sulfide, polyethersulfone, polysulfone, polyphenylene sulfide, polyphenylene oxide, polyethylene terephthalate, polybutylene terephthalate, polyethylene naphthalate, polyacetal, polycarbonate, polyarylate, an acrylic resin, polyvinyl alcohol, polypropylene, cellulose, triacetyl cellulose or a partially saponified product thereof, an epoxy resin, a phenolic resin or a cycloolefin resin. The resin described above may be used alone or in combination thereof.

Specific examples of the cycloolefin resin include a norbornene resin and a dicyclopentadiene resin, but are not limited thereto. Among the resins, a resin having no unsaturated bond or a resin in which an unsaturated bond is hydrogenated is suitably used. Specific examples include a hydrogenated product of a ring-opened (co)polymer of one kind or two or more kinds of norbornene monomers, an addition (co)polymer of one kind or two or more kinds of norbornene monomers, an addition copolymer of a norbornene monomer and an olefin monomer (ethylene, α-olefin), an addition copolymer of a norbornene monomer and a cycloolefin monomer (cyclopentene, cyclooctene, 5,6-dihydrodicyclopentadiene) and a modified product thereof. Specific examples include ZEONEX, ZEONOR (made by Zeon Corporation), ARTON (made by JSR Corporation), TOPAS (made by Ticona GmbH), APEL (made by Mitsui Chemicals, Inc.), S-SINA (made by Sekisui Chemical Co., Ltd.) and OPTOREZ (made by Hitachi Chemical Co., Ltd.).

The plastic films may include a uniaxially stretched film or a biaxially stretched film. The plastic films may be subjected to surface treatment such as hydrophilization treatment including corona treatment or plasma treatment, or hydrophobization treatment. A method for applying the hydrophilization treatment is not particularly restricted, but corona treatment or plasma treatment is preferred, and a particularly preferred method is plasma treatment. For the plasma treatment, a method described in JP 2002-226616 A, JP 2002-121648 A or the like may be applied. Moreover, an anchor coat layer may be formed for improving the adhesion properties between a liquid crystal film and the plastic film. Such an anchor coat layer may be formed of any of an inorganic material or an organic material without any problem, as long as the material improves the adhesion properties between the liquid crystal film and the plastic film. Moreover, the plastic film may include a laminated film.

Prior to forming the coating film of the polymerizable liquid crystal composition, in order to stabilize the alignment of the liquid crystal, mechanical or physical surface treatment by rubbing treatment, photoalignment treatment or the like may be applied onto the support substrate such as the glass and the plastic film. For example, in the case where the stretched film of the plastic film made from the polyester resin such as the polyethylene terephthalate resin is utilized, the liquid crystal tends to align in a stretching direction, and therefore can be directly used, and thus such a case is preferred. In order to further uniformize the alignment, the rubbing treatment may be directly applied on the film. When the glass is used, the alignment film made from polyimide or polyvinyl alcohol (PVA) film or a photoalignment film is formed, and rubbing treatment or photoalignment treatment by polarized light exposure is applied, and thus alignment characteristics can be provided.

An arbitrary method can be employed for the rubbing treatment, but a method is ordinarily employed by winding around a metallic roll or the like a rubbing fabric formed of a raw material such as rayon, cotton and polyamide to move the roll while the roll is rotated in a state in contact with a support substrate or a polymer coat, or by moving a support substrate side while the roll is fixed. The rubbing treatment may be directly applied to the support substrate, or the polymer coat is arranged beforehand on the support substrate, and then the rubbing treatment may be applied to the polymer coat. The method of the rubbing treatment is as described above. Depending on a kind of the support substrate, silicon oxide is obliquely vapor-deposited on a surface of the substrate to allow provision of alignment ability on the surface thereof. When the photoalignment film is used, the alignment ability can be provided by irradiating the film with polarized ultraviolet light.

Upon application of the polymerizable liquid crystal composition or the solution thereof, specific examples of an application method for obtaining uniform thickness include a spin coating method, a micro gravure coating method, a gravure coating method, a wire bar coating method, a dip coating method, a spray coating method, a meniscus coating method and a die coating method. In particular, the wire bar coating method or the like in which shear stress is applied to the polymerizable liquid crystal composition during application may be applied in controlling alignment of the polymerizable liquid crystal composition without applying the surface treatment onto the substrate by rubbing or the like.

Upon application of the solution of the polymerizable liquid crystal composition according to the invention, the solvent is removed after the application to allow formation of a polymerizable liquid crystal layer, namely, a polymerizable liquid crystal composition layer having uniform thickness on the support substrate. Conditions for solvent removal are not particularly limited. Drying only needs to be performed until the solvent is substantially removed and flowability of the coating film of the polymerizable liquid crystal composition is lost. The solvent can be removed by applying air drying at room temperature, drying on a hot plate, drying in a drying furnace, blowing of warm air or hot air or the like. Depending on a kind and a composition ratio of the compounds used for the polymerizable liquid crystal composition, the nematic alignment of the polymerizable liquid crystal composition in the coating film is completed in a process of drying of the coating film in several cases. Therefore, the coating film through a drying step can be provided for a polymerization step without passing through a heat treatment step to be described later.

A preferred range of temperature and time upon applying heat treatment to the coating film, a wavelength of light used for irradiation with light, an amount of light to be irradiated from a light source, or the like is different depending on a kind and a composition ratio of the compounds used for the polymerizable liquid crystal composition, presence or absence of addition of the photopolymerization initiator, an amount of addition thereof, or the like. Therefore, conditions of the temperature and the time of heat treatment of the coating film, the wavelength of light used for irradiation with light, and the amount of light to be irradiated from the light source described below represent only an approximate range.

The heat treatment of the coating film is preferably applied on conditions under which the solvent is removed and uniform alignment properties of the polymerizable liquid crystal are obtained, and is also applied at temperature equal to or higher than a transition temperature of liquid crystal phases of the polymerizable liquid crystal composition. One example of the method of heat treatment includes a method of warming the coating film to temperature at which the polymerizable liquid crystal compound exhibits a nematic liquid crystal phase to allow formation of the nematic alignment in the polymerizable liquid crystal compound in the coating film. The nematic alignment may be formed by changing the temperatures of the coating film within a temperature range in which the polymerizable liquid crystal compound exhibits the nematic liquid crystal phase. The above method includes a method of warming the coating film to a high temperature region in the temperature range described above to almost compete the nematic alignment in the coating film, and subsequently to form further ordered alignment by decreasing the temperature. Even when any one of the heat treatment methods described above is applied, the heat treatment temperature is in the range of approximately room temperature (25° C.) to approximately 150° C. A preferred temperature range is approximately room temperature (25° C.) to approximately 130° C., a further preferred range is approximately room temperature (25° C.) to approximately 110° C., and a still further preferred range is approximately room temperature (25° C.) to approximately 100° C. Heat treatment time is in the range of approximately 5 seconds to approximately 2 hours. A preferred range of the time is approximately 10 seconds to approximately 40 minutes, and a further preferred range is approximately 20 seconds to approximately 20 minutes. In order to increase the temperature of the layer formed of the polymerizable liquid crystal composition to a desired temperature, the heat treatment time is preferably adjusted to approximately 5 seconds or more. In order to avoid a decrease in productivity, the heat treatment time is preferably adjusted within approximately 2 hours. Thus, the polymerizable liquid crystal layer in which the twist alignment is formed is obtained.

A nematic alignment state of the polymerizable liquid crystal compound as formed in the polymerizable liquid crystal layer is immobilized by polymerizing the polymerizable liquid crystal compound by irradiation with light or heating. In the invention, polymerization by irradiation with light is preferred.

A wavelength of light used for irradiation with light is not particularly limited, and is preferably coincided with the absorption maximal wavelength of the photopolymerization initiator as much as possible. Electron beams, ultraviolet light, visible light, infrared light (heat rays) or the like can be used. Ultraviolet light or visible light is ordinarily sufficiently used. A range of the wavelength is approximately 150 to approximately 500 nanometers. A preferred range is approximately 250 to approximately 450 nanometers, and a further preferred range is approximately 250 to approximately 400 nanometers. Specific examples of the light sources include a low-pressure mercury lamp (a germicidal lamp, a fluorescent chemical lamp or a black light), a high-pressure discharge lamp (a high-pressure mercury lamp or a metal halide lamp) and a short arc discharge lamp (an super-high pressure mercury lamp, a xenon lamp or a mercury-xenon lamp). Preferred examples of the light sources include a metal halide lamp, a xenon lamp, an super-high pressure mercury lamp and a high-pressure mercury lamp. A wavelength region of the light source for irradiation may be selected by installing a filter or the like between the light source and the polymerizable liquid crystal layer to pass light only in a specific wavelength region through the layer.

An amount of light to be irradiated from the light source is approximately 2 to approximately 5,000 mJ/cm² at arriving at a coating film plane. A preferred range of the amount of light is approximately 10 to approximately 3,000 mJ/cm², and a further preferred range is approximately 100 to approximately 2,000 mJ/cm². When the helical pitch is uniformly formed, a range of irradiance is approximately 1.0 mW to approximately 100 mW/cm². A further preferred range is approximately 3.0 mW to approximately 100 mW/cm². When the helical pitch is nonuniformly formed as described below, a range of irradiance is approximately 0.01 to approximately 100 mW/cm², a preferred range is approximately 0.05 to approximately 10 mW/cm², and a further preferred range is approximately 0.01 to approximately 1.0 mW/cm². Temperature conditions during irradiation with light are preferably set up in a manner similar to the conditions of the heat treatment temperature described above. Moreover, an atmosphere of a polymerization environment may include any of a nitrogen atmosphere, an inert gas atmosphere and an air atmosphere, but a nitrogen atmosphere or an inert gas atmosphere is preferred from a viewpoint of improving curability.

When the cationically polymerizable liquid crystal compound is used for the polymerizable liquid crystal composition, polymerization by heating is also preferably adopted. Specific effect conditions when polymerization is performed by heating is not particularly limited, and although the conditions are different depending on the polymerization initiator to be used, a range of temperature is ordinarily approximately 40 to approximately 180° C., and a preferred range is approximately 50 to approximately 160° C. A range of heating time is ordinarily approximately 1 to approximately 120 minutes, and a preferred range is approximately 3 to approximately 60 minutes.

When the characteristics of the infrared reflecting film obtained by polymerizing the polymerizable liquid crystal layer using light, heat or the like according to the invention is controlled, control of the helical pitch in the thickness direction and control of uniformity of the twist alignment become important. The control of the helical pitch in the thickness direction herein refers to achievement of uniformity or nonuniformity (gradient formation) of a direction of rotation of a helix, or the helical pitch in the thickness direction. Uniformity of the twist alignment refers to expression of planer molecular arrangement in the twist alignment, and arrangement of the liquid crystal molecules such that the helical axis of the liquid crystal becomes perpendicular to the substrate plane. In such alignment, the tilt angle of the liquid crystal molecules on the side of the air interface is required to be horizontal to the substrate plane, and addition of the nonionic surfactant to the polymerizable liquid crystal composition according to the invention facilitates the planer arrangement.

The control of the direction of the rotation of the helix in the thickness direction is made on chirality of the optically active compound to be utilized in the polymerizable liquid crystal composition. The chirality has dextrorotation and levorotation, and if either alone is used, helical structure in agreement with the direction of rotation is formed.

A method for controlling the helical pitch in the thickness direction mainly includes two methods.

A first method is to uniformize the helical pitch in the thickness direction. According to the method, film formation is achieved by optimizing film-forming conditions so as to form the planar arrangement, and therefore a manufacturing process may be simplified. However, the reflection band of infrared light depends on the birefringence (Δn) of the polymerizable liquid crystal compound, and therefore significant extension of the reflection band is not easy. When the technique is applied, a method is applied in which a desired reflection band is obtained by laminating an infrared reflecting film in which an amount of addition (difference in a reflection wavelength) of the optically active compound having a direction identical with the direction of rotation of the helix is changed. A reflection wavelength can be ordinarily shortened by increasing the amount of addition of the optically active compound, and the reflection wavelength can be ordinarily lengthened by decreasing the amount of addition thereof. Moreover, the reflection wavelength can be controlled by twisting power of the optically active compound. For example, the reflection wavelength can be shortened by using the optically active compound having biphenyl or phenyl structure and having strong twisting power.

A thickness of the infrared reflecting film is not particularly limited, as long as the thickness is within the range in which a function of selectively reflecting near-infrared light in a predetermined wavelength region. The thickness is appropriately determined based on a kind of the polymerizable liquid crystal composition or the like to be used in the invention, but the thickness is preferably in the range of approximately 1.5 micrometers to 50 micrometers, further preferably, in the range of approximately 2 micrometers to 40 micrometers, and particularly preferably, in the range of approximately 3 micrometers to 30 micrometers. Moreover, the thickness of the infrared reflecting film is ordinarily formed such that the helical pitch has one pitch or more, and preferably, five pitches or more. The specific number of helical pitches can be calculated by a desired thickness of the infrared reflecting film.

The helical pitch herein refers a predetermined cycle (pitch) at which twist alignment (cholesteric structure) formed by the polymerizable liquid crystal compound forms multilayer structure in the normal direction on the transparent substrate surface. One pitch means a length of an axis while the polymerizable liquid crystal compound rotates by 360 degrees in drawing helical structure. Repeated layer structure is formed in practice for each rotation by 180 degrees, and therefore an interlayer pitch becomes one half of the helical pitch of the polymerizable liquid crystal compound. For example, when the interlayer pitch that can be observed upon observation of a cross section is 500 nanometers, the pitch of a rod-like compound becomes 1,000 nanometers.

The infrared reflecting film is preferably formed into a laminated film including two or more layers of infrared reflecting films having different selective reflection bands obtained by such a method. The number of layers in the laminated film is, although the number depends on a width of a desired reflection band and economic efficiency, ordinarily approximately 2 to approximately 9 layers, and preferably, approximately 2 to approximately 6 layers.

A second method is to nonuniformize the helical pitch in the thickness direction. Specific methods may be used as a reference, such as a method for changing light energy during exposure along a thickness direction by adding a component that absorbs ultraviolet light into a polymerizable liquid crystal composition between two transparent support substrates (JP H06-281814 A, JP 2004-264322 A) or a method for changing a helical pitch along a thickness direction by allowing exposure with low illuminance to a polymerizable liquid crystal composition formed between two transparent support substrates (JP 2019-42764 A), but such a method becomes further complicated as the manufacturing process in comparison with the method described above. However, a desired wavelength region can be obtained by formation of one layer.

Specific examples of the method for manufacturing the infrared reflecting film by exposure with low illuminance include a method described below. First, a polymerizable liquid crystal composition is applied onto a substrate. Subsequently, the resulting applied substrate is exposed with an irradiance of approximately 0.05 to approximately 0.50 mW/cm² (preferably, approximately 0.10 to approximately 0.30 mW/cm²) for approximately 10 to approximately 200 seconds (preferably, approximately 50 to approximately 150 seconds) (step of exposure with low illuminance). Further, operations in the step of exposure with low illuminanace are repeated 2 to 4 times (preferably, 2 to 3 times). Further, the resulting material is exposed with an irradiance of approximately 5 to approximately 30 mW/cm² (preferably, approximately 10 to approximately 25 mW/cm²) for approximately 10 to 200 seconds (preferably, approximately 50 to approximately 150 seconds) to obtain an infrared reflecting film.

When the exposure with low illuminance is performed, from a viewpoint of thick film formation, 1,3-dioxolane, cyclopentanone, cyclohexanone or the like is preferably used as a solvent.

Infrared light in the invention indicates a wavelength of near-infrared light (wavelength: approximately 750 to approximately 2,500 nanometers) in a region in which the wavelength is longer than 750 nanometers, and light having a wavelength in the range of approximately 750 nanometers to approximately 1,400 nanometers (preferably, approximately 750 to approximately 1,350 nanometers) is preferably reflected. In order to widely reflect the light having the wavelength in the range described above, specific methods described below are described.

When the layer is constituted of only a material having one direction as the direction of rotation of the helical pitch in the thickness direction, an aspect in combination with a ½λ, wavelength plate having action of reversing a direction of rotation of circularly polarized light is preferred, more specifically, the infrared reflecting film having the direction identical with the direction of rotation of the helical pitch in the thickness direction is preferably laminated onto both side of the ½λ, wavelength plate. Specific examples include a method for interposing a ½λ, wavelength plate with an infrared reflecting film having right-handed circularly polarized light performance or a method for interposing a ½λ, wavelength plate with an infrared reflecting film having left-handed circularly polarized light performance.

When the layer is constituted using two kinds of materials having different directions of rotation of the helical pitch in the thickness direction, specific methods include a method for, on a support substrate, laminating an infrared reflecting film having right-handed circularly polarized light performance on an infrared reflecting film having left-handed circularly polarized light performance directly or through an alignment film or a method for laminating an infrared reflecting film having left-handed circularly polarized light performance on an infrared reflecting film having right-handed circularly polarized light performance directly or through an alignment film.

An adhesive layer may be formed between a plurality of selective reflection layers consisting the infrared reflecting layer. As a material used for the adhesive layer include a hydrophilic adhesive such as polyvinyl alcohol and polyvinylpyrolidone, an acryl-based pressure sensitive adhesive, a urethane-based pressure sensitive adhesive or an epoxy-based pressure sensitive adhesive can be preferably used.

The ½λ, wavelength plate herein requires, when characteristics are matched with the infrared light wavelength described above, a comparatively larger phase difference in comparison with an ordinary optical film. Specific examples of the optical film to be used in the case, as described in JP 2011-137850 A, a stretched film formed of a general-purpose resin such as a polycarbonate resin, a poly(meth)acrylate resin such as polymethylmethacrylate, a polystyrene resin such as polystylene and a styrene copolymer obtained by copolymerizing styrene with any other monomer, a polyacrylonitrile resin, a polyester resin such as polyethylene terephthalate, polybutylene terephthalate, polyethylene naphthalate, a polyamide-based resin such as nylon 6, nylon 6,6, and a polyolefin-based resin such as polyethylene and polypropylene. Among the resins, from a viewpoint of availability, manufacture cost and magnitude of mean retardation, a stretched film formed of a polyester resin can be preferably used. For example, the mean retardation of biaxially oriented film formed of polyethylene terephthalate is approximately 5,000 nanometers in a film thickness of approximately 200 micrometers, and approximately 3,000 nanometers in a film thickness of approximately 120 micrometers.

A method for uniformizing the helical pitches in the thickness direction otherwise than the method described above includes a method for adjusting a kind, a composition ratio or the like of the liquid crystal compounds used for the polymerizable liquid crystal composition. The uniformity of the twist alignment may occasionally be influenced also by adding any other component to the polymerizable liquid crystal compound. The uniformity of the twist alignment can be controlled also by a kind, rubbing conditions or photoalignment treatment of the support substrate or the alignment film, or by drying conditions or heat treatment conditions or the like of the coating film of the polymerizable liquid crystal composition. Further, an irradiation atmosphere, temperature or the like during irradiation in a photopolymerization step after the twist alignment is achieved influences the uniformity of the twist alignment.

In the twist alignment, the tilt angles of the liquid crystal molecules are uniformly close to 0 degrees from a substrate interface to a free interface, and are distributed particularly in the range of 0 to 5 degrees. Such an alignment state is easily obtained by applying onto a support substrate surface having alignment ability the polymerizable liquid crystal composition in which the nonionic surfactant is added.

A ratio of component (A) to component (F) to be used in the description below is as described above. In order to obtain uniform twist alignment in the invention, preferred examples of formula (1) being component (A) include formulas (1-1-A) and (1-1-C), and further preferred examples include formula (1-1-A). Use of a compound in which n¹¹ is 3 to 6 and X¹ is hydrogen in formula (1-1-A) is preferred. In addition, a plurality of compounds represented by formula (1) may be combined and used.

Moreover, from a viewpoint of securing the adhesion properties with the support substrate and suppressing yellowing, P¹ is preferably a cationically polymerizable substituent being any one of formulas (P-8) to (P-18). The compound (1) having the cationically polymerizable substituent is preferably contained in an amount of approximately 0.1% by weight to approximately 70% by weight based on the total weight of the polymerizable liquid crystal compound and the optically active compound, and further preferably, approximately 0.3% by weight to approximately 60% by weight based thereon.

Preferred examples of formula (2) being component (B) include formula (2-2-A), formula (2-2-B), formula (2-2-J), formula (2-2-M) and formula (2-2-P), and use of a compound in which n²² is 3 to 6, Q¹ is hydrogen and Q² is ethyl is preferred. In addition, a plurality of compounds represented by formula (2) may be combined and used.

From a viewpoint of the adhesion properties, at least one of hydrogen in R¹ may be replaced by the cationically polymerizable substituent represented by any one of formulas (P-8) to (P-18). When the compound represented by formula (2) and having the cationically polymerizable substituent, the compound is preferably contained in an amount of approximately 0.1% by weight or more and approximately 5% by weight or less based on the total weight of the polymerizable liquid crystal compound and the optically active compound, and further preferably, approximately 0.3% by weight or more and approximately 5% by weight or less based thereon.

As the photopolymerization initiator being component (C), NCI-930 or Irgacure OXE 01 being the photopolymerization initiator having oxime ester is preferred.

Formula (3) being component (D) is not always required. However, in the case of use for adjusting Δn, or the like, use of formula (3-1) allows an increase in Δn, and use of formula (3-2) allows a decrease in Δn. Use of a compound in which n is 3 to 6 and X³¹ is hydrogen in formula (3-1-A) is preferred. Use of a compound in which n is 3 to 6 and X³² is hydrogen in formula (3-2-C) is preferred. In addition, a plurality of compounds represented by formula (3) may be combined and used.

Formula (4) being component (E) is not always required, but may be occasionally used in the case of adjusting the planar arrangement or the like. Use of formula (4-C) or formula (4-O) to formula (4-S) allows reduction of a decrease in Δn to obtain uniformly aligned twist alignment. When formula (4-E) to formula (4-L) each having a substituent having two or more carbons on a site lateral to a mesogen skeleton are used, the melting point can be easily adjusted. Preferred n⁴¹ is 3 to 6 and preferred X⁴ is hydrogen. In addition, a plurality of compounds represented by formula (4) may be combined and used.

Formula (5) being component (F) is not always required, but may be occasionally used in the case of adjusting the melting point or the like. Use of formula (5-1-A) to formula (5-1-B), formula (5-1-E) to formula (5-1-F), formula (5-1-I) to formula (5-1-J), formula (5-1-M) to formula (5-1-N) or formula (5-1-Q) to formula (51-1-R) each having biphenyl structure allows reduction of a decrease in Δn to obtain uniformly aligned twist alignment. A case of significantly adjusting the melting point only needs use of formula (5-1-C) to formula (5-1-D), formula (5-1-G) to formula (5-1-H), formula (5-1-K) to formula (5-1-L) or formula (5-1-O) to formula (5-1-P).

In formula (5), n⁵¹ is preferably 3 to 6, X⁵¹ is preferably hydrogen, W⁵¹ is preferably hydrogen or fluorine, and R⁵¹ is preferably straight-chain alkyl having 1 to 10 carbons, straight-chain alkoxy having 1 to 10 carbons or straight-chain alkyl ester having 1 to 10 carbons. In addition, a plurality of compounds represented by formula (5) may be combined and used.

Formula (6) being component (G) is not always required, but formula (6) is cationically polymerizable, and therefore the cure shrinkage is small, and the adhesion properties with the support substrate can be provided. A rate of polymerization in the cationic polymerization is lower in comparison with the radical polymerization, and therefore contribution to achievement of nonuniformity of the helical pitches can also be assumed.

Formula (7) being component (H) is not always required, but can be used for adjusting the melting point. Moreover, in a manner similar to component (G), the cure shrinkage is small, and therefore the adhesion properties with the support substrate can be provided. Moreover, formula (7) is cationically polymerizable, and therefore a rate of polymerization is lower in comparison with the radical polymerization, and therefore contribution to achievement of nonuniformity of the helical pitches can also be assumed.

To the polymerizable liquid crystal composition according to the invention, a liquid crystal compound having no polymerizable group may be added. Specific examples of such a non-polymerizable liquid crystal compound is described in LiqCryst (LCI Publisher GmbH, Hamburg, Germany) being a database of the liquid crystal compounds, or the like. Specific examples of the liquid crystal compound having no polymerizable group are described, for example, in JP 2011-148762 A, pp. 66 to 69. The polymerizable liquid crystal composition according to the invention has good compatibility with other liquid crystal compounds. To such a polymerizable liquid crystal composition, an additive such as a dichroic dye and a fluorescent dye may be further added. Composite materials with the liquid crystal compound having no polymerizable group can be obtained by polymerizing the above polymerizable liquid crystal composition.

To the polymerizable liquid crystal composition according to the invention, an optically active compound other than compound (2) may be added. Specific example of the optically active compounds are described in paragraph 0161 to paragraph 0170 in JP 2011-148762 A. The number of the optically active compounds to be added may be one, but a plurality of the optically active compounds may be used for the purpose of offsetting temperature dependence of the helical pitch. Control of the helical pitch into the region of the infrared light wavelength can be achieved by use of an optically active compound having small helical twisting power or reduction of an amount of addition of the optically active compound. Specific examples of commercial items include LC-756 made by BASF A.G. and CNL-715 and CNL-716 made by ADEKA Corporation.

If the optically active compound described above can induce the helical structure and can be suitably mixed with the polymerizable liquid crystal composition serving as a base, any of the optically active compound may be used. Moreover, the optically active compound may be polymerizable or non-polymerizable, and an optimum compound can be added thereto according to a purpose. The polymerizable compound is further preferred when heat resistance and solvent resistance are taken into consideration.

Selective reflection of the infrared reflecting film being the characteristics of the optically anisotropic substance having twist alignment refers to action of the helical structure onto incident light to reflect circularly polarized light or elliptically polarized light. Selective reflection characteristics are expressed by an equation: λ=n*Pitch (in which λ is a center wavelength of selective reflection, n is an average refractive index and Pitch means a helical pitch), and therefore the center wavelength (λ) and a wavelength width (Δλ) can be appropriately adjusted by changing values of n or Pitch. A case of desiring reflection in a broad band only needs an increase in the wavelength width (Δλ) (increase in birefringence Δn)). A thickness of the selective reflection layer constituting the infrared reflecting layer is not particularly limited, and the thickness is as described above when an infrared reflecting film having uniform helical pitches in the thickness direction is used.

When an infrared reflecting film having nonuniform helical pitches in the thickness direction is used, although a level depends on the reflection wavelength and the reflection wavelength band, a thickness is preferably from approximately 5 micrometers to approximately 50 micrometers, and further preferably, from approximately 5 micrometers to approximately 30 micrometers. When the bandwidth is 300 nanometers or more, the thickness is further preferably from approximately 10 micrometers to approximately 20 micrometers.

A preferred haze value of the infrared reflecting layer is approximately 4% or less, and a preferred transmittance is approximately 75% or more. A further preferred haze value is approximately 3% or less, and a further preferred transmittance is approximately 80% or more. A still further preferred haze value is approximately 2% or less, and a still further preferred transmittance is approximately 90% or more. The transmittance preferably meets the conditions in a visible light region.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

The invention will be described in detail by way of Examples below, but the invention is not limited to the Examples. Evaluation methods in Examples are presented below.

### Polymerization Conditions

A 250 W super-high pressure mercury lamp was used at room temperature in air. An integrated amount of ultraviolet light was calculated based on intensity at 365 nanometers.

### Evaluation of Twist Alignment

(1) Preparation of a Glass Substrate with a Rubbing-Treated Alignment Film

Onto a 1.1 mm-thick glass substrate, polyamic acid for a low pretilt angle (horizontal alignment mode) (Lixon Aligner: PIA-5370, made by JNC Corporation) was spin coated, a solvent was dried on a hot plate at 80° C., and the resultant material was calcinated at 230° C. for 30 minutes. Then, rubbing treatment was applied using a rayon fabric.

### (2) Confirmation of Uniformity of Twist Alignment

A substrate with a cured film of a polymerizable liquid crystal compound was interposed between two polarizing plates arranged in a crossed Nicol state, and presence or absence of light leakage (a little light transmission) through the cured film in a dark field state was observed. The light leakage is observed when a defect is produced in twist alignment (planar arrangement). When no light leakage was observed, the alignment was judged to be uniform.

### (3) Confirmation of Spectral Characteristics of Infrared Reflecting Film

A substrate with a cured film of a polymerizable liquid crystal compound was evaluated using an ultraviolet visible near-infrared spectrophotometer (V670 made by JASCO Corporation). A band of a selective reflection wavelength was represented by a wavelength width of transmittance placed in a middle of a maximum transmittance and a minimum transmittance. The center wavelength of selective reflection was taken as a center value of the bandwidth.

### Measurement of Film Thickness

A layer of a cured film in a glass substrate with a cured film of a polymerizable liquid crystal compound was shaved off and a profile was measured using a high-resolution surface profiler (Alpha-Step IQ, made by KLA-Tencor Corporation).

Compounds used in Examples and Comparative Examples are shown below.

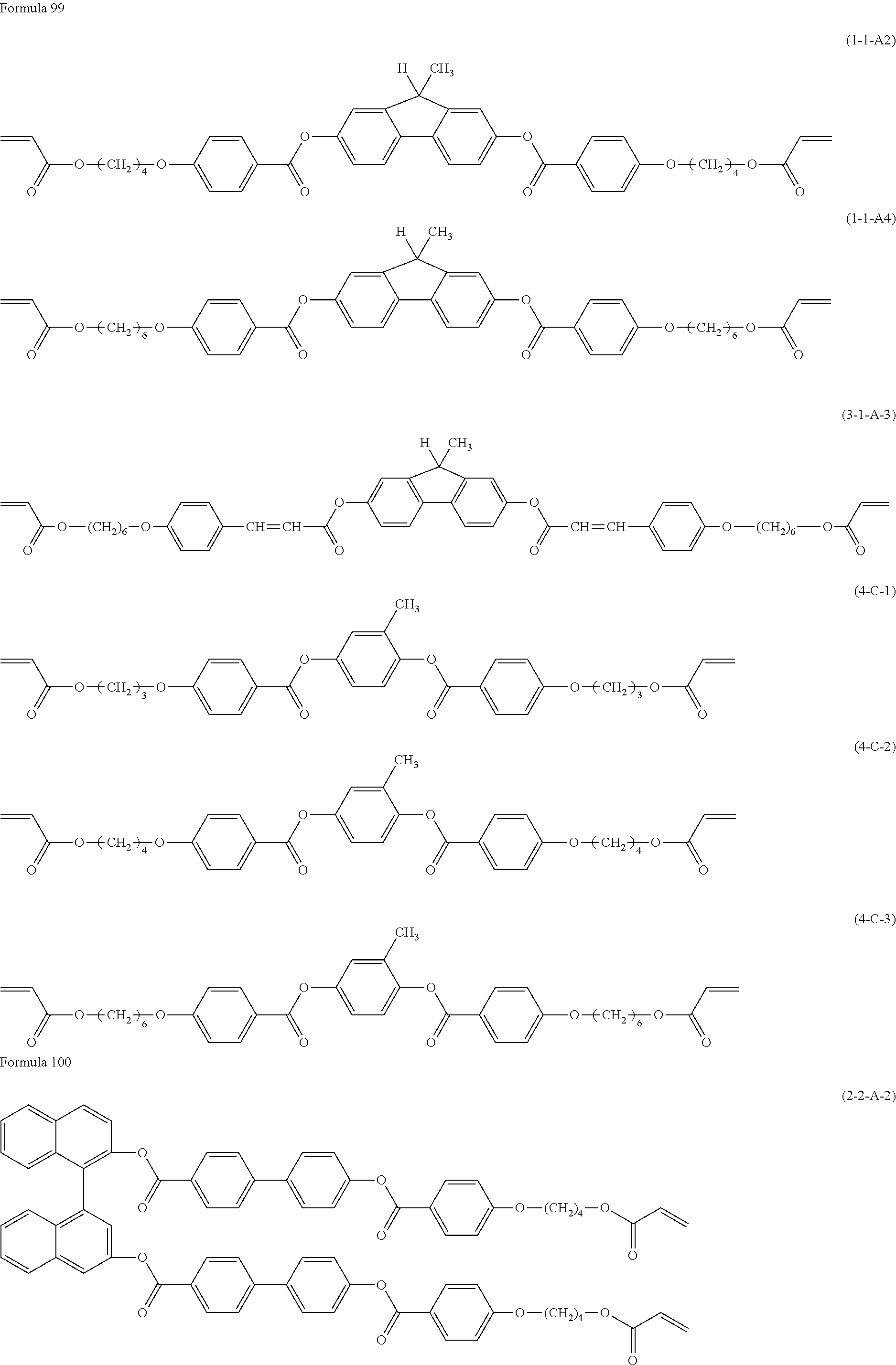

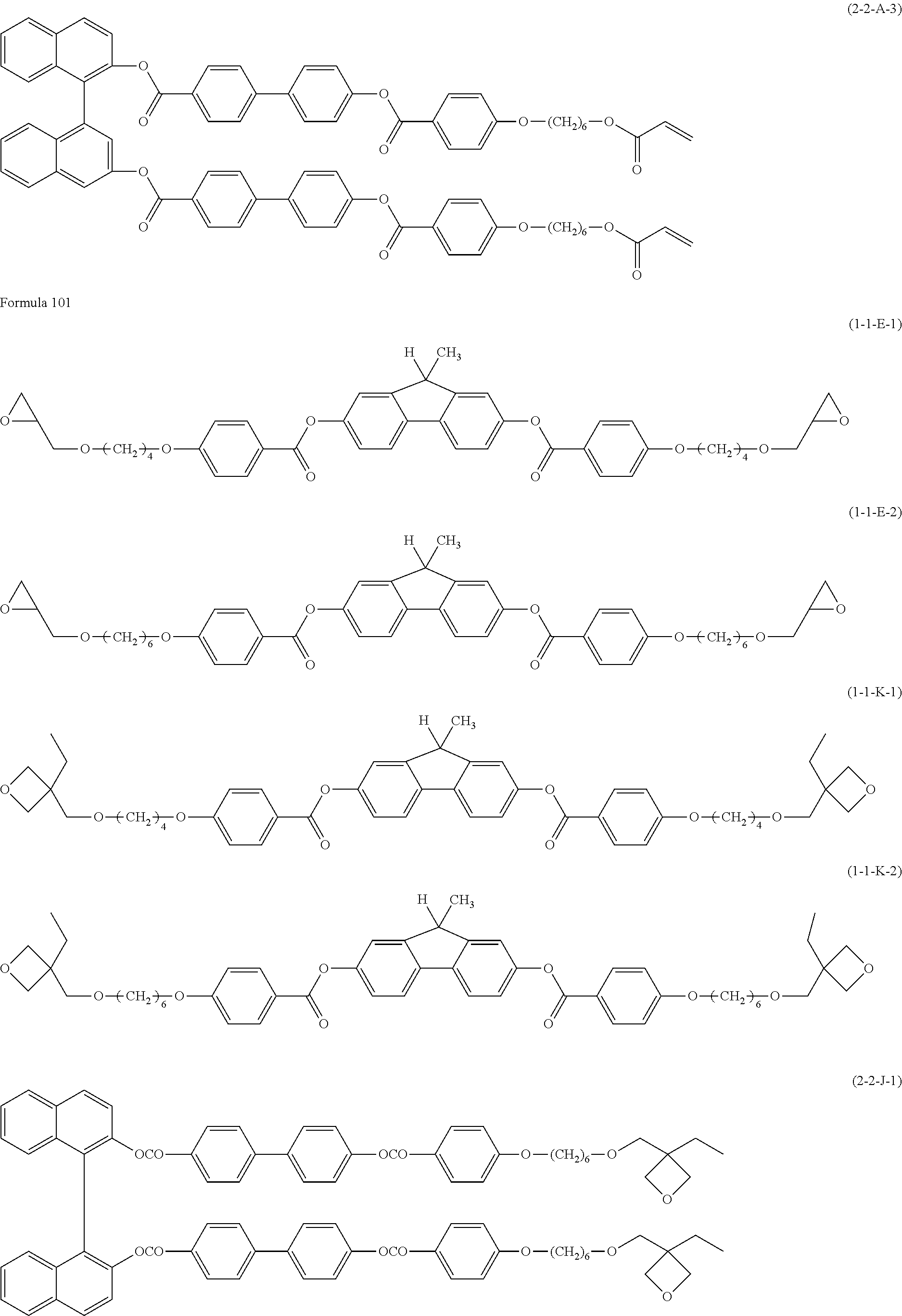

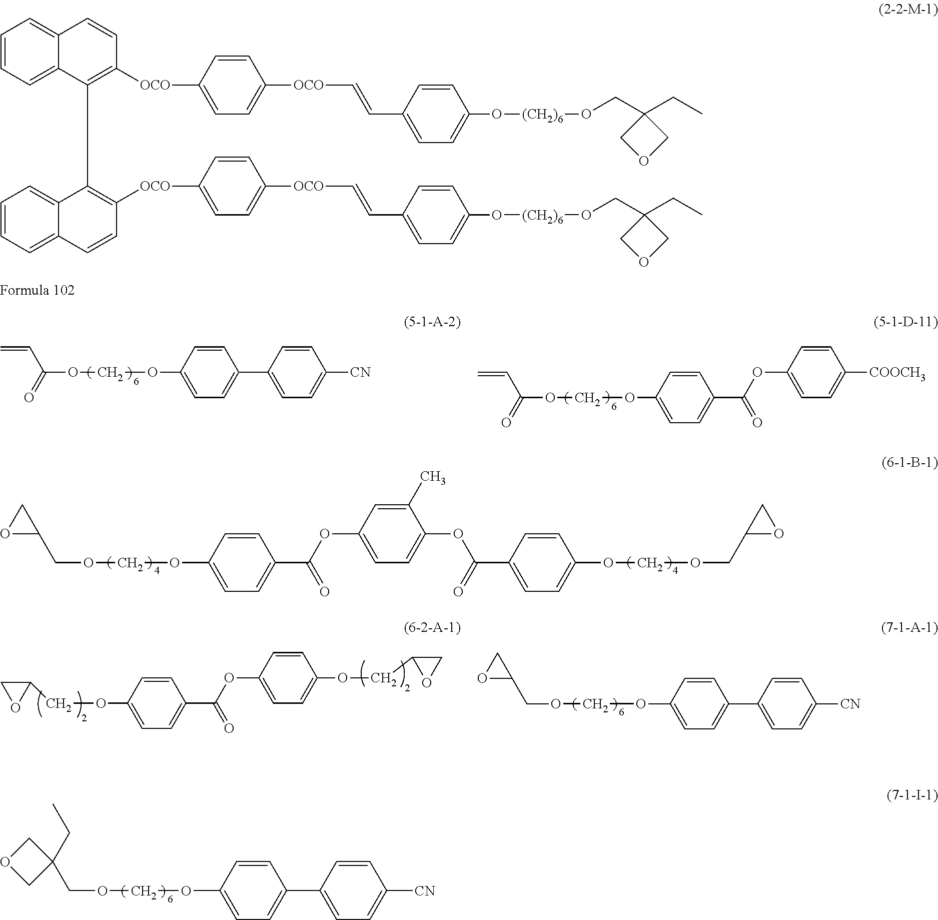

Formula (1-1-A2) and formula (1-1-A4) were prepared by a method described in JP 2003-238491 A.

Formula (3-1-A3) was prepared by a method described in JP 2012-177087 A. In addition, both of —CH═CH— in compound (3-1-A3) take a trans form.

Formula (4-C-1), formula (4-C-2) and formula (4-C-3) were prepared in accordance with a method described in Makromol. Chem., 190, 2255-2268 (1989).

Formula (2-2-A-2) and formula (2-2-A-3) were prepared by a method in combination with methods described in JP 2005-263778 A, U.S. Pat. No. 5,886,242 B and GB 2298202 A.

Formula (1-1-E-1), formula (1-1-E-2), formula (1-1-K-1) and formula (1-1-K-2) were prepared by a method described in JP 2005-60373 A.

Formula (2-2-J-1) and formula (2-2-M-1) were prepared by a method described in JP 2005-263778 A.

Formula (5-1-A-2) was prepared in a manner similar to a method described in Macromolecules, 26, 6132-6134 (1993).

Formula (6-2-A-1) was prepared in accordance with a method described in Macromolecules, 1993, 26(6), 244.

### Example 1

### Preparation of Composition (1)

At a weight ratio of 49:49:2 for formula (1-1-A2):formula (1-1-A4):formula (2-2-A2) of a (R) isomer, the compounds were mixed. The polymerizable liquid crystal composition was defined as MIX1. To the MIX1, in terms of a weight ratio, 0.05 of a polymerization initiator having oxime ester NCI-930 (made by ADEKA Corporation) and 0.01 of TEGOFLOW (registered trademark) 370 as an acrylic polymer-based surfactant were added. Cyclopentanone was added to the composition to adjust composition (1) in which a concentration of MIX1 was 35% by weight.

Onto a glass substrate (Matsunami Slide Glass: S-1112), polyamic acid for a low pretilt angle (horizontal alignment mode) (Lixon Aligner: PIA-5580, made by JNC Corporation) was applied, and the resulting applied material was dried at 80° C. for 3 minutes, and then calcinated at 230° C. for 30 minutes. Rubbing treatment was applied using a rubbing fabric made from rayon (rubbing-treated alignment film). Next, composition (1) was applied onto the glass substrate with the rubbing-treated alignment film by spin coating. The substrate was heated at 80° C. for 3 minutes and cooled at room temperature for 3 minutes. A coating film from which a solvent was removed was exposed, in air, with ultraviolet light such that the ultraviolet light having an irradiance (at a wavelength of 365 nm) of 20 mW/cm² became 500 mJ/cm² in an integrated amount of light to give a transparent liquid crystal cured film (optically anisotropic substance). When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with the liquid crystal cured film was measured, an absorption maximal wavelength was 1,020 nanometers in a near-infrared region and a band of a selective reflection wavelength was approximately 180 nanometers. A thickness of the infrared reflecting film on the above occasion was approximately 3.4 micrometers.

### Example 2

### Preparation of Composition (2)

Composition (2) was prepared in a manner similar to the method described in Example 1 except that formula (1-1-A4) in the MIX1 described in Example 1 was changed to formula (4-C-2).

When a cured film was formed using composition (2) in a manner similar to the method described in Example 1, a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with the liquid crystal cured film was measured, an absorption maximal wavelength was 1,110 nanometers in a near-infrared region and a band of a selective reflection wavelength was approximately 170 nanometers. A thickness of the infrared reflecting film on the above occasion was approximately 3.2 micrometers.

### Example 3

### Preparation of Composition (3)

Composition (3) was prepared by the method described in Example 1 except that at a weight ratio of 29.6:49.2:19.7:1.5 for formula (1-1-A2):formula (1-1-A4):formula (3-1-A3):formula (2-2-A2) of a (R) isomer, the compounds were mixed and the polymerizable liquid crystal composition was obtained.

When a cured film was formed using composition (3) in a manner similar to the method described in Example 1 and a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with liquid crystal cured film was measured, an absorption maximal wavelength was 1,290 nanometers in a near-infrared region and a band of a selective reflection wavelength was approximately 220 nanometers. A thickness of the infrared reflecting film on the above occasion was approximately 3.6 micrometers.

### Example 4

### Preparation of Composition (4)

Composition (4) was prepared in a manner similar to the method described in Example 1 except that formula (2-2-A2) of the (R) isomer in MIX1 described in Example 1 was changed to formula (2-2-J-1) of a (R) isomer.

When a cured film was formed using composition (4) in a manner similar to the method described in Example 1 and a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with liquid crystal cured film was measured, an absorption maximal wavelength was 1,110 nanometers in a near-infrared region and a band of a selective reflection wavelength was approximately 170 nanometers. A thickness of the infrared reflecting film on the above occasion was approximately 3.2 micrometers.

### Example 5

### Preparation of Composition (5)

At a weight ratio of 68.8:29.5:1.8 for formula (1-1-A4):formula (5-1-A-2):formula (2-2-J-1) of a (R) isomer, the compounds were mixed. The polymerizable liquid crystal composition was defined as MIX5. To the MIX5, in terms of a weight ratio, 0.05 of a polymerization initiator Irgacure 907 (made by BASF Japan Ltd.) and 0.002 of a fluorine-based surfactant FTX-218 (made by Neos Company Limited) were added. Cyclopentanone was added to the composition to adjust composition (5) in which a concentration of MIX5 was 35% by weight.

When a cured film was formed using composition (5) in a manner similar to the method described in Example 1, a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with the liquid crystal cured film was measured, an absorption maximal wavelength was 1,230 nanometers in a near-infrared region and a band of a selective reflection wavelength was approximately 200 nanometers. A thickness of the infrared reflecting film on the above occasion was approximately 3.8 micrometers.

### Example 6

### Preparation of Composition (6)

Composition (6) was prepared in a manner similar to the method described in Example 5 except that formula (2-2-J-1) of the (R) isomer in MIX5 described in Example 5 was changed to formula (2-2-J-1) of a (S) isomer.

When a cured film was formed using composition (6) in a manner similar to the method described in Example 1, a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with the liquid crystal cured film was measured, an absorption maximal wavelength was 1,230 nanometers in a near-infrared region and a band of a selective reflection wavelength was approximately 200 nanometers. A thickness of the infrared reflecting film on the above occasion was approximately 3.0 micrometers.

### Example 7

### Preparation of Composition (7)

At a weight ratio of 68.8:29.5:1.8 for formula (1-1-A4):formula (5-1-A-2):formula (2-2-A-3) of a (R) isomer, the compounds were mixed. The polymerizable liquid crystal composition was defined as MIX7. To the MIX7, in terms of a weight ratio, 0.05 of a polymerization initiator Irgacure 907 (made by BASF Japan Ltd.) and 0.002 of a fluorine-based surfactant FTX-218 (made by Neos Company Limited) were added. Cyclopentanone was added to the composition to adjust composition (7) in which a concentration of MIX7 was 35% by weight.

When a cured film was formed using composition (7) in a manner similar to the method described in Example 1, a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with the liquid crystal cured film was measured, an absorption maximal wavelength was 1,230 nanometers in a near-infrared region and a band of selective reflection wavelength was approximately 200 nanometers. A thickness of the infrared reflecting film on the above occasion was approximately 3.0 micrometers.

### Comparative Example 1

### Preparation of Composition (8)

Ata weight ratio of 47.4:47.4:5.2 for formula (1-1-A2):formula (1-1-A4):formula (2-2-A2) of a (R) isomer, the compounds were mixed. The polymerizable liquid crystal composition was defined as MIX8. To the MIX8, in terms of a weight ratio, 0.05 of a polymerization initiator NCI-930 (made by ADEKA Corporation) and 0.001 of TEGOFLOW (registered trademark) 370 as a acrylic polymer-based surfactant were added. Cyclopentanone was added to the composition to adjust composition (8) in which a concentration of MIX8 was 35% by weight.

When a cured film was formed using composition (8) in a manner similar to the method described in Example 1, a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with the liquid crystal cured film was measured, an absorption maximal wavelength was 393 nanometers in an ultraviolet region and a band of a selective reflection wavelength was approximately 70 nanometers. A thickness of the infrared reflecting film on the above occasion was approximately 3.3 micrometers.

### Example 8

### Preparation of Composition (9)

Ata weight ratio of 42.8:47.6:4.8:4.8 for formula (1-1-A4):formula (6-2-A-1):formula (1-1-K-2):formula (2-2-M-1) of a (R) isomer, the compounds were mixed. The polymerizable liquid crystal composition was defined as MIX9. To the MIX9, in terms of a weight ratio, 0.01 of a polymerization initiator Irgacure 184 (made by BASF Japan Ltd), 0.02 of a polymerization initiator Irgacure 250 (made by BASF Japan Ltd), 0.01 of a sensitizer DETX (Speedcure made by LAMBSON Ltd.) and 0.001 of an acrylic polymer-based surfactant TEGOFLOW (registered trademark) 370 were added. Cyclopentanone was added to the composition to adjust composition (9) in which a concentration of MIX9 was 35% by weight.

When a cured film was formed using composition (9) in a manner similar to the method described in Example 1, a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with the liquid crystal cured film was measured, an absorption maximal wavelength was 1,150 nanometers in a near-infrared region and a band of a selective reflection wavelength was approximately 200 nanometers. A thickness of the infrared reflecting film on the above occasion was approximately 3.0 micrometers.

### Example 9

### Preparation of Composition (10)

Ata weight ratio of 49.5:19.8:24.7:4.9:1.1 for formula (1-1-A4):formula (3-1-A-3):formula (1-1-E-2):formula (1-1-K-2):formula (2-2-M-1) of a (R) isomer, the compounds were mixed. The polymerizable liquid crystal composition was defined as MIX10. To the MIX10, in terms of a weight ratio, 0.01 of a polymerization initiator Irgacure 184 (made by BASF Japan Ltd), 0.02 of a polymerization initiator Irgacure 250 (made by BASF Japan Ltd), 0.01 of a sensitizer DETX (Speedcure made by LAMBSON Ltd.) and 0.001 of an acrylic polymer-based surfactant TEGOFLOW (registered trademark) 370 were added. Cyclopentanone was added to the composition to adjust composition (10) in which a concentration of MIX10 was 35% by weight.

When a cured film was formed using composition (10) in a manner similar to the method described in Example 1, a transparent liquid crystal cured film (optically anisotropic substance) was obtained. When the optically anisotropic substance obtained was interposed between two polarizing plates arranged in a crossed Nicol state and the substrate was placed into a dark field state, no light leakage was confirmed, and thus alignment was judged to be uniform. When an infrared transmission of the substrate with the liquid crystal cured film was measured, an absorption maximal wavelength was 1,850 nanometers in a near-infrared region and a band of a selective reflection wavelength was approximately 240 nanometers. A thickness of the infrared reflecting film on the above occasion was approximately 5.0 micrometers.

### Example 10

Two sheets of the substrates each with the cured film obtained in Example 5 were prepared. As a ½λ plate in a near-infrared region, two wavelength plates (MCR 280A sold by MeCan Imaging Inc.) having structure of interposing a cycloolefin polymer between triacetyl cellulose (TAC) films were prepared, and used in a state in which the plates were overlapped by adjusting phase lag axes in an identical direction. A front phase difference in the ½λ plate on the above occasion was approximately 560 nanometers.

When the substrates each with the cured film obtained in Example 5 were overlapped on both sides of the ½λ plate, and an infrared transmission was measured, an absorption maximal wavelength was 1,230 nanometers in a near-infrared region and a band of a selective reflection wavelength was approximately 200 nanometers. However, the transmittance of the absorption maximal wavelength was reduced by half.

### Example 11

### Preparation of Composition (11)

Composition (11) was prepared in a manner similar to the method described in Example 5 except that the solvent used for preparation of composition (5) described in Example 5 was changed to 1,3-dioxolane. Next, composition (11) was coated onto a biaxially stretched PET film and the resulting coat was exposed for 100 seconds with an irradiance of 0.15 mW/cm² from a PET film side, heated at 90° C. for 1 minute, and then cooled to room temperature. The resulting coat was again exposed for 100 seconds with an irradiance of 0.15 mW/cm² from the PET film side and warmed at 90° C. for 1 minute, and then exposed for 100 seconds with ultraviolet light having an irradiance of 20 mW/cm² from a liquid crystal layer surface side, and thus a band of an infrared reflection wavelength was extended to approximately 300 nanometers.

### Comparative Example 2

### Preparation of Composition (12)

At a weight ratio of 98:2 for formula (4-C-3):formula (2-2-A2) of a (R) isomer, the compounds were mixed. The polymerizable liquid crystal composition was defined as MIX12. To the MIX12, in terms of a weight ratio, 0.05 of a polymerization initiator NCI-930 (made by ADEKA Corporation) and 0.001 of an acrylic polymer-based surfactant TEGOFLOW (registered trademark) 370 were added. Cyclopentanone was added to the composition to adjust polymerizable liquid crystal composition (12) in which a concentration of MIX12 was 35% by weight.

When a cured film was formed using the composition (12) in a manner similar to the method described in Example 1, many alignment defects occurred to form a cured film in which appearance became cloudy, and therefore an evaluation was difficult.

The results described above show that the infrared reflecting film having selective reflection characteristics in an infrared region and uniform alignment characteristics can be obtained by using an achiral polymerizable liquid crystal compound having a fluorene skeleton and an optically active compound having a specific amount of a binaphthol moiety.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

### INDUSTRIAL APPLICABILITY

According to the invention, an infrared reflecting film having selective reflection characteristics in an infrared region, and uniform alignment characteristics can be obtained.

What is claimed is:

1. An infrared reflecting film, obtained by curing a polymerizable liquid crystal composition containing an achiral polymerizable liquid crystal compound and an optically active compound in a state of a liquid crystal phase, wherein
the achiral polymerizable liquid crystal compound contains component (A) being at least one compound selected from the group of achiral polymerizable liquid crystal compounds represented by formula (1),
the optically active compound contains component (B) being at least one compound selected from the group of optically active compounds having a binaphthol moiety represented by formula (2), and
a content of component (B) in the total weight of the achiral polymerizable liquid crystal compound and the optically active compound is in the range of 0.1% by weight or more and 5% by weight or less: 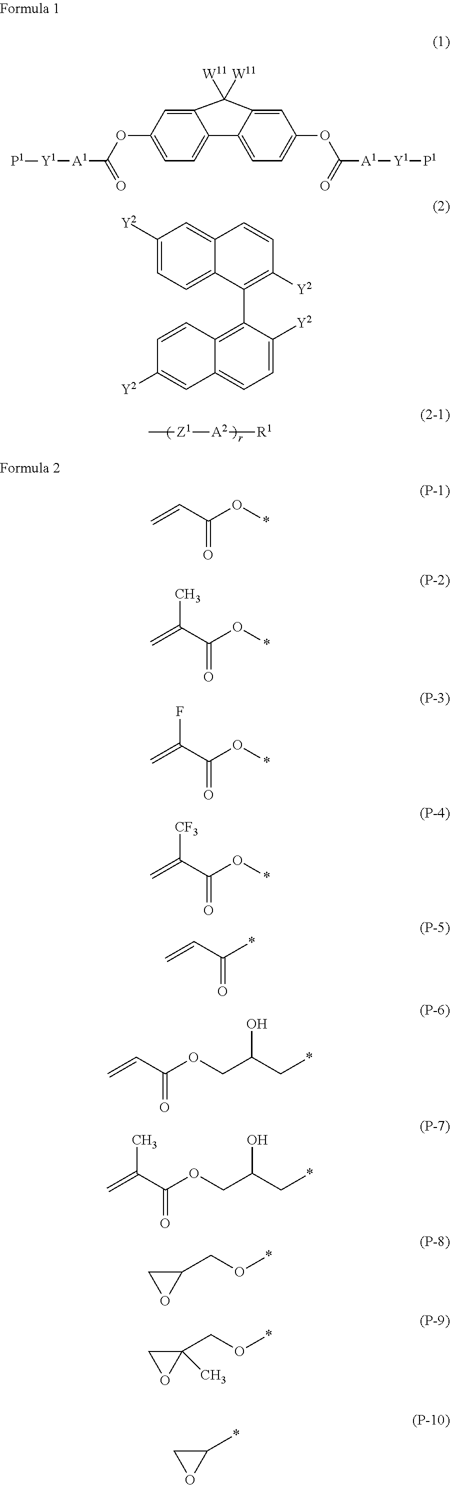 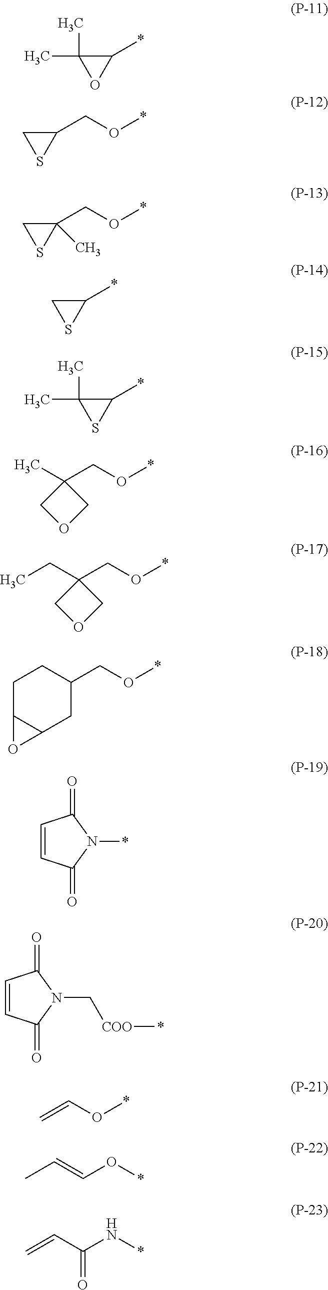
wherein, in (P-1) to (P-23), * represents a bonding site:
in formula (1),
P¹ is independently represented by any one of formulas (P-1) to (P-23);
W¹¹ is independently hydrogen, fluorine, chlorine, methyl or ethyl, and at least one of hydrogen in the methyl and the ethyl may be replaced by halogen;
A¹ is independently 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;
Y¹ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine,
in formula (2),
Y² is independently hydrogen, halogen or a group represented by formula (2-1), however, in Y², at least two are a group represented by formula (2-1);
in formula (2-1),
R¹ is independently halogen, cyano, alkenyl having 2 to 20 carbons, or alkyl having 1 to 20 carbons, at least one of —CH₂— in the group may be replaced by —O—, excluding a case where —O— is adjacent, at least one of hydrogen in the group may be replaced by halogen, in one or two of Y², one of hydrogen in R¹ may be replaced by any one of formulas (P-1) to (P-23);
A² is independently 1,4-cyclohexylene, 1,4-phenylene, 4,4′-biphenylene, naphthalene-2,6-diyl, decahydronaphthalene-2,6-diyl, 1,2,3,4-tetrahydronaphthalene-2,6-diyl, or 1,4-phenylene in which at least one of hydrogen is replaced by halogen;
Z¹ is independently a single bond, —O—, —COO—, —OCO—, —CH═CH—COO—, —OCO—CH═CH—, —CH₂CH₂—COO—, —OCO—CH₂CH₂—, —OCF₂— or —(CH₂)ₚ—, and one of —CH₂— in —(CH₂)ₚ— may be replaced by —O—;
p is independently an integer from 1 to 20; and
r is independently an integer from 1 to 3.

2. The infrared reflecting film according to claim 1, wherein component (A) is at least one compound selected from the group of compounds represented by formula (1-1), and component (B) is at least one compound selected from the group of compounds having optical activity represented by formula (2-2): 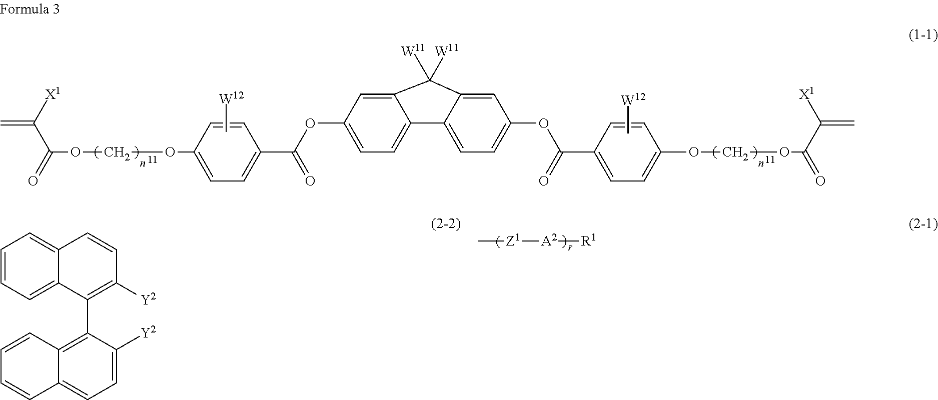
wherein, in formula (1-1),
X¹ is independently hydrogen, methyl, fluorine or trifluoromethyl;
W¹¹ is independently hydrogen or methyl;
W¹² is independently hydrogen, halogen, nitro, cyano, alkyl having 1 to 7 carbons or alkoxy having 1 to 7 carbons;
n¹¹ is independently an integer from 2 to 20;
in formula (2-2),
Y² is independently a group represented by formula (2-1);
in formula (2-1),
R¹ is independently halogen, cyano, alkenyl having 2 to 20 carbons or alkyl having 1 to 20 carbons, at least one of —CH₂— in the group may be replaced by —O—, excluding a case where —O— is adjacent, at least one of hydrogen in the group may be replaced by halogen, and in one or two of Y², one of hydrogen in R¹ may be replaced by acryloyloxy, methacryloyloxy, formula (P-16) or formula (P-17);
A² is independently 1,4-cyclohexylene, 1,4-phenylene, 4,4′-biphenylene, naphthalene-2,6-diyl, decahydronaphthalene-2,6-diyl, 1,2,3,4-tetrahydronaphthalene-2,6-diyl, or 1,4-phenylene in which at least one of hydrogen is replaced by halogen;
Z¹ is independently a single bond, —O—, —COO—, —OCO—, —CH═CH—COO—, —OCO—CH═CH—, —CH₂CH₂—COO—, —OCO—CH₂CH₂—, —OCF₂— or —(CH₂)ₚ—, and one of —CH₂— in —(CH₂)ₚ— may be replaced by —O—;
p is independently an integer from 1 to 20; and
r is independently an integer from 1 to 3.

3. The infrared reflecting film according to claim 1, wherein at least one kind of polymerization initiator is added as component (C) to the polymerizable liquid crystal composition.

4. The infrared reflecting film according to claim 2, wherein at least one kind of polymerization initiator is added as component (C) to the polymerizable liquid crystal composition.

5. The infrared reflecting film according to claim 3, wherein the polymerization initiator includes a photopolymerization initiator having oxime ester.

6. The infrared reflecting film according to claim 4, wherein the polymerization initiator includes a photopolymerization initiator having oxime ester.

7. The infrared reflecting film according to claim 2, wherein,
in formula (1-1),
X¹ is independently hydrogen or methyl;
W¹² is independently hydrogen, halogen, alkyl having 1 to 7 carbons or alkoxy having 1 to 7 carbons;
n¹¹ is independently an integer from 2 to 20;
in formula (2-2),
Y² is independently a group represented by formula (2-1);
in formula (2-1),
R¹ is independently alkenyl having 2 to 20 carbons or alkyl having 1 to 20 carbons, at least one of —CH₂— in the group may be replaced by —O—, excluding a case where —O— is adjacent, at least one of hydrogen in the group may be replaced by halogen, and one of hydrogen in the group may be replaced by acryloyloxy, methacryloyloxy, formula (P-16) or formula (P-17);
Z¹ is independently a single bond, —O—, —COO—, —OCO—, —CH═CH—COO—, —OCO—CH═CH—, —CH₂CH₂—COO—, —OCO—CH₂CH₂— or —(CH₂)ₚ—, and one of —CH₂— in —(CH₂)ₚ— may be replaced by —O—; and
p is independently an integer from 1 to 10.

8. The infrared reflecting film according to claim 7, wherein
in formula (1-1),
W¹² is independently hydrogen, fluorine, alkyl having 1 to 7 carbons or alkoxy having 1 to 7 carbons;
n¹¹ is independently an integer from 2 to 10;
in formula (2-2),
Y² is independently a group represented by formula (2-1); and
in formula (2-1),
p is independently an integer from 1 to 3.

9. The infrared reflecting film according to claim 1, wherein the polymerizable liquid crystal composition further contains at least one compound selected from the group of achiral polymerizable liquid crystal compounds represented by formula (3-1), formula (3-2) and formula (3-3) as component (D): 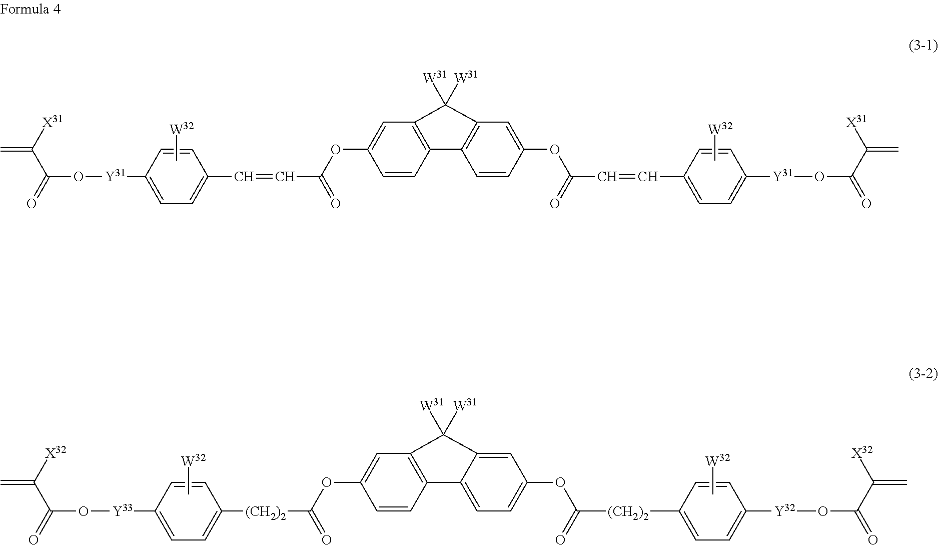
wherein, in formula (3-1),
X³¹ is independently hydrogen, methyl or trifluoromethyl;
Y³¹ is independently alkylene having 1 to 20 carbons, and at least one of —CH₂— may be replaced by —O—, —S—, —COO—, —OCO— or —OCOO—, at least one of —CH₂CH₂— may be replaced by —CH═CH— or —C≡C—, and in the groups, at least one of hydrogen may be replaced by fluorine or chlorine;
W³¹ is independently hydrogen, fluorine, chlorine, methyl or ethyl, and at least one of hydrogen in the methyl and the ethyl may be replaced by halogen;
W³² is independently hydrogen, halogen, nitro, cyano, alkyl having 1 to 7 carbons or alkoxy having 1 to 7 carbons;
in formula (3-2),
W³¹ and W³² are defined in a manner identical with the definitions described above;
Y³² is defined in a manner identical with the definitions of Y³¹, and
X³² is defined in a manner identical with the definitions of X³¹.

10. The infrared reflecting film according to claim 1, wherein the polymerizable liquid crystal composition further contains at least one compound selected from the group of achiral polymerizable liquid crystal compounds represented by formula (4) as component (E): 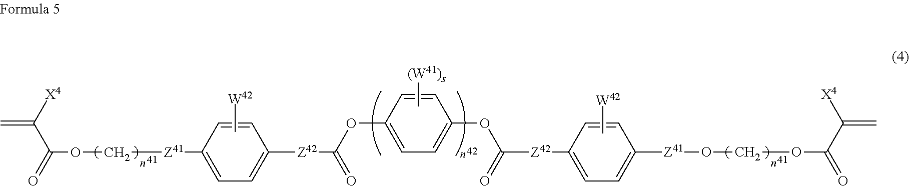
wherein, in formula (4),
X⁴ is independently hydrogen, methyl, fluorine or trifluoromethyl;
W⁴² is independently hydrogen, halogen, nitro, cyano, alkyl having 1 to 7 carbons or alkoxy having 1 to 7 carbons, and in the alkyl and the alkoxy, at least one of hydrogen may be replaced by fluorine;
W⁴¹ is independently hydrogen, halogen, nitro, cyano, phenyl, benzyl, alkyl having 1 to 7 carbons, alkoxy having 1 to 7 carbons, alkoxycarbonyl (—COOR^{a}; R^{a} is straight-chain alkyl having 1 to 7 carbons) or alkylcarbonyl (—COR^{b}; R^{b} is straight-chain alkyl having 1 to 16 carbons), and in the alkyl and the alkoxy, at least one of hydrogen may be replaced by fluorine;
s is an integer from 0 to 4;
n⁴¹ is independently an integer from 2 to 12;
n⁴² is an integer from 1 to 3;
Z⁴¹ is independently a single bond, —O—, —CO—, —CH═CH—, —COO—, —OCO—, —OCO—CH═CH—COO— or —OCOO—; and
Z⁴² is independently a single bond, —CH₂CH₂— or —CH═CH—.

11. The infrared reflecting film according to claim 1, wherein the polymerizable liquid crystal composition further contains at least one compound selected from the group of achiral polymerizable liquid crystal compounds represented by formula (5-1) and formula (5-2) as component (F): 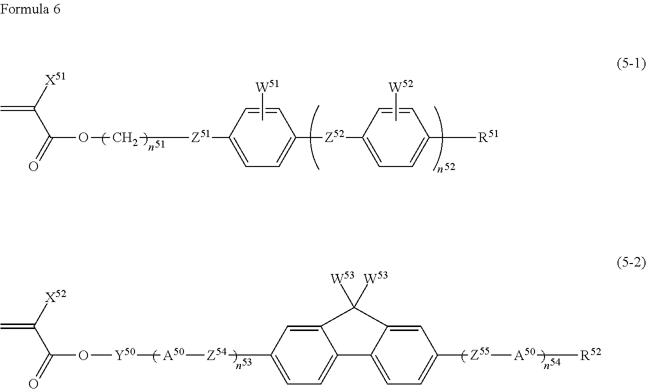
wherein, in formula (5-1),
X⁵¹ is hydrogen, methyl, fluorine or trifluoromethyl;
R⁵¹ is cyano, trifluoromethoxy, alkyl having 1 to 20 carbons, alkyl ester having 1 to 20 carbons (—COOR^{c}, —OCOR^{c} or —CH═CH—COOR^{c}; R^{c} is straight-chain alkyl having 1 to 20 carbons) or alkoxy having 1 to 20 carbons, and in the alkyl and the alkoxy, at least one of hydrogen may be replaced by fluorine;
W⁵¹ and W⁵² are independently hydrogen, halogen, nitro, cyano, alkyl having 1 to 7 carbons or alkoxy having 1 to 7 carbons, and in the alkyl and the alkoxy, at least one of hydrogen may be replaced by fluorine;
Z⁵¹ is a single bond, —O—, —COO—, —OCO— or —OCOO—;
Z⁵² is independently a single bond, —COO—, —OCO—, —CH═CH—COO—, —OCO—CH═CH—, —CH₂CH₂—COO—, —OCO—CH₂CH₂— or —C≡C—;
n⁵¹ is an integer from 2 to 12;
n⁵² is an integer from 1 to 2;
in formula (5-2),
X⁵² is independently hydrogen, methyl, fluorine or trifluoromethyl;
R⁵² is cyano, trifluoromethoxy, alkyl having 1 to 20 carbons, alkyl ester having 1 to 20 carbons (—COOR^{c}, —OCOR^{c} or —CH═CH—COOR^{c}; R^{c} is straight-chain alkyl having 1 to 20 carbons) or alkoxy having 1 to 20 carbons, and in the alkyl and the alkoxy, at least one of hydrogen may be replaced by fluorine;
W⁵³ is independently hydrogen, fluorine, chlorine, methyl or ethyl, and at least one of hydrogen in the methyl and the ethyl may be replaced by halogen;
Y⁵⁰ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine;
A⁵⁰ is independently a single bond, 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;
Z⁵⁴ and e are each independently a single bond, —COO—, —OCO—, —OCOO—, —CH═CH—COO—, —OCO—CH═CH—, —CH₂CH₂—COO—, —OCO—CH₂CH₂— or —C≡C—; and,
n⁵³ and n⁵⁴ are independently 0 or 1.

12. The infrared reflecting film according to claim 1, wherein the polymerizable liquid crystal composition further contains at least one compound selected from the group of achiral polymerizable liquid crystal compounds represented by formulas (6-1) to (6-2) as component (G): 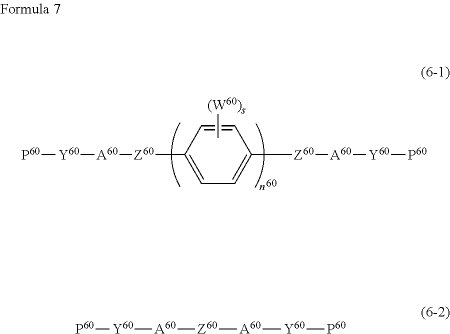
wherein, in formula (6-1) and formula (6-2),
P⁶⁰ is independently represented by any one of formula (P-8) to formula (P-18);
Y⁶⁰ is independently a single bond or alkylene having 1 to 20 carbons, and at least one of —CH₂— may be replaced by —O—, —S—, —COO—, —OCO—, —OCOO—, excluding a case where —O— is adjacent, at least one of —CH₂CH₂— may be replaced by —CH═CH— or —C≡C—, and in the groups, at least one of hydrogen may be replaced by fluorine or chlorine;
A⁶⁰ is independently 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;
Z⁶⁰ is independently a single bond, —COO—, —OCO—, —CH═CH—COO—, —OCO—CH═CH—, —CH₂CH₂—COO—, —OCO—CH₂CH₂— or —C≡C—;
W⁶⁰ is independently hydrogen, halogen, nitro, cyano, phenyl, benzyl, alkyl having 1 to 7 carbons, alkoxy having 1 to 7 carbons, alkoxycarbonyl (—COOR^{a}; R^{a} is straight-chain alkyl having 1 to 7 carbons) or alkylcarbonyl (—COR^{b}; R^{b} is straight-chain alkyl having 1 to 16 carbons), and in the alkyl and the alkoxy, at least one of hydrogen may be replaced by fluorine;
s is an integer from 0 to 4; and
n⁶⁰ is an integer from 1 to 3.

13. The infrared reflecting film according to claim 1, wherein the polymerizable liquid crystal composition further contains at least one compound selected from the group of achiral polymerizable liquid crystal compounds represented by formula (7-1) and formula (7-2) as component (H): 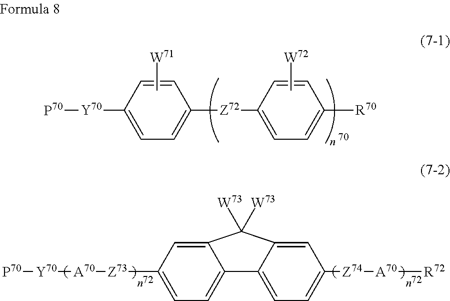
wherein, in formula (7-1),
P⁷⁰ is independently represented by any one of formula (P-8) to formula (P-18);
Y⁷⁰ is independently a single bond or alkylene having 1 to 20 carbons, and at least one of —CH₂— may be replaced by —O—, —S—, —COO—, —OCO— or —OCOO—, excluding a case where —O— is adjacent, at least one of —CH₂CH₂— may be replaced by —CH═CH— or —C≡C—, and in the groups, at least one of hydrogen may be replaced by fluorine or chlorine;
W⁷¹ and W⁷² are independently hydrogen, halogen, nitro, cyano, alkyl having 1 to 7 carbons or alkoxy having 1 to 7 carbons;
Z⁷² is independently a single bond, —COO—, —OCO—, —CH═CH—COO—, —OCO—CH═CH—, —CH₂CH₂—COO—, —OCO—CH₂CH₂— or —C≡C—;
R⁷⁰ is cyano, trifluoromethoxy, alkyl having 1 to 20 carbons, alkyl ester having 1 to 20 carbons (—COOR^{c}, —OCOR^{c} or —CH═CH—COOR^{c}; R^{c} is straight-chain alkyl having 1 to 20 carbons) or alkoxy having 1 to 20 carbons, and in the alkyl and the alkoxy, at least one of hydrogen may be replaced by fluorine;
n⁷⁰ is an integer from 1 to 2;
in formula (7-2),
P⁷² is independently represented by any one of formula (P-8) to formula (P-18);
Y⁷² is independently a single bond or alkylene having 1 to 20 carbons, and at least one of —CH₂— may be replaced by —O—, —S—, —COO—, —OCO—, or —OCOO—, excluding a case where —O— is adjacent, at least one of —CH₂CH₂— may be replaced by —CH═CH— or —C≡C—, and in the groups, at least one of hydrogen may be replaced by fluorine or chlorine;
W⁷³ is independently hydrogen, fluorine, chlorine, methyl or ethyl, and at least one of hydrogen in the methyl and the ethyl may be replaced by halogen;
Z⁷³ and Z⁷⁴ are each independently a single bond, —COO—, —OCO—, —CH═CH—COO—, —OCO—CH═CH—, —CH₂CH₂—COO—, —OCO—CH₂CH₂— or —C≡C—;
A⁷⁰ is independently a single bond, 1,4-cyclohexylene, 1,4-phenylene, or 1,4-phenylene in which at least one of hydrogen is replaced by halogen, nitro, cyano, alkyl having 1 to 7 carbons or alkoxy having 1 to 7 carbons;
R⁷² is cyano, trifluoromethoxy, alkyl having 1 to 20 carbons, alkyl ester having 1 to 20 carbons (—COOR^{c}, —OCOR^{c} or —CH═CH—COOR^{c}; R^{c} is straight-chain alkyl having 1 to 20 carbons) or alkoxy having 1 to 20 carbons, and in the alkyl and the alkoxy, at least one of hydrogen may be replaced by fluorine; and
n⁷² and n⁷³ are independently 0 or 1.

14. The infrared reflecting film according to claim 1, wherein a surfactant is added to the polymerizable liquid crystal composition.

15. The infrared reflecting film according to claim 1, wherein a weathering agent is added to the polymerizable liquid crystal composition.

16. A laminated film, including two or more layers of the infrared reflecting film according to claim 1.

17. The laminated film according to claim 16, including a ½λ layer.

18. The laminated film according to claim 17, wherein the ½λ layer includes a stretched film.
